(19) United States
(12) Patent Application Publication
(10) Pub. No.: US 2026/0025235 A1
(43) Pub. Date: Jan. 22, 2026

(54) METHOD AND APPARATUS FOR CLUSTER-BASED SIDELINK TRANSMISSION OVER UNLICENSED SPECTRUM

(71) Applicant: LENOVO (BEIJING) LIMITED, Beijing (CN)

(72) Inventors: Haipeng Lei, Beijing (CN); Yu Zhang, Beijing (CN); Xin Guo, Beijing (CN); Xiaodong Yu, Beijing (CN); Zhennian Sun, Beijing (CN)

(21) Appl. No.: 18/879,669

(22) PCT Filed: Jun. 30, 2022
(86) PCT No.: PCT/CN2022/102998

§ 371 Date: Dec. 27, 2024

(51) Int. Cl. H04L 1/1812; H04W 72/0453; H04W 92/18

(52) U.S. Cl. CPC H04L 1/1812; H04W 72/0453; H04W 92/18

(57) ABSTRACT

Embodiments of the present disclosure relate to methods and apparatuses for a cluster-based sidelink transmission(s) over an unlicensed spectrum. According to some embodiments of the disclosure, a UE may: receive data transmission on a PSSCH on a carrier; determine a first Type-1 interlace from a first set of Type-1 interlaces for transmitting a PSFCH carrying HARQ-ACK feedback corresponding to the data transmission, wherein each of the first set of Type-1 interlaces has a frequency span exceeding a predefined percentage of a frequency bandwidth of the carrier; and transmit the PSFCH on the first Type-1 interlace.

### TECHNICAL FIELD

Embodiments of the present disclosure generally relate to wireless communication technology, and more particularly to a cluster-based sidelink transmission(s) over an unlicensed spectrum.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink, rather than being linked through the BS. The term “sidelink” may refer to a radio link established for communicating among devices (e.g., UEs), as opposed to communicating via the cellular infrastructure (e.g., uplink and downlink). Sidelink transmission may be performed on a licensed spectrum and an unlicensed spectrum.

There is a need for handling sidelink transmissions on an unlicensed spectrum.

### SUMMARY

Some embodiments of the present disclosure provide a first user equipment (UE). The first UE may include a transceiver, and a processor coupled to the transceiver. The processor may be configured to: receive data transmission on a physical sidelink shared channel (PSSCH) on a carrier; determine a first Type-1 interlace from a first set of Type-1 interlaces for transmitting a physical sidelink feedback channel (PSFCH) carrying hybrid automatic repeat request acknowledgement (HARQ-ACK) feedback corresponding to the data transmission, wherein each of the first set of Type-1 interlaces has a frequency span exceeding a predefined percentage of a frequency bandwidth of the carrier and comprises a set of subcarrier clusters that are equally spaced in the frequency bandwidth of the carrier in the case that non-interleaved subcarrier-to-cluster mapping is employed or equally spaced within each resource block (RB) associated with the corresponding Type-1 interlace in the case that interleaved subcarrier-to-cluster mapping is employed; and transmit the PSFCH on the first Type-1 interlace.

In some embodiments of the present disclosure, the first set of Type-1 interlaces is within a resource pool for the PSFCH.

Some embodiments of the present disclosure provide a second user equipment (UE). The second UE may include a transceiver, and a processor coupled to the transceiver. The processor may be configured to: transmit, to a first UE, data transmission on a physical sidelink shared channel (PSSCH) on a carrier; determine a first Type-1 interlace from a first set of Type-1 interlaces for receiving, from the first UE, a physical sidelink feedback channel (PSFCH) carrying hybrid automatic repeat request acknowledgement (HARQ-ACK) feedback corresponding to the data transmission, wherein each of the first set of Type-1 interlaces has a frequency span exceeding a predefined percentage of a frequency bandwidth of the carrier and comprises a set of subcarrier clusters that are equally spaced in the frequency bandwidth of the carrier in the case that non-interleaved subcarrier-to-cluster mapping is employed or equally spaced within each resource block (RB) associated with the corresponding Type-1 interlace in the case that interleaved subcarrier-to-cluster mapping is employed; and receive, from the first UE, the PSFCH on the first Type-1 interlace.

In some embodiments of the present disclosure, each of the set of subcarrier clusters comprises equal number of contiguous subcarriers per RB.

In some embodiments of the present disclosure, in the case that the non-interleaved subcarrier-to-cluster mapping is employed, the first Type-1 interlace includes a single subcarrier cluster in each RB associated with the first Type-1 interlace. In some embodiments of the present disclosure, in the case that the interleaved subcarrier-to-cluster mapping is employed, the first Type-1 interlace includes one or more subcarrier clusters in each RB associated with the first Type-1 interlace.

In some embodiments of the present disclosure, the first Type-1 interlace is defined with reference to a Type-2 interlace of a second set of Type-2 interlaces, wherein each of the second set of Type-2 interlaces has a frequency span exceeding the predefined percentage of the frequency bandwidth of the carrier and comprises RBs that are equally spaced in the frequency bandwidth of the carrier.

In some embodiments of the present disclosure, the Type-2 interlace comprises one or more Type-1 interlaces orthogonal in a frequency domain.

In some embodiments of the present disclosure, the number of Type-1 interlaces of the first set of Type-1 interlaces is dependent on the number of Type-2 interlaces of the second set of Type-2 interlaces and a size of the subcarrier cluster in the case that non-interleaved subcarrier-to-cluster mapping is employed. In some embodiments of the present disclosure, the number of Type-1 interlaces of the first set of Type-1 interlaces is dependent on the number of Type-2 interlaces of the second set of Type-2 interlaces and the total number of subcarriers per RB for each Type-1 interlace in the case that interleaved subcarrier-to-cluster mapping is employed.

In some embodiments of the present disclosure, the first Type-1 interlace is determined from the first set of Type-1 interlaces based on a total number of available PSFCH resources, which is determined based on one of the following in the case that non-interleaved subcarrier-to-cluster mapping is employed: the number of Type-2 interlaces of the second set of Type-2 interlaces and a size of the subcarrier cluster; the number of Type-2 interlaces for transmitting the PSSCH and a size of the subcarrier cluster; the number of RB sets for transmitting the PSSCH, the number of Type-2 interlaces of the second set of Type-2 interlaces, and a size of the subcarrier cluster; or the number of RB sets within a resource pool for the PSFCH, the number of Type-2 interlaces of the second set of Type-2 interlaces, and a size of the subcarrier cluster.

In some embodiments of the present disclosure, the first Type-1 interlace is determined from the first set of Type-1 interlaces based on a total number of available PSFCH resources, which is determined based on one of the following in the case that interleaved subcarrier-to-cluster mapping is employed: the number of Type-2 interlaces of the second set of Type-2 interlaces, and the total number of subcarriers per RB for each Type-1 interlace; the number of Type-2 interlaces for transmitting the PSSCH and the total number of subcarriers per RB for each Type-1 interlace; the number of RB sets for transmitting the PSSCH, the number of Type-2 interlaces of the second set of Type-2 interlaces, and the total number of subcarriers per RB for each Type-1 interlace; or the number of RB sets within a resource pool for the PSFCH, the number of Type-2 interlaces of the second set of Type-2 interlaces, and the total number of subcarriers per RB for each Type-1 interlace.

In some embodiments of the present disclosure, the number of Type-2 interlaces of the second set of Type-2 interlaces is dependent on subcarrier spacing of the carrier.

In some embodiments of the present disclosure, the total number of available PSFCH resources is determined further based on at least one of: the number of cyclic shift pairs supported for the resource pool for the PSFCH; or the number of PSFCH transmission occasions within a PSFCH slot.

In some embodiments of the present disclosure, the second UE and the first UE are from a UE group, and the first Type-1 interlace is determined from the first set of Type-1 interlaces further based on: a physical layer source ID indicated in sidelink control information (SCI) scheduling the PSSCH; and an ID of the first UE in the UE group in the case that groupcast ACK or negative ACK (NACK) based HARQ-ACK feedback is enabled.

In some embodiments of the present disclosure, the PSFCH is configured with a resource pool, and the resource pool is configured by at least one of the following: an index of an RB set for the PSFCH; subcarrier spacing of the carrier; a cluster size or the number of contiguous subcarriers per cluster; the number of subcarriers per cluster per RB; the number of clusters per Type-2 interlace; a subcarrier-to-cluster mapping type; the number of clusters per RB; or the total number of subcarriers per RB for each Type-1 interlace.

In some embodiments of the present disclosure, the first set of Type-1 interlaces is within a resource pool for the PSFCH.

In some embodiments of the present disclosure, the PSFCH is transmitted confined within an RB set on the carrier and the RB set is: a predefined RB set of RB set(s) for transmitting the PSSCH; indicated in a configuration of a resource pool for the PSFCH; one of RB set(s) for transmitting the PSSCH; one of RB set(s) within a resource pool for the PSFCH; an RB set of one or more RB sets for transmitting the PSSCH subject to the result of a listen-before-talk (LBT) test on each of the one or more RB sets; or an RB set of all RB sets on the carrier subject to the result of an LBT test on each of the RB sets on the carrier.

Some embodiments of the present disclosure provide a method for wireless communication performed by a first UE. The method may include: receiving data transmission on a physical sidelink shared channel (PSSCH) on a carrier; determining a first Type-1 interlace from a first set of Type-1 interlaces for transmitting a physical sidelink feedback channel (PSFCH) carrying hybrid automatic repeat request acknowledgement (HARQ-ACK) feedback corresponding to the data transmission, wherein each of the first set of Type-1 interlaces has a frequency span exceeding a predefined percentage of a frequency bandwidth of the carrier and comprises a set of subcarrier clusters that are equally spaced in the frequency bandwidth of the carrier in the case that non-interleaved subcarrier-to-cluster mapping is employed or equally spaced within each resource block (RB) associated with the corresponding Type-1 interlace in the case that interleaved subcarrier-to-cluster mapping is employed; and transmitting the PSFCH on the first Type-1 interlace.

Some embodiments of the present disclosure provide a method for wireless communication performed by a second UE. The method may include: transmitting, to a first UE, data transmission on a physical sidelink shared channel (PSSCH) on a carrier; determining a first Type-1 interlace from a first set of Type-1 interlaces for receiving, from the first UE, a physical sidelink feedback channel (PSFCH) carrying hybrid automatic repeat request acknowledgement (HARQ-ACK) feedback corresponding to the data transmission, wherein each of the first set of Type-1 interlaces has a frequency span exceeding a predefined percentage of a frequency bandwidth of the carrier and comprises a set of subcarrier clusters that are equally spaced in the frequency bandwidth of the carrier in the case that non-interleaved subcarrier-to-cluster mapping is employed or equally spaced within each resource block (RB) associated with the corresponding Type-1 interlace in the case that interleaved subcarrier-to-cluster mapping is employed; and receiving, from the first UE, the PSFCH on the first Type-1 interlace.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an example of an interlace-based resource block configuration according to some embodiments of the present disclosure;

FIGS. 3A-4G illustrate examples of cluster-based interlace configurations according to some embodiments of the present disclosure;

FIGS. 5 and 6 illustrate flow charts of exemplary procedures of wireless communications in accordance with some embodiments of the present disclosure; and

FIG. 7 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

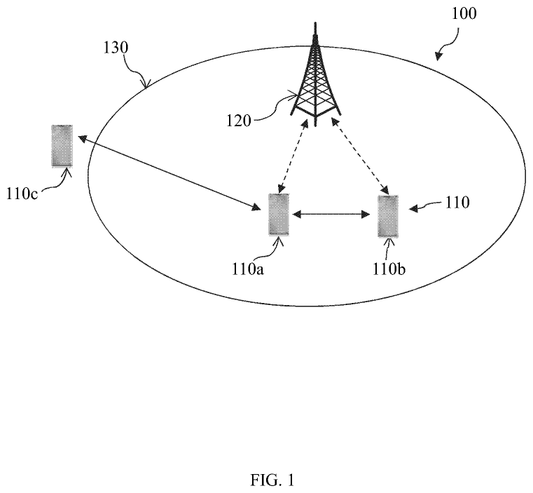

FIG. 1 illustrates a schematic diagram of a wireless communication system 100 in accordance with some embodiments of the present disclosure.

As shown in FIG. 1, wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g., UE 110a, UE 110b, or UE 110c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 802.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g., UE 110a and UE 110b) are within the coverage of BS 120, which may not be the specific BS 120 as shown in FIG. 1 and can be any one of the BSs 120 in a wireless communication system, and some UEs (e.g., UE 110c) are outside of the coverage of BS 120. For example, in the case that the wireless communication system includes two BSs 120 with UE 110a being within the coverage of any one of the two BSs means that UE 110a is within the coverage of a BS 120 (i.e., in-coverage) in the wireless communication system; and UE 110a being outside of the coverage of both BSs 120 means that UE 110a is outside the coverage of a BS 120 (i.e., out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1). In some embodiments, UE 110a, UE 110b, and UE 110c may form a UE group.

Sidelink transmission may involve a physical sidelink control channel (PSCCH) and an associated physical sidelink shared channel (PSSCH), which is scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE).

The PSSCH may carry data which may require corresponding HARQ-ACK feedback from the Rx UE(s) to the Tx UE. The HARQ-ACK feedback for a PSSCH may be carried on a physical sidelink feedback channel (PSFCH).

In some embodiments of the present disclosure, sidelink transmission may be performed on an unlicensed spectrum. This is advantageous because a sidelink transmission over an unlicensed spectrum can achieve, for example, an increased data rate(s).

The unlicensed spectrum may be at around 6 GHz or 60 GHz of carrier frequency. NR-U (NR system access on unlicensed spectrum) operating bandwidth may be, for example, an integer multiple of 20 MHz. In order to achieve fair coexistence between various systems, for example, NR systems (e.g., NR-U systems) and other wireless systems, a channel access procedure, also known as a listen-before-talk (LBT) test, may be performed before communicating on the unlicensed spectrum. In some examples, the LBT test may be performed in units of 20 MHz. For a bandwidth larger than 20 MHz, e.g., 40 MHz, 60 MHz, 80 MHz, or 100 MHz, the carrier bandwidth may be partitioned into subbands, each of which may have a bandwidth of 20 MHz and may be indexed.

To perform the LBT test, energy detection may be performed on a certain channel. If the received power of the channel is below a predefined threshold, the LBT test may be determined as successful, and the channel may then be deemed as empty and available for transmission. Only when the LBT test is successful can a device (e.g., a UE) start transmission on the channel and occupy the channel up to a maximum channel occupancy time (MCOT). Otherwise, that is, if the LBT test fails, the device cannot start any transmission on the channel, and may continue to perform another LBT test until a successful LBT test result.

In addition, wireless transmission on an unlicensed spectrum should meet the requirements of the regulations subject to the management of the country/region where a wireless communication device (e.g., a UE) is located. The requirements mainly include the following aspects:
occupied channel bandwidth (OCB): the bandwidth containing 99% of the power of the signal, shall be between 80% and 100% of the declared nominal channel bandwidth; and
maximum power spectrum density (PSD) with a resolution bandwidth of 1 MHz (e.g., 10 dBm/MHz).

An interlace-based waveform may be applied to uplink (UL) transmission, as well as sidelink communication, to meet both the OCB and PSD requirements. An interlace may be defined as a set of resource blocks (RBs) based on the subcarrier spacing (SCS). The set of RBs of an interlace may be evenly spaced in the frequency domain. Such interlace may also be referred to as “RB-based interlace” hereinafter.

The total number of interlaces in the frequency domain may be dependent on only the SCS of a carrier, regardless of the concrete carrier bandwidth. For example, for 15 kHz subcarrier spacing, there may be 10 interlaces on the carrier; and for 30 kHz subcarrier spacing, there may be 5 interlaces on the carrier.

The number of RBs of each interlace may be dependent on the concrete carrier bandwidth. For example, for a 20 MHz bandwidth with 15 kHz subcarrier spacing, each of the 10 interlaces may include 10 or 11 RBs; and for a 20 MHz bandwidth with 30 kHz subcarrier spacing, each of the 5 interlaces may include 10 or 11 RBs. For a carrier bandwidth larger than 20 MHz, the same spacing between consecutive RBs in an interlace may be maintained for all interlaces regardless of the carrier bandwidth. That is, the number of RBs per interlace may be dependent on the carrier bandwidth. Keeping the same interlace spacing with increasing bandwidth is a straightforward and simple way to scale the interlace design from 20 MHz to a wider bandwidth(s). For example, for an 80 MHz bandwidth with 30 kHz subcarrier spacing, each of the 5 interlaces may include 43 or 44 RBs.

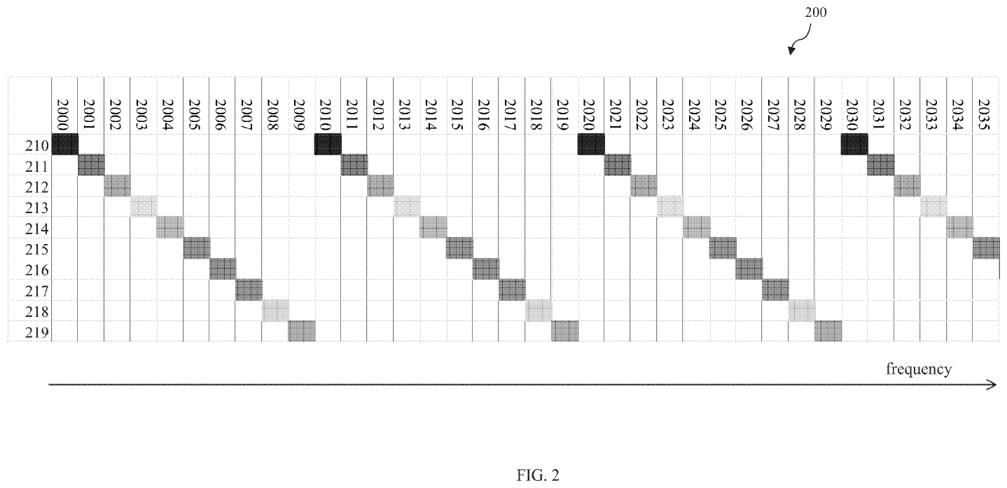

FIG. 2 illustrates an example of interlace-based resource block configuration 200 for 15 kHz subcarrier spacing according to some embodiments of the present disclosure. It should be understood that configuration 200 is only for illustrative purposes, and should not be construed as limiting the embodiments of the present disclosure.

As shown in FIG. 2, carrier bandwidth may be partitioned into resource blocks (RBs). For illustrative purposes, FIG. 2 only shows a part of the RBs (e.g., RBs that are represented with reference numerals 2000 to 2035 in FIG. 2) included in the carrier bandwidth. Persons skilled in the art can readily know the number of RBs included in a certain carrier bandwidth by referring to bandwidth configurations for different subcarrier spacings.

As mentioned above, the number of interlaces distributed within the bandwidth of a carrier may be based on only the subcarrier spacing regardless of the bandwidth of the carrier. In the example of FIG. 2, the RBs of the carrier bandwidth are partitioned into 10 interlaces (corresponding to 15 kHz subcarrier spacing), which are represented with reference numerals 210, 211, 212, 213, 214, 215, 216, 217, 218, and 219 in FIG. 2.

Each interlace of the 10 interlaces may include evenly-spaced RBs in the frequency domain. The number of RBs included in each of the 10 interlaces may depend on carrier bandwidth. As shown in FIG. 2, interlace 210 may include RB 2000, RB 2010, RB 2020, RB 2030, and so on; interlace 211 may include RB 2001, RB 2011, RB 2021, RB 2031, and so on; and interlace 219 may include RB 2009, RB 2019, RB 2029, and so on. RB 2000 to RB 2035 may be indexed from “0” to “35” along the frequency axis, and interlaces 210 to 219 may be indexed from “0” to “9”.

For sidelink transmission over an unlicensed spectrum, the interlace-based structure can be adopted for sidelink channels, e.g., PSCCH, PSSCH and PSFCH, to obey OCB and PSD regulatory requirements. For example, for a given PSSCH transmission on one or multiple interlaces for unicast purposes, one interlace may be enough for the Rx UE to transmit the corresponding PSFCH. For example, for a given PSSCH transmission for groupcast purposes, in the case of a first type of groupcast (also referred to as “groupcast option 1” or “groupcast NACK only based HARQ-ACK feedback”) being enabled, all the Rx UEs may share one PSFCH resource, and an Rx UE may transmit a negative ACK (NACK) on the PSFCH resource if it does not correctly decode the PSSCH or transmit nothing on the PSFCH resource if it correctly decodes the PSSCH. In this scenario, one interlace would be enough for a group of UEs to transmit corresponding PSFCHs on the same PSFCH resource. In the case of a second type of groupcast (also referred to as “groupcast option 2” or “groupcast ACK or NACK based HARQ-ACK feedback”) being enabled, each of the Rx UEs may have a separate PSFCH resource, and an Rx UE may transmit a NACK on the PSFCH resource if it does not correctly decode the PSSCH, or transmit ACK on the PSFCH resource if it does correctly decode the PSSCH. In this scenario, multiple interlaces may be needed so that each Rx UE can transmit a corresponding PSFCH.

On the other hand, as mentioned above, the number of interlaces is dependent on the adopted subcarrier spacing regardless of carrier bandwidth, for example, 10 interlaces for 15 kHz subcarrier spacing and 5 interlaces for 30 kHz subcarrier spacing. For unicast and groupcast option 1, one interlace is sufficient for UEs to transmit a PSFCH. However, for groupcast option 2, tens of interlaces may be needed for Rx UEs to transmit PSFCHs from each of the Rx UEs. PSFCH capacity would be a problem for groupcast option 2, especially when there are a lot of UEs in a group (e.g., more than one hundred UEs) or high subcarrier spacing is used (e.g., 30 kHz subcarrier spacing). Hence, it is desirable to increase PSFCH resource capacity. Moreover, methods for determining the PSFCH resource(s) are also desirable to determine which interlace will be used.

Embodiments of the present disclosure provide solutions to improve PSFCH capacity or solutions for resource determination for sidelink HARQ-ACK feedback transmissions over an unlicensed spectrum. More details on the embodiments of the present disclosure will be illustrated in the following text in combination with the appended drawings.

In some embodiments of the present disclosure, a cluster-based interlace structure is introduced as the basic unit for PSFCH transmission. For example, one PSFCH may be transmitted on one cluster-based interlace. Multiple PSFCHs in the same PSFCH resource pool may be differentiated by different cluster-based interlaces.

In some embodiments, the cluster-based interlace is defined with reference to an RB-based interlace as described above. A cluster-based interlace may include subcarriers aligned with the subcarriers of the reference RB-based interlace in the frequency domain. According to the definitions of the present disclosure, a cluster-based interlace may have a frequency span exceeding 80% of the LBT bandwidth of, for example, 20 MHz, or a channel bandwidth or an RB set which is approximate, for example, 20 MHz. Thus, such structure can meet regulatory requirements, such as OCB, PSD or both.

“Cluster” or “subcarrier cluster” is a frequency domain unit. A cluster may include one or multiple contiguous subcarriers in the frequency domain and is confined within an RB. A cluster-based interlace may include a set of clusters.

In some embodiments of the present disclosure, for a cluster-based interlace there is only a single cluster within one RB. Each cluster-based interlace may thus include a set of clusters equally spaced in the frequency domain (e.g., in the frequency bandwidth of a carrier). This may also be referred to as “non-interleaved subcarrier-to-cluster mapping” or “localized subcarrier-to-cluster mapping”.

In these embodiments, a reference RB-based interlace can be partitioned into multiple cluster-based interlaces and the number of cluster-based interlaces of the reference RB-based interlace is dependent on the cluster size of a cluster-based interlace.

In some embodiments, the cluster size, i.e., the number of subcarriers within one cluster of a cluster-based interlace, can be 6, 4, 3, 2 or 1. Accordingly, the possible cluster-based interlace structures can include a 6 subcarrier-based interlace, 4 subcarrier-based interlace, 3 subcarrier-based interlace, 2 subcarrier-based interlace and 1 subcarrier-based interlace.

In the context of the present disclosure, it is assumed that an RB may include 12 subcarriers. For a 6 subcarrier-based interlace, the cluster size is 6 which implies that there are 6 contiguous subcarriers within each cluster. So the reference RB-based interlace can be partitioned into two (12÷6) cluster-based interlaces, and each of the two cluster-based interlaces includes 60 or 66 subcarriers (e.g., “10 or 11 RBs”×6) within one RB set.

For a 4 subcarrier-based interlace, the cluster size is 4 which implies that there are 4 contiguous subcarriers within each cluster. So the reference RB-based interlace can be partitioned into three (12÷4) cluster-based interlaces and each of the three cluster-based interlaces includes 40 or 44 subcarriers (e.g., “10 or 11 RBs”×4) within one RB set.

For a 3 subcarrier-based interlace, the cluster size is 3 which implies that there are 3 contiguous subcarriers within each cluster. So the reference RB-based interlace can be partitioned into four (12÷3) cluster-based interlaces and each of the four cluster-based interlaces includes 30 or 33 subcarriers (e.g., “10 or 11 RBs”×3) within one RB set;

For a 2 subcarrier-based interlace, the cluster size is 2 which implies that there are 2 contiguous subcarriers within each cluster. So the reference RB-based interlace can be partitioned into six (12÷2) cluster-based interlaces and each of the six cluster-based interlaces includes 20 or 22 subcarriers (e.g., “10 or 11 RBs”×2) within one RB set;

For a 1 subcarrier-based interlace, the cluster size is 1 which implies that there is a single subcarrier within each cluster. So the reference RB-based interlace can be partitioned into twelve (12÷1) cluster-based interlaces and each of the twelve cluster-based interlaces includes 10 or 11 subcarriers (e.g., “10 or 11 RBs”×1) within one RB set.

The total number of cluster-based interlaces is dependent on the number of RB-based interlaces (denoted as M) dependent on subcarrier spacing and the cluster size (denoted as K). For example, the total number of cluster-based interlaces can be denoted as M×12/K.

For example, for 15 kHz SCS, the total number of RB-based interlaces may be 10, so the total number of cluster-based interlaces is 20, 30, 40, 60, or 120 for a cluster size of 6, 4, 3, 2, or 1, respectively. For example, for 30 kHz SCS, the total number of RB-based interlaces may be 5, so the total number of cluster-based interlaces is 10, 15, 20, 30, or 60 for a cluster size of 6, 4, 3, 2, or 1, respectively. For each cluster-based interlace structure, regardless of the cluster size (e.g., 6, 4, 3, 2 or 1), both OCB and PSD requirements can be met. Such cluster-based interlace can achieve better power utilization under PSD limits due to more sparser frequency resources transmitted per 1 MHz.

For 15 kHz SCS, M=10, and taking RB-based interlace p as the reference, it is assumed that RB-based interlace p includes RBs p, p+10, p+20, . . . , where p is the interlace index of the RB-based interlace and p∈{0, 1, 2, . . . , 9} for 15 kHz SCS. For the cluster-based interlace structure, assuming K is the cluster size within one RB, and K∈{1, 2, 3, 4, 6}, then RB-based interlace p may include 12/K cluster-based interlaces. Assuming pᵢ is the index of a cluster-based interlace with reference to RB-based interlace p, i∈{0, 1, . . . , 12/K−1}, then cluster-based interlace pᵢ with reference to RB-based interlace p may include subcarrier i×K, i×K+1, . . . , i×K+K−1 of RB p, RB p+10, RB p+20, . . . . The M×12/K cluster-based interlaces may be indexed together (or globally) from 0 to M×12/K−1. Cluster-based interlace pᵢ with reference to RB-based interlace p may correspond to one of the M×12/K cluster-based interlaces with a (global) index of p×12/K+pᵢ. Alternatively, the cluster-based interlace may be firstly indexed corresponding to the reference RB-based interlace and then indexed to a specific cluster-based interlace among multiple cluster-based interlaces with same reference RB-based interlace. For example, as described above, cluster-based interlace pᵢ, i∈

$$\{ 0 , 1 , … , \frac{12}{K} - 1 \} ,$$

is indexed corresponding to 12/K cluster-based interlace of the reference RB-based interlace p. This detail of this alternative is not repeated here.

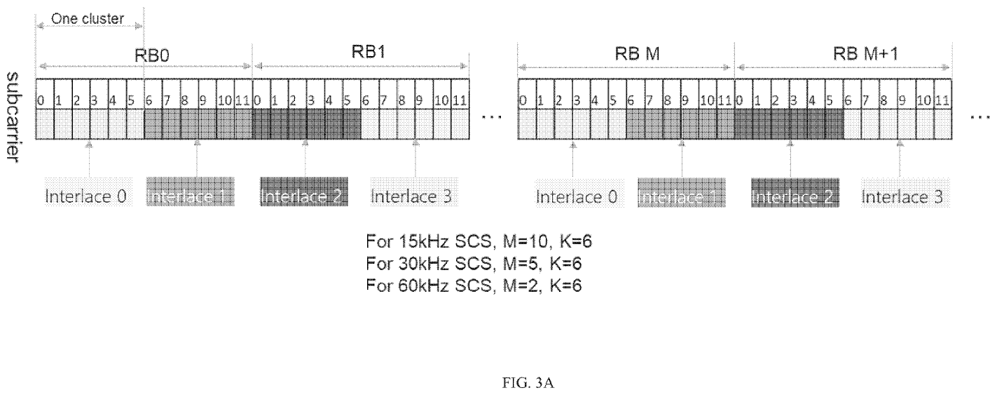

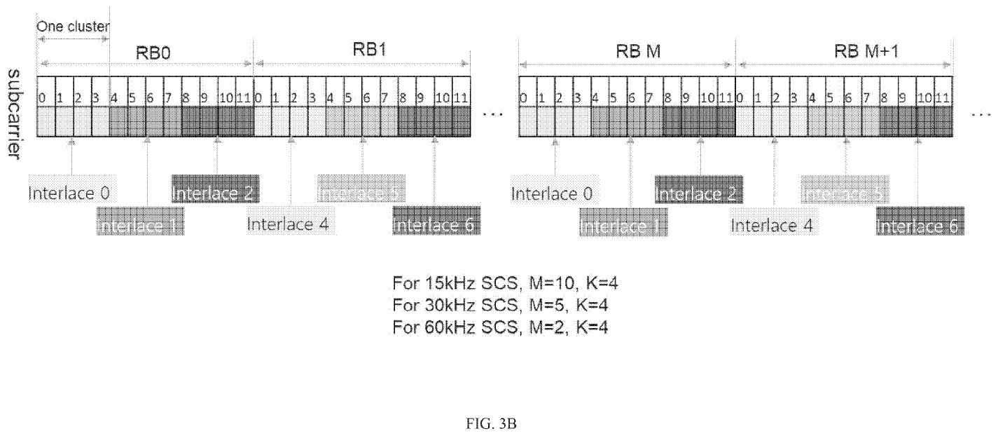

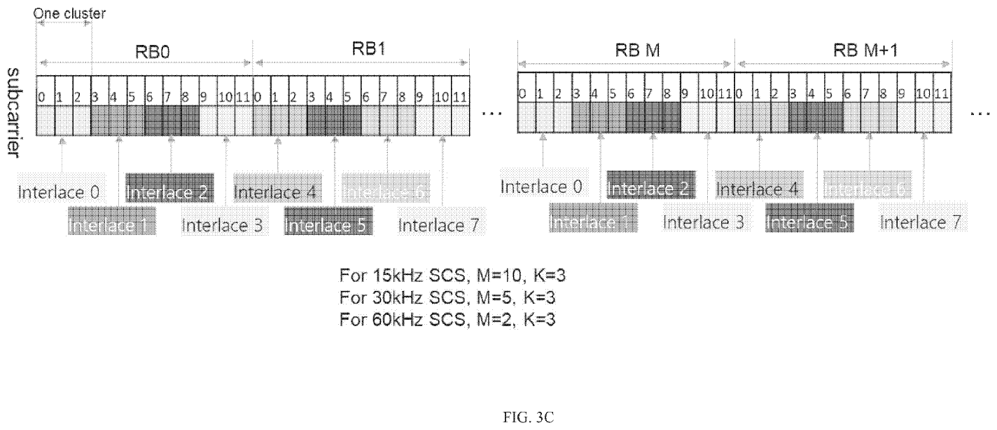

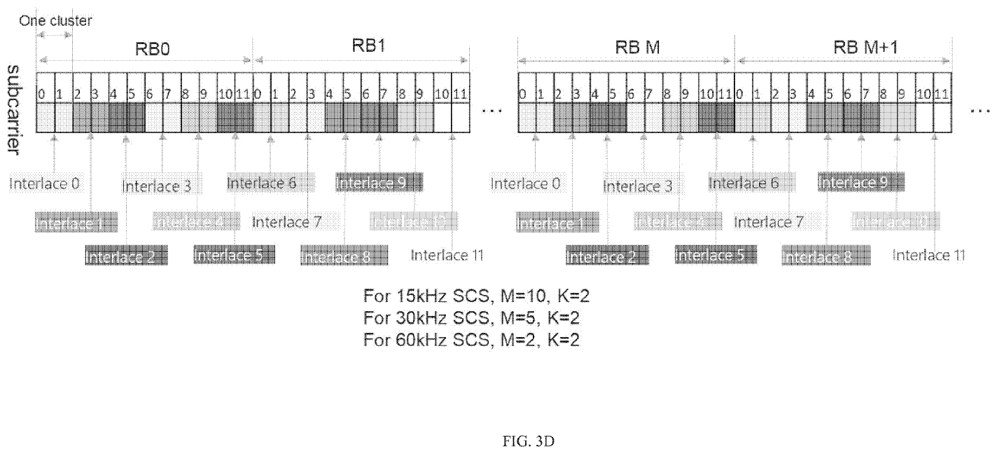

For example, as shown in FIG. 3A, when K=6, there are 2 cluster-based interlaces per RB-based interlace,
Cluster-based interlace 0 with reference to RB-based interlace p includes subcarriers 0, 1, 2, 3, 4 and 5 of RBs p, p+10, p+20, . . . , and corresponds to cluster-based interlace p×2 in FIG. 3A, where the index of p×2 is globally numbered among total M×12/K cluster-based interlaces; and
Cluster-based interlace 1 with reference to RB-based interlace p includes subcarriers 6, 7, 8, 9, 10 and 11 of RBs p, p+10, p+20, . . . , and corresponds to cluster-based interlace p×2+1 in FIG. 3A, where the index of p×2+1 is globally numbered among total M×12/K cluster-based interlaces.

For example, as shown in FIG. 3B, when K=4, there are 3 cluster-based interlaces per RB-based interlace,
Cluster-based interlace 0 with reference to RB-based interlace p includes subcarriers 0, 1, 2 and 3 of RBs p, p+10, p+20, . . . , and corresponds to cluster-based interlace p×3 in FIG. 3B, where the index of p×3 is globally numbered among total M×12/K cluster-based interlaces;
Cluster-based interlace 1 with reference to RB-based interlace p includes subcarriers 4, 5, 6 and 7 of RBs p, p+10, p+20, . . . , and corresponds to cluster-based interlace p×3+1 in FIG. 3B, where the index of p×3+1 is globally numbered among total M×12/K cluster-based interlaces; and
Cluster-based interlace 2 with reference to RB-based interlace p includes subcarriers 8, 9, 10 and 11 of RBs p, p+10, p+20, . . . , and corresponds to cluster-based interlace p×3+2 in FIG. 3B, where the index of p×3+2 is globally numbered among total M×12/K cluster-based interlaces.

For example, as shown in FIG. 3C, when K=3, there are 4 cluster-based interlaces per RB-based interlace,
Cluster-based interlace 0 with reference to RB-based interlace p includes subcarriers 0, 1 and 2 of RBs p, p+10, p+20, . . . , and corresponds to cluster-based interlace p×4 in FIG. 3C, where the index of p×4 is globally numbered among total M×12/K cluster-based interlaces;
Cluster-based interlace 1 with reference to RB-based interlace p includes subcarriers 3, 4 and 5 of RBs p, p+10, p+20, . . . , and corresponds to cluster-based interlace p×4+1 in FIG. 3C, where the index of p×4+1 is globally numbered among total M×12/K cluster-based interlaces;
Cluster-based interlace 2 with reference to RB-based interlace p includes subcarriers 6, 7 and 8 of RBs p, p+10, p+20, . . . , and corresponds to cluster-based interlace p×4+2 in FIG. 3C, where the index of p×4+2 is globally numbered among total M×12/K cluster-based interlaces; and
Cluster-based interlace 3 with reference to RB-based interlace p includes subcarriers 9, 10 and 11 of RBs p, p+10, p+20, . . . , and corresponds to cluster-based interlace p×4+3 in FIG. 3C, where the index of p×4+3 is globally numbered among total M×12/K cluster-based interlaces.

For example, as shown in FIG. 3D, when K=2, there are 6 cluster-based interlaces per RB-based interlace,
Cluster-based interlace 0 with reference to RB-based interlace p includes subcarriers 0 and 1 of RBs p, p+10, p+20, . . . , and corresponds to cluster-based interlace p×6 in FIG. 3D, where the index of p×6 is globally numbered among total M×12/K cluster-based interlaces;
Cluster-based interlace 1 with reference to RB-based interlace p includes subcarriers 2 and 3 of RBs p, p+10, p+20, . . . , and corresponds to cluster-based interlace p×6+1 in FIG. 3D, where the index of p×6+1 is globally numbered among total M×12/K cluster-based interlaces;
Cluster-based interlace 2 with reference to RB-based interlace p includes subcarriers 4 and 5 of RBs p, p+10, p+20, . . . , and corresponds to cluster-based interlace p×6+2 in FIG. 3D, where the index of p×6+2 is globally numbered among total M×12/K cluster-based interlaces;
Cluster-based interlace 3 with reference to RB-based interlace p includes subcarriers 6 and 7 of RBs p, p+10, p+20, . . . , and corresponds to cluster-based interlace p×6+3 in FIG. 3D, where the index of p×6+3 is globally numbered among total M×12/K cluster-based interlaces;
Cluster-based interlace 4 with reference to RB-based interlace p includes subcarriers 8 and 9 of RBs p, p+10, p+20, . . . , and corresponds to cluster-based interlace p×6+4 in FIG. 3D, where the index of p×6+4 is globally numbered among total M×12/K cluster-based interlaces; and
Cluster-based interlace 5 with reference to RB-based interlace p includes subcarriers 10 and 11 of RBs p, p+10, p+20, . . . , and corresponds to cluster-based interlace p×6+5 in FIG. 3D, where the index of p×6+5 is globally numbered among total M×12/K cluster-based interlaces.

For example, when K=1, there are 12 cluster-based interlaces per RB-based interlace,
Cluster-based interlace 0 with reference to RB-based interlace p includes subcarrier 0 of RBs p, p+10, p+20, . . . , and corresponds to the globally indexed cluster-based interlace p×12 among total M×12/K cluster-based interlaces;
Cluster-based interlace 1 with reference to RB-based interlace p includes subcarrier 1 of RBs p, p+10, p+20, . . . , and corresponds to the globally indexed cluster-based interlace p×12+1 among total M×12/K cluster-based interlaces;
Cluster-based interlace 2 with reference to RB-based interlace p includes subcarrier 2 of RBs p, p+10, p+20, . . . , and corresponds to the globally indexed cluster-based interlace p×12+2 among total M×12/K cluster-based interlaces;
Cluster-based interlace 3 with reference to RB-based interlace p includes subcarrier 3 of RBs p, p+10, p+20, . . . , and corresponds to the globally indexed cluster-based interlace p×12+3 among total M×12/K cluster-based interlaces;
Cluster-based interlace 4 with reference to RB-based interlace p includes subcarrier 4 of RBs p, p+10, p+20, . . . , and corresponds to the globally indexed cluster-based interlace p×12+4 among total M×12/K cluster-based interlaces;
Cluster-based interlace 5 with reference to RB-based interlace p includes subcarrier 5 of RBs p, p+10, p+20, . . . , and corresponds to the globally indexed cluster-based interlace p×12+5 among total M×12/K cluster-based interlaces;
Cluster-based interlace 6 with reference to RB-based interlace p includes subcarrier 6 of RBs p, p+10, p+20, . . . , and corresponds to the globally indexed cluster-based interlace p×12+6 among total M×12/K cluster-based interlaces;
Cluster-based interlace 7 with reference to RB-based interlace p includes subcarrier 7 of RBs p, p+10, p+20, . . . , and corresponds to the globally indexed cluster-based interlace p×12+7 among total M×12/K cluster-based interlaces;
Cluster-based interlace 8 with reference to RB-based interlace p includes subcarrier 8 of RBs p, p+10, p+20, . . . , and corresponds to the globally indexed cluster-based interlace p×12+8 among total M×12/K cluster-based interlaces;
Cluster-based interlace 9 with reference to RB-based interlace p includes subcarrier 9 of RBs p, p+10, p+20, . . . , and corresponds to the globally indexed cluster-based interlace p×12+9 among total M×12/K cluster-based interlaces;
Cluster-based interlace 10 with reference to RB-based interlace p includes subcarrier 10 of RBs p, p+10, p+20, . . . , and corresponds to the globally indexed cluster-based interlace p×12+10 among total M×12/K cluster-based interlaces; and
Cluster-based interlace 11 with reference to RB-based interlace p includes subcarrier 11 of RBs p, p+10, p+20, . . . , and corresponds to the globally indexed cluster-based interlace p×12+11 among total M×12/K cluster-based interlaces.

For 30 KHz SCS, M=5, and taking RB-based interlace p as the reference, it is assumed that RB-based interlace p includes RBs p, p+5, p+10, p+15, . . . , where p is the interlace index of the RB-based interlace and p∈{0, 1, 2, 3, 4} for 30 KHz SCS. For the cluster-based interlace structure, assuming K is the cluster size within one RB, K∈{1, 2, 3, 4, 6}, then RB-based interlace p comprises 12/K cluster-based interlaces. Assuming pᵢ is the index of a cluster-based interlace with reference to RB-based interlace p, i∈

$$\{ 0 , 1 , … , \frac{12}{K} - 1 \} ,$$

then cluster-based interlace pᵢ with reference to RB-based interlace p may include subcarrier i×K, i×K+1, . . . , i×K+K−1 of RB p, RB p+5, RB p+10, p+15, The M×12/K cluster-based interlaces may be indexed together (or globally) from 0 to M×12/K−1. Cluster-based interlace pᵢ with reference to RB-based interlace p may correspond to one of the M×12/K cluster-based interlaces with a global index of p×12/K+pᵢ.

For example, as shown in FIG. 3A, when K=6, there are 2 cluster-based interlaces per RB-based interlace,
Cluster-based interlace 0 with reference to RB-based interlace p includes subcarriers 0, 1, 2, 3, 4 and 5 of RBs p, p+5, p+10, p+15, . . . , and corresponds to cluster-based interlace p×2 in FIG. 3A, where the index of p×2 is globally numbered among total M×12/K cluster-based interlaces; and
Cluster-based interlace 1 with reference to RB-based interlace p includes subcarriers 6, 7, 8, 9, 10 and 11 of RBs p, p+5, p+10, p+15, . . . , and corresponds to cluster-based interlace p×2+1 in FIG. 3A, where the index of p×2+1 is globally numbered among total M×12/K cluster-based interlaces.

For example, as shown in FIG. 3B, when K=4, there are 3 cluster-based interlaces per RB-based interlace,
Cluster-based interlace 0 with reference to RB-based interlace p includes subcarriers 0, 1, 2 and 3 of RBs p, p+5, p+10, p+15, . . . , and corresponds to cluster-based interlace p×3 in FIG. 3B, where the index of p×3 is globally numbered among total M×12/K cluster-based interlaces;
Cluster-based interlace 1 with reference to RB-based interlace p includes subcarriers 4, 5, 6 and 7 of RBs p, p+5, p+10, p+15, . . . , and corresponds to cluster-based interlace p×3+1 in FIG. 3B, where the index of p×3+1 is globally numbered among total M×12/K cluster-based interlaces; and
Cluster-based interlace 2 with reference to RB-based interlace p includes subcarriers 8, 9, 10 and 11 of RBs p, p+5, p+10, p+15, . . . , and corresponds to cluster-based interlace p×3+2 in FIG. 3B, where the index of p×3+2 is globally numbered among total M×12/K cluster-based interlaces.

For example, as shown in FIG. 3C, when K=3, there are 4 cluster-based interlaces per RB-based interlace,
Cluster-based interlace 0 with reference to RB-based interlace p includes subcarriers 0, 1 and 2 of RBs p, p+5, p+10, p+15, . . . , and corresponds to cluster-based interlace p×4 in FIG. 3C, where the index of p×4 is globally numbered among total M×12/K cluster-based interlaces;
Cluster-based interlace 1 with reference to RB-based interlace p includes subcarriers 3, 4 and 5 of RBs p, p+5, p+10, p+15, . . . , and corresponds to cluster-based interlace p×4+1 in FIG. 3C, where the index of p×4+1 is globally numbered among total M×12/K cluster-based interlaces;
Cluster-based interlace 2 with reference to RB-based interlace p includes subcarriers 6, 7 and 8 of RBs p, p+5, p+10, p+15, . . . , and corresponds to cluster-based interlace p×4+2 in FIG. 3C, where the index of p×4+2 is globally numbered among total M×12/K cluster-based interlaces; and
Cluster-based interlace 3 with reference to RB-based interlace p includes subcarriers 9, 10 and 11 of RBs p, p+5, p+10, p+15, . . . , and corresponds to cluster-based interlace p×4+3 in FIG. 3C, where the index of p×4+3 is globally numbered among total M×12/K cluster-based interlaces.

For example, as shown in FIG. 3D, when K=2, there are 6 cluster-based interlaces per RB-based interlace,
Cluster-based interlace 0 with reference to RB-based interlace p includes subcarriers 0 and 1 of RBs p, p+5, p+10, p+15, . . . , and corresponds to cluster-based interlace p×6 in FIG. 3D, where the index of p×6 is globally numbered among total M×12/K cluster-based interlaces;
Cluster-based interlace 1 with reference to RB-based interlace p includes subcarriers 2 and 3 of RBs p, p+5, p+10, p+15, . . . , and corresponds to cluster-based interlace p×6+1 in FIG. 3D, where the index of p×6+1 is globally numbered among total M×12/K cluster-based interlaces;
Cluster-based interlace 2 with reference to RB-based interlace p includes subcarriers 4 and 5 of RBs p, p+5, p+10, p+15, . . . , and corresponds to cluster-based interlace p×6+2 in FIG. 3D, where the index of p×6+2 is globally numbered among total M×12/K cluster-based interlaces;
Cluster-based interlace 3 with reference to RB-based interlace p includes subcarriers 6 and 7 of RBs p, p+5, p+10, p+15, . . . , and corresponds to cluster-based interlace p×6+3 in FIG. 3D, where the index of p×6+3 is globally numbered among total M×12/K cluster-based interlaces;
Cluster-based interlace 4 with reference to RB-based interlace p includes subcarriers 8 and 9 of RBs p, p+5, p+10, p+15, . . . , and corresponds to cluster-based interlace p×6+4 in FIG. 3D, where the index of p×6+4 is globally numbered among total M×12/K cluster-based interlaces; and Cluster-based interlace 5 with reference to RB-based interlace p includes subcarriers 10 and 11 of RBs p, p+5, p+10, p+15, . . . , and corresponds to cluster-based interlace p×6+5 in FIG. 3D, where the index of p×6+5 is globally numbered among total M×12/K cluster-based interlaces.

For example, when K=1, there are 12 cluster-based interlaces per RB-based interlace,
Cluster-based interlace 0 with reference to RB-based interlace p includes subcarrier 0 of RBs p, p+5, p+10, p+15, . . . , and corresponds to the globally indexed cluster-based interlace p×12 among total M×12/K cluster-based interlaces;
Cluster-based interlace 1 with reference to RB-based interlace p includes subcarrier 1 of RBs p, p+5, p+10, p+15, . . . , and corresponds to the globally indexed cluster-based interlace p×12+1 among total M×12/K cluster-based interlaces;
Cluster-based interlace 2 with reference to RB-based interlace p includes subcarrier 2 of RBs p, p+5, p+10, p+15, . . . , and corresponds to the globally indexed cluster-based interlace p×12+2 among total M×12/K cluster-based interlaces;
Cluster-based interlace 3 with reference to RB-based interlace p includes subcarrier 3 of RBs p, p+5, p+10, p+15, . . . , and corresponds to the globally indexed cluster-based interlace p×12+3 among total M×12/K cluster-based interlaces;
Cluster-based interlace 4 with reference to RB-based interlace p includes subcarrier 4 of RBs p, p+5, p+10, p+15, . . . , and corresponds to the globally indexed cluster-based interlace p×12+4 among total M×12/K cluster-based interlaces;
Cluster-based interlace 5 with reference to RB-based interlace p includes subcarrier 5 of RBs p, p+5, p+10, p+15, . . . , and corresponds to the globally indexed cluster-based interlace p×12+5 among total M×12/K cluster-based interlaces;
Cluster-based interlace 6 with reference to RB-based interlace p includes subcarrier 6 of RBs p, p+5, p+10, p+15, . . . , and corresponds to the globally indexed cluster-based interlace p×12+6 among total M×12/K cluster-based interlaces;
Cluster-based interlace 7 with reference to RB-based interlace p includes subcarrier 7 of RBs p, p+5, p+10, p+15, . . . , and corresponds to the globally indexed cluster-based interlace p×12+7 among total M×12/K cluster-based interlaces;
Cluster-based interlace 8 with reference to RB-based interlace p includes subcarrier 8 of RBs p, p+5, p+10, p+15, . . . , and corresponds to the globally indexed cluster-based interlace p×12+8 among total M×12/K cluster-based interlaces;
Cluster-based interlace 9 with reference to RB-based interlace p includes subcarrier 9 of RBs p, p+5, p+10, p+15, . . . , and corresponds to the globally indexed cluster-based interlace p×12+9 among total M×12/K cluster-based interlaces;
Cluster-based interlace 10 with reference to RB-based interlace p includes subcarrier 10 of RBs p, p+5, p+10, p+15, . . . , and corresponds to the globally indexed cluster-based interlace p×12+10 among total M×12/K cluster-based interlaces; and
Cluster-based interlace 11 with reference to RB-based interlace p includes subcarrier 11 of RBs p, p+5, p+10, p+15, . . . , and corresponds to the globally indexed cluster-based interlace p×12+11 among total M×12/K cluster-based interlaces.

For 60 kHz SCS, to meet OCB requirements, the supported number of RB-based interlace may be 2 (e.g., M=2). Taking RB-based interlace p as the reference, it is assumed that RB-based interlace p includes RBs p, p+2, p+4, p+6, . . . , where p is the interlace index of the RB-based interlace and p∈{0, 1} for 60 kHz SCS. For the cluster-based interlace structure, assuming K is the cluster size within one RB, and K∈{1, 2, 3, 4, 6}, then RB-based interlace p comprises 12/K cluster-based interlaces. Assuming pᵢ is the index of a cluster-based interlace with reference to RB-based interlace p, i∈

$$\{ 0 , 1 , … , \frac{12}{K} - 1 \} ,$$

then cluster-based interlace pᵢ with reference to RB-based interlace p may include subcarrier i×K, i×K+1, . . . , i×K+K−1 of RB p, RB p+2, RB p+4, p+6, . . . . The M×12/K cluster-based interlaces may be indexed together (or globally) from 0 to M×12/K−1. Cluster-based interlace pᵢ with reference to RB-based interlace p may correspond to one of the M×12/K cluster-based interlaces with a global index of p×12/K+pᵢ.

For example, when K=6, there are 2 cluster-based interlaces per RB-based interlace,
Cluster-based interlace 0 with reference to RB-based interlace p includes subcarriers 0, 1, 2, 3, 4 and 5 of RBs p, p+2, p+4, p+6, . . . , and corresponds to cluster-based interlace p×2 in FIG. 3A, where the index of p×2 is globally numbered among total M×12/K cluster-based interlaces; and
Cluster-based interlace 1 with reference to RB-based interlace p includes subcarriers 6, 7, 8, 9, 10 and 11 of RBs p, p+2, p+4, p+6, . . . , and corresponds to cluster-based interlace p×2+1 in FIG. 3A, where the index of p×2+1 is globally numbered among total M×12/K cluster-based interlaces.

For example, when K=4, there are 3 cluster-based interlaces per RB-based interlace,
Cluster-based interlace 0 with reference to RB-based interlace p includes subcarriers 0, 1, 2 and 3 of RBs p, p+2, p+4, p+6, . . . , and corresponds to cluster-based interlace p×3 in FIG. 3B, where the index of p×3 is globally numbered among total M×12/K cluster-based interlaces;
Cluster-based interlace 1 with reference to RB-based interlace p includes subcarriers 4, 5, 6 and 7 of RBs p, p+2, p+4, p+6, . . . , and corresponds to cluster-based interlace p×3+1 in FIG. 3B, where the index of p×3+1 is globally numbered among total M×12/K cluster-based interlaces; and
Cluster-based interlace 2 with reference to RB-based interlace p includes subcarriers 8, 9, 10 and 11 of RBs p, p+2, p+4, p+6, . . . , and corresponds to cluster-based interlace p×3+2 in FIG. 3B, where the index of p×3+2 is globally numbered among total M×12/K cluster-based interlaces.

For example, when K=3, there are 4 cluster-based interlaces per RB-based interlace,
Cluster-based interlace 0 with reference to RB-based interlace p includes subcarriers 0, 1 and 2 of RBs p, p+2, p+4, p+6, . . . , and corresponds to cluster-based interlace p×4 in FIG. 3C, where the index of p×4 is globally numbered among total M×12/K cluster-based interlaces;
Cluster-based interlace 1 with reference to RB-based interlace p includes subcarriers 3, 4 and 5 of RBs p, p+2, p+4, p+6, . . . , and corresponds to cluster-based interlace p×4+1 in FIG. 3C, where the index of p×4+1 is globally numbered among total M×12/K cluster-based interlaces;
Cluster-based interlace 2 with reference to RB-based interlace p includes subcarriers 6, 7 and 8 of RBs p, p+2, p+4, p+6, . . . , and corresponds to cluster-based interlace p×4+2 in FIG. 3C, where the index of p×4+2 is globally numbered among total M×12/K cluster-based interlaces; and
Cluster-based interlace 3 with reference to RB-based interlace p includes subcarriers 9, 10 and 11 of RBs p, p+2, p+4, p+6, . . . , and corresponds to cluster-based interlace p×4+3 in FIG. 3C, where the index of p×4+3 is globally numbered among total M×12/K cluster-based interlaces.

For example, when K=2, there are 6 cluster-based interlaces per RB-based interlace,
Cluster-based interlace 0 with reference to RB-based interlace p includes subcarriers 0 and 1 of RBs p, p+2, p+4, p+6, . . . , and corresponds to cluster-based interlace p×6 in FIG. 3D, where the index of p×6 is globally numbered among total M×12/K cluster-based interlaces;
Cluster-based interlace 1 with reference to RB-based interlace p includes subcarriers 2 and 3 of RBs p, p+2, p+4, p+6, . . . , and corresponds to cluster-based interlace p×6+1 in FIG. 3D, where the index of p×6+1 is globally numbered among total M×12/K cluster-based interlaces;
Cluster-based interlace 2 with reference to RB-based interlace p includes subcarriers 4 and 5 of RBs p, p+2, p+4, p+6, . . . , and corresponds to cluster-based interlace p×6+2 in FIG. 3D, where the index of p×6+2 is globally numbered among total M×12/K cluster-based interlaces;
Cluster-based interlace 3 with reference to RB-based interlace p includes subcarriers 6 and 7 of RBs p, p+2, p+4, p+6, . . . , and corresponds to cluster-based interlace p×6+3 in FIG. 3D, where the index of p×6+3 is globally numbered among total M×12/K cluster-based interlaces;
Cluster-based interlace 4 with reference to RB-based interlace p includes subcarriers 8 and 9 of RBs p, p+2, p+4, p+6, . . . , and corresponds to cluster-based interlace p×6+4 in FIG. 3D, where the index of p×6+4 is globally numbered among total M×12/K cluster-based interlaces; and
Cluster-based interlace 5 with reference to RB-based interlace p includes subcarriers 10 and 11 of RBs p, p+2, p+4, p+6, . . . , and corresponds to cluster-based interlace p×6+5 in FIG. 3D, where the index of p×6+5 is globally numbered among total M×12/K cluster-based interlaces.

For example, when K=1, there are 12 cluster-based interlaces per RB-based interlace,
Cluster-based interlace 0 with reference to RB-based interlace p includes subcarrier 0 of RBs p, p+2, p+4, p+6, . . . , and corresponds to the globally indexed cluster-based interlace p×12 among total M×12/K cluster-based interlaces;
Cluster-based interlace 1 with reference to RB-based interlace p includes subcarrier 1 of RBs p, p+2, p+4, p+6, . . . , and corresponds to the globally indexed cluster-based interlace p×12+1 among total M×12/K cluster-based interlaces;
Cluster-based interlace 2 with reference to RB-based interlace p includes subcarrier 2 of RBs p, p+2, p+4, p+6, . . . , and corresponds to the globally indexed cluster-based interlace p×12+2 among total M×12/K cluster-based interlaces;
Cluster-based interlace 3 with reference to RB-based interlace p includes subcarrier 3 of RBs p, p+2, p+4, p+6, . . . , and corresponds to the globally indexed cluster-based interlace p×12+3 among total M×12/K cluster-based interlaces;
Cluster-based interlace 4 with reference to RB-based interlace p includes subcarrier 4 of RBs p, p+2, p+4, p+6, . . . , and corresponds to the globally indexed cluster-based interlace p×12+4 among total M×12/K cluster-based interlaces;
Cluster-based interlace 5 with reference to RB-based interlace p includes subcarrier 5 of RBs p, p+2, p+4, p+6, . . . , and corresponds to the globally indexed cluster-based interlace p×12+5 among total M×12/K cluster-based interlaces;
Cluster-based interlace 6 with reference to RB-based interlace p includes subcarrier 6 of RBs p, p+2, p+4, p+6, . . . , and corresponds to the globally indexed cluster-based interlace p×12+6 among total M×12/K cluster-based interlaces;
Cluster-based interlace 7 with reference to RB-based interlace p includes subcarrier 7 of RBs p, p+2, p+4, p+6, . . . , and corresponds to the globally indexed cluster-based interlace p×12+7 among total M×12/K cluster-based interlaces;
Cluster-based interlace 8 with reference to RB-based interlace p includes subcarrier 8 of RBs p, p+2, p+4, p+6, . . . , and corresponds to the globally indexed cluster-based interlace p×12+8 among total M×12/K cluster-based interlaces;
Cluster-based interlace 9 with reference to RB-based interlace p includes subcarrier 9 of RBs p, p+2, p+4, p+6, . . . , and corresponds to the globally indexed cluster-based interlace p×12+9 among total M×12/K cluster-based interlaces;
Cluster-based interlace 10 with reference to RB-based interlace p includes subcarrier 10 of RBs p, p+2, p+4, p+6, . . . , and corresponds to the globally indexed cluster-based interlace p×12+10 among total M×12/K cluster-based interlaces; and
Cluster-based interlace 11 with reference to RB-based interlace p includes subcarrier 11 of RBs p, p+2, p+4, p+6, . . . , and corresponds to the globally indexed cluster-based interlace p×12+11 among total M×12/K cluster-based interlaces.

For 120 KHz SCS, since each RB occupies 1.44 MHz bandwidth, the RB-based interlace including RBs equally spaced in the frequency domain cannot meet the PSD requirements. However, the RB-based interlace can still meet OCB requirements. It is assumed that there are P RB-based interlaces specified for 120 kHz SCS (e.g., P=2, 3, 4, 5, 6, 8, 10 etc.), that is, every two consecutive RB-based interlaces are spaced with P RBs. It is further assumed that RB-based interlace p includes RBs p, p+P, p+2P, p+3P, . . . , where p is the interlace index of the RB-based interlace and pe {0, 1, 2, . . . , P−1} for 120 kHz SCS. For the cluster-based interlace structure, assuming K is the cluster size within one RB, K∈{1, 2, 3, 4, 6}, then RB-based interlace p comprises 12/K cluster-based interlaces. Assuming pᵢ is the index of a cluster-based interlace with reference to RB-based interlace p, i∈

$$\{ 0 , 1 , … , \frac{12}{K} - 1 \} ,$$

then the cluster-based interlace pᵢ comprises subcarrier i×K, i×K+1, . . . , i×K+K−1 of RB p, RB p+P, RB p+2P, p+3P, . . . . The M×12/K or P×12/K (M=P) cluster-based interlaces may be indexed together (or globally) from 0 to M×12/K−1 or P×12/K−1 (M=P). Cluster-based interlace pᵢ with reference to RB-based interlace p may correspond to one of the M×12/K or P×12/K (M=P) cluster-based interlaces with a global index of p×12/K+pᵢ.

For example, when K=6, there are 2 cluster-based interlaces per RB-based interlace,
Cluster-based interlace 0 with reference to RB-based interlace p includes subcarriers 0, 1, 2, 3, 4 and 5 of RBs p, p+P, p+2P, p+3P, . . . , and corresponds to cluster-based interlace p×2, where the index of p×2 is globally numbered among total P×12/K cluster-based interlaces; and
Cluster-based interlace 1 with reference to RB-based interlace p includes subcarriers 6, 7, 8, 9, 10 and 11 of RBs p, p+P, p+2P, p+3P, . . . , and corresponds to cluster-based interlace p×2+1, where the index of p×2+1 is globally numbered among total P×12/K cluster-based interlaces.

For example, when K=4, there are 3 cluster-based interlaces per RB-based interlace,
Cluster-based interlace 0 with reference to RB-based interlace p includes subcarriers 0, 1, 2 and 3 of RBs p, p+P, p+2P, p+3P, . . . , and corresponds to cluster-based interlace p×3, where the index of p×3 is globally numbered among total P×12/K cluster-based interlaces;
Cluster-based interlace 1 with reference to RB-based interlace p includes subcarriers 4, 5, 6 and 7 of RBs p, p+P, p+2P, p+3P, . . . , and corresponds to cluster-based interlace p×3+1, where the index of p×3+1 is globally numbered among total P×12/K cluster-based interlaces; and
Cluster-based interlace 2 with reference to RB-based interlace p includes subcarriers 8, 9, 10 and 11 of RBs p, p+P, p+2P, p+3P, . . . , and corresponds cluster-based to interlace p×3+2, where the index of p×3+2 is globally numbered among total P×12/K cluster-based interlaces.

For example, when K=3, there are 4 cluster-based interlaces per RB-based interlace,
Cluster-based interlace 0 with reference to RB-based interlace p includes subcarriers 0, 1 and 2 of RBs p, p+P, p+2P, p+3P, . . . , and corresponds to cluster-based interlace p×4, where the index of p×4 is globally numbered among total P×12/K cluster-based interlaces;
Cluster-based interlace 1 with reference to RB-based interlace p includes subcarriers 3, 4 and 5 of RBs p, p+P, p+2P, p+3P, . . . , and corresponds to cluster-based interlace p×4+1, where the index of p×4+1 is globally numbered among total P×12/K cluster-based interlaces;
Cluster-based interlace 2 with reference to RB-based interlace p includes subcarriers 6, 7 and 8 of RBs p, p+P, p+2P, p+3P, . . . , and corresponds to cluster-based interlace p×4+2, where the index of p×4+2 is globally numbered among total P×12/K cluster-based interlaces; and
Cluster-based interlace 3 with reference to RB-based interlace p includes subcarriers 9, 10 and 11 of RBs p, p+P, p+2P, p+3P, . . . , and corresponds to cluster-based interlace p×4+3, where the index of p×4+3 is globally numbered among total P×12/K cluster-based interlaces.

For example, when K=2, there are 6 cluster-based interlaces per RB-based interlace,
Cluster-based interlace 0 with reference to RB-based interlace p includes subcarriers 0 and 1 of RBs p, p+P, p+2P, p+3P, . . . , and corresponds to cluster-based interlace p×6, where the index of p×6 is globally numbered among total P×12/K cluster-based interlaces;
Cluster-based interlace 1 with reference to RB-based interlace p includes subcarriers 2 and 3 of RBs p, p+P, p+2P, p+3P, . . . , and corresponds to cluster-based interlace p×6+1, where the index of p×6+1 is globally numbered among total P×12/K cluster-based interlaces;
Cluster-based interlace 2 with reference to RB-based interlace p includes subcarriers 4 and 5 of RBs p, p+P, p+2P, p+3P, . . . , and corresponds to cluster-based interlace p×6+2, where the index of p×6+2 is globally numbered among total P×12/K cluster-based interlaces;
Cluster-based interlace 3 with reference to RB-based interlace p includes subcarriers 6 and 7 of RBs p, p+P, p+2P, p+3P, . . . , and corresponds to cluster-based interlace p×6+3, where the index of p×6+3 is globally numbered among total P×12/K cluster-based interlaces;
Cluster-based interlace 4 with reference to RB-based interlace p includes subcarriers 8 and 9 of RBs p, p+P, p+2P, p+3P, . . . , and corresponds to cluster-based interlace p×6+4, where the index of p×6+4 is globally numbered among total P×12/K cluster-based interlaces; and
Cluster-based interlace 5 with reference to RB-based interlace p includes subcarriers 10 and 11 of RBs p, p+P, p+2P, p+3P, . . . , and corresponds to cluster-based interlace p×6+5, where the index of p×6+5 is globally numbered among total P×12/K cluster-based interlaces.

For example, when K=1, there are 12 cluster-based interlaces per RB-based interlace,
Cluster-based interlace 0 with reference to RB-based interlace p includes subcarrier 0 of RBs p, p+P, p+2P, p+3P, . . . , and corresponds to the globally indexed cluster-based interlace p×12 among total P×12/K cluster-based interlaces;
Cluster-based interlace 1 with reference to RB-based interlace p includes subcarrier 1 of RBs p, p+P, p+2P, p+3P, . . . , and corresponds to the globally indexed cluster-based interlace p×12+1 among total P×12/K cluster-based interlaces;
Cluster-based interlace 2 with reference to RB-based interlace p includes subcarrier 2 of RBs p, p+P, p+2P, p+3P, . . . , and corresponds to the globally indexed cluster-based interlace p×12+2 among total P×12/K cluster-based interlaces;
Cluster-based interlace 3 with reference to RB-based interlace p includes subcarrier 3 of RBs p, p+P, p+2P, p+3P, . . . , and corresponds to the globally indexed cluster-based interlace p×12+3 among total P×12/K cluster-based interlaces;
Cluster-based interlace 4 with reference to RB-based interlace p includes subcarrier 4 of RBs p, p+P, p+2P, p+3P, . . . , and corresponds to the globally indexed cluster-based interlace p×12+4 among total P×12/K cluster-based interlaces;
Cluster-based interlace 5 with reference to RB-based interlace p includes subcarrier 5 of RBs p, p+P, p+2P, p+3P, . . . , and corresponds to the globally indexed cluster-based interlace p×12+5 among total P×12/K cluster-based interlaces;
Cluster-based interlace 6 with reference to RB-based interlace p includes subcarrier 6 of RBs p, p+P, p+2P, p+3P, . . . , and corresponds to the globally indexed cluster-based interlace p×12+6 among total P×12/K cluster-based interlaces;
Cluster-based interlace 7 with reference to RB-based interlace p includes subcarrier 7 of RBs p, p+P, p+2P, p+3P, . . . , and corresponds to the globally indexed cluster-based interlace p×12+7 among total P×12/K cluster-based interlaces;
Cluster-based interlace 8 with reference to RB-based interlace p includes subcarrier 8 of RBs p, p+P, p+2P, p+3P, . . . , and corresponds to the globally indexed cluster-based interlace p×12+8 among total P×12/K cluster-based interlaces;
Cluster-based interlace 9 with reference to RB-based interlace p includes subcarrier 9 of RBs p, p+P, p+2P, p+3P, . . . , and corresponds to the globally indexed cluster-based interlace p×12+9 among total P×12/K cluster-based interlaces;
Cluster-based interlace 10 with reference to RB-based interlace p includes subcarrier 10 of RBs p, p+P, p+2P, p+3P, . . . , and corresponds to the globally indexed cluster-based interlace p×12+10 among total P×12/K cluster-based interlaces; and
Cluster-based interlace 11 with reference to RB-based interlace p includes subcarrier 11 of RBs p, p+P, p+2P, p+3P, . . . , and corresponds to the globally indexed cluster-based interlace p×12+11 among total P×12/K cluster-based interlaces.

As can be seen from the above, with the cluster-based interlace, the PSFCH capacity can be proportionally increased dependent on the cluster size. It is worth noting that the cluster-based interlace can be also applied to other sidelink channels, such as PSCCH, PSSCH and physical sidelink broadcast channel (PSBCH), besides PSFCH.

In some embodiments, a PSFCH transmission may be constrained within one RB set, which is also named an LBT bandwidth or channel bandwidth and may be approximate 20 MHz.

Within a PSFCH resource pool, the cluster-based interlaces have the same structure. Each cluster-based interlace includes equal number of subcarriers within one RB. The cluster-based interlaces are configured with the same subcarrier spacing and the same cluster size.

To indicate the cluster-based interlace, a PSFCH resource pool configuration may indicate at least one of the following: (a) an index of an RB set for the PSFCH; (b) subcarrier spacing of the carrier; (c) a cluster size (i.e., the number of contiguous subcarriers per cluster) (e.g., the value of K); (d) the number of subcarriers per cluster per RB; (e) the number of clusters per RB-based interlace; or (f) a subcarrier-to-cluster mapping type. The PSFCH resource pool configuration may be configured for a UE via RRC signaling or predefined in, for example, a standard(s).

In some embodiments, parameter (a) may be implicitly determined, and thus not included in the PSFCH resource pool configuration. In some embodiments, parameter (b) may be implicitly determined (for example, the same as the one for PSSCH corresponding to the PSFCH), and thus not included in the PSFCH resource pool configuration. In some embodiments, parameter (f) may not be included in the PSFCH resource pool configuration when, for example, only a single mapping type (e.g., “non-interleaved subcarrier-to-cluster mapping”) is supported, enabled or allowed.

In some embodiments, the PSFCH resource pool configuration may include none, only one, or more than one of parameters (c)-(e). For example, since there is only a single cluster within one RB, the value of parameter (c) (e.g., K) is equal to that of parameter (d), and parameter (e) can be determined based on parameter (c) or parameter (d), or vice versa. For example, any one of parameters (c)-(e) may be predefined in, for example, a standard(s).

The above parameters are only for illustrative purposes. Various other parameters or parameter combinations may be included in the resource pool configuration as long as it can define the structure of the cluster-based interlace.

Various methods may be employed to determine the corresponding RB set for a PSFCH transmission on the carrier. Various methods may be employed to determine the cluster-based interlace in the RB set for the PSFCH transmission. In some embodiments, a UE may first determine an RB set for a PSFCH transmission and then determine which cluster-based interlace in the RB set is used for the PSFCH transmission. In some embodiments, a UE may determine a number of cluster-based interlaces on a number of RB sets for a PSFCH transmission, and then determine which cluster-based interlace among the number of cluster-based interlaces is used for the PSFCH transmission.

For example, in a first embodiment, the RB set used for a PSFCH transmission may be a predefined (e.g., the lowest or highest in the frequency domain) RB set of one or more RB sets for transmitting the PSSCH corresponding to the PSFCH. In a second embodiment, the RB set used for a PSFCH transmission may be explicitly indicated in the PSFCH resource pool as described above.

For example, in a third embodiment, a PSFCH transmission can have multiple transmission opportunities on multiple RB sets in the frequency domain. In some examples, the multiple RB sets can be the one or more RB sets for transmitting the PSSCH corresponding to the PSFCH. In some examples, the multiple RB sets can be all RB sets on the carrier. Although there are multiple transmission opportunities, the PSFCH may be transmitted in at most one of the multiple RB sets subject to the outcomes of LBT tests on the multiple RB sets. In the case that the LBT tests for more than one RB set of the multiple RB sets are successful, the PSFCH may be transmitted in a predefined RB set (e.g., the lowest or highest in the frequency domain) of the more than one RB set with a successful LBT test. In the case that the LBT tests for all of the multiple RB sets fail, the PSFCH transmission would be dropped.

The specific cluster-based interlace used for the PSFCH transmission in the RB set (which can be determined according to one of the above methods or other similar methods) may be dependent on the total number of available PSFCH resources (denoted as R). In some embodiments, for a PSSCH received on z RB-based interlaces in slot #n and scheduled by an associated SCI, a UE may determine an index of a PSFCH resource (e.g., the index of the cluster-based interlace) for a PSFCH transmission corresponding to the PSSCH based on: R; a physical layer source ID (denoted as P_{ID}) indicated in the SCI scheduling the PSSCH; and an ID of the UE in a UE group (denoted as M_{ID})) in the case that groupcast ACK or NACK based HARQ-ACK feedback is enabled (e.g., as indicated by the SCI), or otherwise, M_{ID} is zero. In some examples, M_{ID} may be indicated by a higher layer(s) (e.g., RRC layer). For example, the index of the PSFCH resource (e.g., the index of the cluster-based interlace) for the PSFCH transmission may be determined according to (P_{ID}+M_{ID}) mod R.

Various methods may be employed to determine the value of R.

In some embodiments, the value of R may refer to the total number of PSFCH resources (e.g., cluster-based interlaces) available within the PSFCH resource pool. The R PSFCH resources are on all the available cluster-based interlaces with one PSFCH transmission on one cluster-based interlace.

For example, without consideration of code-division multiplexing (CDM) or time-division multiplexing (TDM) based multiple UEs multiplexing on the same cluster-based interlace for PSFCH transmission, different UEs in a UE group may have different cluster-based interlaces for transmitting multiple PSFCHs at the same time on the same carrier. Therefore, the total number of PSFCH resources available for PSFCH transmission may be dependent on the total number of cluster-based interlaces, or the number of RB-based interlaces and the cluster size. For example, R=M×12/K, where M is the number of RB-based interlaces dependent on subcarrier spacing of the carrier, and K is the cluster size. For 15 kHz SCS, R may be equal to 20, 30, 40, 60 or 120 for a cluster size of 6, 4, 3, 2 or 1, respectively. For 30 kHz SCS, R may be equal to 10, 15, 20, 30, or 60 for a cluster size of 6, 4, 3, 2 or 1, respectively.

With CDM-based multiplexing, the total number of PSFCH resources available for PSFCH transmission may be further dependent on the number of cyclic shift pairs supported for the PSFCH resource pool (denoted as N_{cs}). For example, R=N_{cs}×M×12/K. With TDM-based multiplexing, the total number of PSFCH resources available for PSFCH transmission may be further dependent on the number of PSFCH transmission occasions within a PSFCH slot (denoted as B). For example, R=B×M×12/K. With CDM and TDM-based multiplexing, the total number of PSFCH resources available for PSFCH transmission may be further dependent on N_{cs} and B. For example, R=N_{cs}×B×M×12/K.

In some embodiments, the value of R may refer to the total number of PSFCH resources (e.g., cluster-based interlaces) available for multiplexing HARQ-ACK information in a PSFCH transmission corresponding to slot #n and the z RB-based interlaces for the PSSCH transmission.

For example, without consideration of CDM or TDM-based multiple UEs multiplexing on the same cluster-based interlace for PSFCH transmission, different UEs in a UE group may have different cluster-based interlaces for transmitting multiple PSFCHs at the same time on the same carrier. Therefore, the total number of PSFCH resources available for PSFCH transmission may be dependent on the total number of cluster-based interlaces corresponding to the PSSCH transmission. For example, R=z×12/K, where z is the number of RB-based interlaces allocated for the PSSCH transmission, and K is the cluster size. When z=1, for 15 kHz SCS, R may be equal to 2, 3, 4, 6 or 12 for a cluster size of 6, 4, 3, 2 or 1, respectively; and for 30 kHz SCS, R may be equal to 2, 3, 4, 6 or 12 for a cluster size of 6, 4, 3, 2 or 1, respectively.

With CDM-based multiplexing, the total number of PSFCH resources available for PSFCH transmission may be further dependent on the number of cyclic shift pairs supported for the PSFCH resource pool (e.g., N_{cs}). For example, R=N_{cs}×z×12/K. With TDM-based multiplexing, the total number of PSFCH resources available for PSFCH transmission may be further dependent on the number of PSFCH transmission occasions within a PSFCH slot (e.g., B). For example, R=B×z×12/K. With CDM and TDM-based multiplexing, the total number of PSFCH resources available for PSFCH transmission may be further dependent on N_{cs} and B. For example, R=N_{cs}×B×z×12/K.

For example, in a fourth embodiment, the RB set used for a PSFCH transmission may be one of the RB sets for transmitting the PSSCH corresponding to the PSFCH, or one of the RB sets within the PSFCH resource pool. The specific RB set may be implicitly determined based on the PSFCH resource index (e.g., index of the cluster-based interlace) among available PSFCH resources within the PSFCH resource pool.

For example, in the fourth embodiment, similar to the above embodiments, the specific cluster-based interlace used for the PSFCH transmission may be dependent on the total number of available PSFCH resources (e.g., R). For example, a UE may determine an index of a PSFCH resource (e.g., the index of the cluster-based interlace) for a PSFCH transmission corresponding to a PSSCH based on: R, P_{ID}, and M_{ID}, for example, according to (P_{ID}+M_{ID}) mod R.

In the fourth embodiment, the total number of available PSFCH resources (e.g., R) may refer to the number of RB sets for transmitting the PSSCH corresponding to the PSFCH, or the number of the RB set(s) within the PSFCH resource pool.

For example, in the fourth embodiment, without consideration of CDM or TDM-based multiple UEs multiplexing on the same cluster-based interlace for PSFCH transmission, the total number of PSFCH resources available for PSFCH transmission (e.g., R) may be dependent on the number of RB sets for transmitting the PSSCH corresponding to the PSFCH, or the number of the RB set(s) within the PSFCH resource pool (denoted as D). For example, R=D×M×12/K, where M is the number of RB-based interlaces dependent on subcarrier spacing of the carrier, and K is the cluster size.

With CDM-based multiplexing, the total number of PSFCH resources available for PSFCH transmission may be further dependent on the number of cyclic shift pairs supported for the PSFCH resource pool (e.g., N_{cs}). For example, R=N_{cs}×D×M×12/K. With TDM-based multiplexing, the total number of PSFCH resources available for PSFCH transmission may be further dependent on the number of PSFCH transmission occasions within a PSFCH slot (e.g., B). For example, R=B×D×M×12/K. With CDM and TDM-based multiplexing, the total number of PSFCH resources available for PSFCH transmission may be further dependent on N_{cs} and B. For example, R=N_{cs}×B×D×M×12/K.

In some embodiments of the present disclosure, for a cluster-based interlace one or more clusters may be included within one RB. In the case that there is only one cluster per cluster-based interlace within one RB, each cluster-based interlace may include a set of clusters equally spaced in the frequency domain, which is the “non-interleaved subcarrier-to-cluster mapping” or “localized subcarrier-to-cluster mapping” as described above. In the case that there is more than one cluster per cluster-based interlace within one RB, each cluster-based interlace may include a set of clusters equally spaced within each RB associated with the corresponding cluster-based interlace, which is also referred to as “interleaved subcarrier-to-cluster mapping”.

In these embodiments, a reference RB-based interlace can be partitioned into multiple cluster-based interlaces, and the number of cluster-based interlaces of the reference RB-based interlace is dependent on the cluster size of a cluster-based interlace and the number of clusters within an RB (or the number of clusters per RB). The cluster size multiplying the number of clusters per RB should be equal to the number of subcarriers per RB.

In some embodiments, the cluster size, i.e., the number of subcarriers within one cluster of a cluster-based interlace (e.g., K), can be 6, 4, 3, 2 or 1. The number of clusters within an RB (e.g., C) can be 1, 2, 3, 4, 6 or 12. The possible cluster-based interlace structures can include a 6 subcarrier-based interlace, 4 subcarrier-based interlace, 3 subcarrier-based interlace, 2 subcarrier-based interlace and 1 subcarrier-based interlace, where X subcarrier-based interlace means that there are a total of X subcarriers within each RB for a cluster-based interlace. Therefore, for a cluster-based interlace, X=K×C.

For 15 kHz or 30 kHz SCS, the number of RBs of each RB-based interlace may be equal to 10 or 11, and thus the number of subcarriers of each cluster-based interlace may be equal to 10×X or 11×X. A reference RB-based interlace can be partitioned into 12/X cluster-based interlaces and each of the 12/X cluster-based interlaces may include 120/X or 132/X subcarriers within one RB set.

A mentioned above, two subcarrier-to-cluster mapping types may be employed for a cluster-based interlace to map the X subcarriers per RB.

A first type is the “non-interleaved subcarrier-to-cluster mapping” or “localized subcarrier-to-cluster mapping,” where there is only one cluster within one RB of a reference RB-based interlace for a cluster-based interlace and each cluster-based interlace with non-interleaved/localized subcarrier-to-cluster mapping may include a set of equally spaced clusters in the frequency domain (e.g., in the frequency bandwidth of a carrier).

For example, for an X subcarrier-based interlace, there is a single cluster within each RB and the single cluster includes X contiguous subcarriers. For example, assuming that X=6, then K=6 since C=1. So the reference RB-based interlace can be partitioned into 2 cluster-based interlaces. For example, assuming that X=4, then K=4 since C=1. So the reference RB-based interlace can be partitioned into 3 cluster-based interlaces. For example, assuming that X=3, then K=3 since C=1. So the reference RB-based interlace can be partitioned into 4 cluster-based interlaces. For example, assuming that X=2, then K=2 since C=1. So the reference RB-based interlace can be partitioned into 6 cluster-based interlaces. For example, assuming that X=1, then K=1 since C=1. So the reference RB-based interlace can be partitioned into 12 cluster-based interlaces.

A second type is the “interleaved subcarrier-to-cluster mapping,” where there are multiple clusters within one RB of the reference RB-based interlace for a cluster-based interlace and each cluster-based interlace with interleaved subcarrier-to-cluster mapping may include a set of equally spaced clusters within each RB of the cluster-based interlace.

For example, for an X subcarrier-based interlace, there are C clusters within each RB and each of the C clusters includes K contiguous subcarriers. For example, assuming that X=6, the reference RB-based interlace can be partitioned into 2 cluster-based interlaces. For example, further assuming that K=3, then C=2. So there are 2 clusters per RB and each cluster comprises 3 contiguous subcarriers. For example, further assuming that K=2, then C=3. So there are 3 clusters per RB and each cluster comprises 2 contiguous subcarriers. For example, further assuming that K=1, then C=6. So there are 6 clusters per RB and each cluster comprises 1 subcarrier. For example, further assuming that K=6, then C=1. So there is 1 cluster per RB and the cluster comprises 6 contiguous subcarriers. This is the same as the non-interleaved mapping as mentioned above.

For example, assuming that X=4, the reference RB-based interlace can be partitioned into 3 cluster-based interlaces. For example, further assuming that K=2, then C=2. So there are 2 clusters per RB and each cluster comprises 2 contiguous subcarriers. For example, further assuming that K=1, then C=4. So there are 4 clusters per RB and each cluster comprises 1 subcarrier. For example, further assuming that K=4, then C=1. So there is 1 cluster per RB and the cluster comprises 4 contiguous subcarriers. This is the same as the non-interleaved mapping as mentioned above.

For example, assuming that X=3, the reference RB-based interlace can be partitioned into 4 cluster-based interlaces. For example, further assuming that K=1, then C=3. So there are 3 clusters per RB and each cluster comprises 1 subcarrier. For example, further assuming that K=3, then C=1. So there is 1 cluster per RB and the cluster comprises 3 contiguous subcarriers. This is the same as the non-interleaved mapping as mentioned above.

For example, assuming that X=2, the reference RB-based interlace can be partitioned into 6 cluster-based interlaces. For example, further assuming that K=1, then C=2. So there are 2 clusters per RB and each cluster comprises 1 subcarrier. For example, further assuming that K=2, then C=1. So there is 1 cluster per RB and the cluster comprises 2 contiguous subcarriers. This is the same as the non-interleaved mapping as mentioned above.

For example, assuming that X=1, the reference RB-based interlace can be partitioned into 12 cluster-based interlaces and K=1 and C=1. So there is 1 cluster per RB and the cluster comprises 1 subcarrier. This is the same as the non-interleaved mapping as mentioned above.

The total number of cluster-based interlaces is dependent on the number of RB-based interlaces (e.g., M) dependent on subcarrier spacing and the total number of subcarriers per RB for each cluster-based interlace (e.g., X). For example, the total number of cluster-based interlaces can be denoted as M×12/X.

For example, for 15 kHz SCS, the total number of RB-based interlaces may be 10, so the total number of cluster-based interlaces is 20, 30, 40, 60, or 120 for X equal to 6, 4, 3, 2, or 1, respectively. For example, for 30 kHz SCS, the total number of RB-based interlaces may be 5, so the total number of cluster-based interlaces is 10, 15, 20, 30, or 60 for X equal to 6, 4, 3, 2, or 1, respectively. For each cluster-based interlace structure, regardless of the value of X (e.g., 6, 4, 3, 2 or 1), both OCB and PSD requirements can be met. Such cluster-based interlace can achieve better power utilization under PSD limits due to sparser frequency resources transmitted per 1 MHz.

For 15 kHz SCS, M=10, taking RB-based interlace p as the reference, it is assumed that RB-based interlace p comprises RBs p, p+10, p+20, . . . , where p is the interlace index of the RB-based interlace and p∈{0, 1, 2, . . . , 9} for 15 kHz SCS. For the cluster-based interlace structure, assuming X is the total number of subcarriers per RB, and X∈{1, 2, 3, 4, 6}, then RB-based interlace p comprises 12/X cluster-based interlaces. It is further assumed that pᵢ is the index of a cluster-based interlace with reference to RB-based interlace p, i∈

$$\{ 0 , 1 , … , \frac{12}{X} - 1 \} .$$

For the non-interleaved subcarrier-to-cluster mapping, cluster-based interlace pᵢ with reference to RB-based interlace p may include subcarrier i×X, i×X+1, . . . , i×X+X−1 of RB p, RB p+10, RB p+20, The M×12/X cluster-based interlaces may be indexed together (or globally) from 0 to M×12/X−1. Cluster-based interlace pᵢ with reference to RB-based interlace p may correspond to one of the M×12/X cluster-based interlaces with a (global) index of p×12/X+pᵢ. Alternatively, the cluster-based interlace may be firstly indexed corresponding to the reference RB-based interlace and then indexed to a specific cluster-based interlace among multiple cluster-based interlaces with same reference RB-based interlace. For example, as described above, cluster-based interlace pᵢ, i∈

$$\{ 0 , 1 , … , \frac{12}{K} - 1 \} ,$$

is indexed corresponding to 12/K cluster-based interlace of the reference RB-based interlace p. This detail of this alternative is not repeated here.

For example, as shown in FIG. 3A, when X=K=6, there are 2 cluster-based interlaces per RB-based interlace,
Cluster-based interlace 0 with reference to RB-based interlace p includes subcarriers 0, 1, 2, 3, 4 and 5 of RBs p, p+10, p+20, . . . , and corresponds to cluster-based interlace p×2 in FIG. 3A, where the index of p×2 is globally numbered among total M×12/K cluster-based interlaces; and
Cluster-based interlace 1 with reference to RB-based interlace p includes subcarriers 6, 7, 8, 9, 10 and 11 of RBs p, p+10, p+20, . . . , and corresponds to cluster-based interlace p×2+1 in FIG. 3A, where the index of p×2+1 is globally numbered among total M×12/K cluster-based interlaces.

For example, as shown in FIG. 3B, when X=K=4, there are 3 cluster-based interlaces per RB-based interlace,
Cluster-based interlace 0 with reference to RB-based interlace p includes subcarriers 0, 1, 2 and 3 of RBs p, p+10, p+20, . . . , and corresponds to cluster-based interlace p×3 in FIG. 3B, where the index of p×3 is globally numbered among total M×12/K cluster-based interlaces;
Cluster-based interlace 1 with reference to RB-based interlace p includes subcarriers 4, 5, 6 and 7 of RBs p, p+10, p+20, . . . , and corresponds to cluster-based interlace p×3+1 in FIG. 3B, where the index of p×3+1 is globally numbered among total M×12/K cluster-based interlaces; and
Cluster-based interlace 2 with reference to RB-based interlace p includes subcarriers 8, 9, 10 and 11 of RBs p, p+10, p+20, . . . , and corresponds to cluster-based interlace p×3+2 in FIG. 3B, where the index of p×3+2 is globally numbered among total M×12/K cluster-based interlaces.

For example, as shown in FIG. 3C, when X=K=3, there are 4 cluster-based interlaces per RB-based interlace,
Cluster-based interlace 0 with reference to RB-based interlace p includes subcarriers 0, 1 and 2 of RBs p, p+10, p+20, . . . , and corresponds to cluster-based interlace p×4 in FIG. 3C, where the index of p×4 is globally numbered among total M×12/K cluster-based interlaces;
Cluster-based interlace 1 with reference to RB-based interlace p includes subcarriers 3, 4 and 5 of RBs p, p+10, p+20, . . . , and corresponds to cluster-based interlace p×4+1 in FIG. 3C, where the index of p×4+1 is globally numbered among total M×12/K cluster-based interlaces; and
Cluster-based interlace 2 with reference to RB-based interlace p includes subcarriers 6, 7 and 8 of RBs p, p+10, p+20, . . . , and corresponds to cluster-based interlace p×4+2 in FIG. 3C, where the index of p×4+2 is globally numbered among total M×12/K cluster-based interlaces;
Cluster-based interlace 3 with reference to RB-based interlace p includes subcarriers 9, 10 and 11 of RBs p, p+10, p+20, . . . , and corresponds to cluster-based interlace p×4+3 in FIG. 3C, where the index of p×4+3 is globally numbered among total M×12/K cluster-based interlaces.

For example, as shown in FIG. 3D, when X=K=2, there are 6 cluster-based interlaces per RB-based interlace,
Cluster-based interlace 0 with reference to RB-based interlace p includes subcarriers 0 and 1 of RBs p, p+10, p+20, . . . , and corresponds to cluster-based interlace p×6 in FIG. 3D, where the index of p×6 is globally numbered among total M×12/K cluster-based interlaces;
Cluster-based interlace 1 with reference to RB-based interlace p includes subcarriers 2 and 3 of RBs p, p+10, p+20, . . . , and corresponds to cluster-based interlace p×6+1 in FIG. 3D, where the index of p×6+1 is globally numbered among total M×12/K cluster-based interlaces;
Cluster-based interlace 2 with reference to RB-based interlace p includes subcarriers 4 and 5 of RBs p, p+10, p+20, . . . , and corresponds to cluster-based interlace p×6+2 in FIG. 3D, where the index of p×6+2 is globally numbered among total M×12/K cluster-based interlaces;
Cluster-based interlace 3 with reference to RB-based interlace p includes subcarriers 6 and 7 of RBs p, p+10, p+20, . . . , and corresponds to cluster-based interlace p×6+3 in FIG. 3D, where the index of p×6+3 is globally numbered among total M×12/K cluster-based interlaces;
Cluster-based interlace 4 with reference to RB-based interlace p includes subcarriers 8 and 9 of RBs p, p+10, p+20, . . . , and corresponds to cluster-based interlace p×6+4 in FIG. 3D, where the index of p×6+4 is globally numbered among total M×12/K cluster-based interlaces; and
Cluster-based interlace 5 with reference to RB-based interlace p includes subcarriers 10 and 11 of RBs p, p+10, p+20, . . . , and corresponds to cluster-based interlace p×6+5 in FIG. 3D, where the index of p×6+5 is globally numbered among total M×12/K cluster-based interlaces.

For example, when X=K=1, there are 12 cluster-based interlaces per RB-based interlace,
Cluster-based interlace 0 with reference to RB-based interlace p includes subcarrier 0 of RBs p, p+10, p+20, . . . , and corresponds to the globally indexed cluster-based interlace p×12 among total M×12/K cluster-based interlaces;
Cluster-based interlace 1 with reference to RB-based interlace p includes subcarrier 1 of RBs p, p+10, p+20, . . . , and corresponds to the globally indexed cluster-based interlace p×12+1 among total M×12/K cluster-based interlaces;
Cluster-based interlace 2 with reference to RB-based interlace p includes subcarrier 2 of RBs p, p+10, p+20, . . . , and corresponds to the globally indexed cluster-based interlace p×12+2 among total M×12/K cluster-based interlaces;
Cluster-based interlace 3 with reference to RB-based interlace p includes subcarrier 3 of RBs p, p+10, p+20, . . . , and corresponds to the globally indexed cluster-based interlace p×12+3 among total M×12/K cluster-based interlaces;
Cluster-based interlace 4 with reference to RB-based interlace p includes subcarrier 4 of RBs p, p+10, p+20, . . . , and corresponds to the globally indexed cluster-based interlace p×12+4 among total M×12/K cluster-based interlaces;
Cluster-based interlace 5 with reference to RB-based interlace p includes subcarrier 5 of RBs p, p+10, p+20, . . . , and corresponds to the globally indexed cluster-based interlace p×12+5 among total M×12/K cluster-based interlaces;
Cluster-based interlace 6 with reference to RB-based interlace p includes subcarrier 6 of RBs p, p+10, p+20, . . . , and corresponds to the globally indexed cluster-based interlace p×12+6 among total M×12/K cluster-based interlaces;
Cluster-based interlace 7 with reference to RB-based interlace p includes subcarrier 7 of RBs p, p+10, p+20, . . . , and corresponds to the globally indexed cluster-based interlace p×12+7 among total M×12/K cluster-based interlaces;
Cluster-based interlace 8 with reference to RB-based interlace p includes subcarrier 8 of RBs p, p+10, p+20, . . . , and corresponds to the globally indexed cluster-based interlace p×12+8 among total M×12/K cluster-based interlaces;
Cluster-based interlace 9 with reference to RB-based interlace p includes subcarrier 9 of RBs p, p+10, p+20, . . . , and corresponds to the globally indexed cluster-based interlace p×12+9 among total M×12/K cluster-based interlaces;
Cluster-based interlace 10 with reference to RB-based interlace p includes subcarrier 10 of RBs p, p+10, p+20, . . . , and corresponds to the globally indexed cluster-based interlace p×12+10 among total M×12/K cluster-based interlaces; and
Cluster-based interlace 11 with reference to RB-based interlace p includes subcarrier 11 of RBs p, p+10, p+20, . . . , and corresponds to the globally indexed cluster-based interlace p×12+11 among total M×12/K cluster-based interlaces.

For the interleaved subcarrier-to-cluster mapping, cluster-based interlace pᵢ with reference to RB-based interlace p may include C clusters, wherein the first cluster may include subcarrier {i, i+1, . . . , i+K−1} of RB p, RB p+10, RB p+20, . . . ; the second cluster may include subcarrier

$$\{ i + \frac{12}{C} , i + \frac{12}{C} + 1 , … , i + \frac{12}{C} + K - 1 \}$$

of RB p, RB p+10, RB p+20, . . . ; and the C^{th} cluster may include subcarrier

$$\{ i + \frac{12}{C} \times ( C - 1 ) , i + \frac{12}{C} \times ( C - 1 ) + 1 , … , i + \frac{12}{C} \times ( C - 1 ) + K - 1 \}$$

of RB p, RB p+10, RB p+20, . . . . The M×12/X cluster-based interlaces may be indexed together (or globally) from 0 to M×12/X−1. Cluster-based interlace pᵢ with reference to RB-based interlace p may correspond to one of the M×12/X cluster-based interlaces with a (global) index of p×12/X+pᵢ.

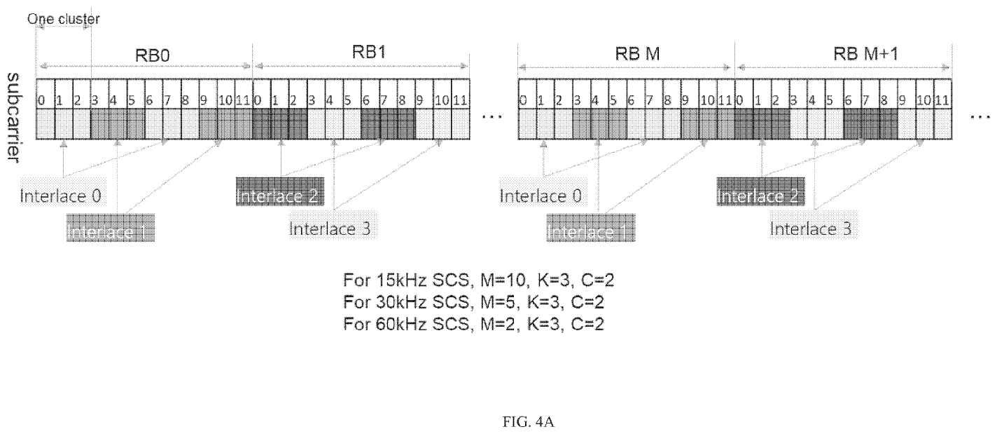

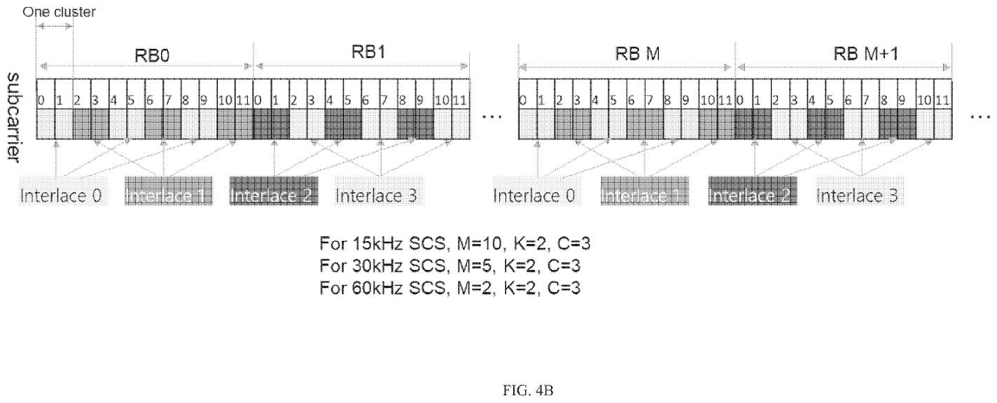

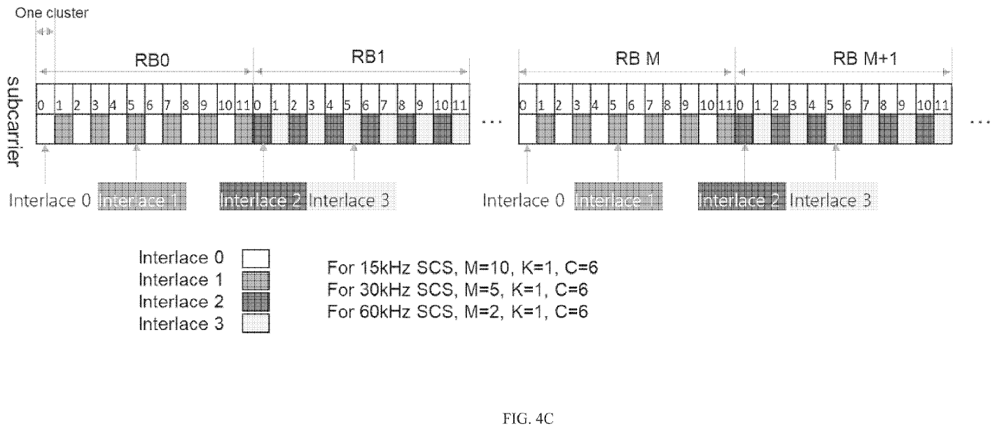

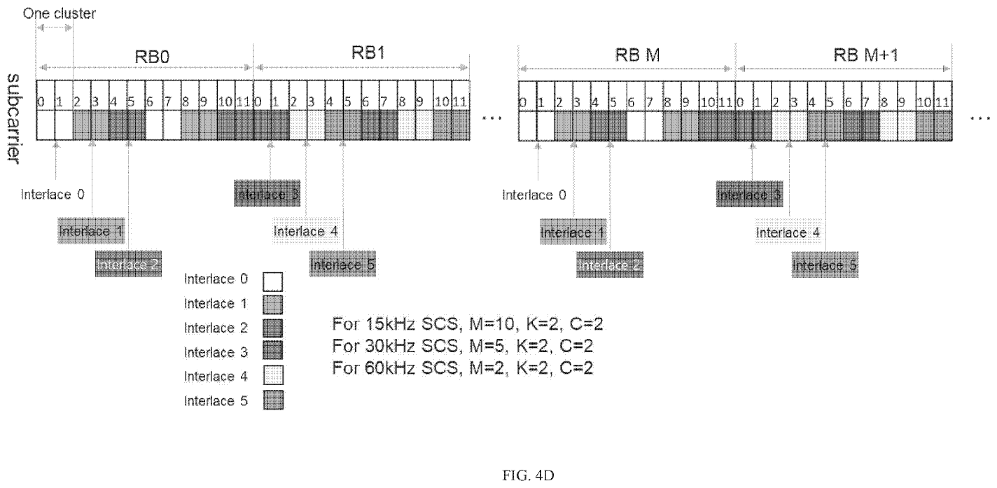

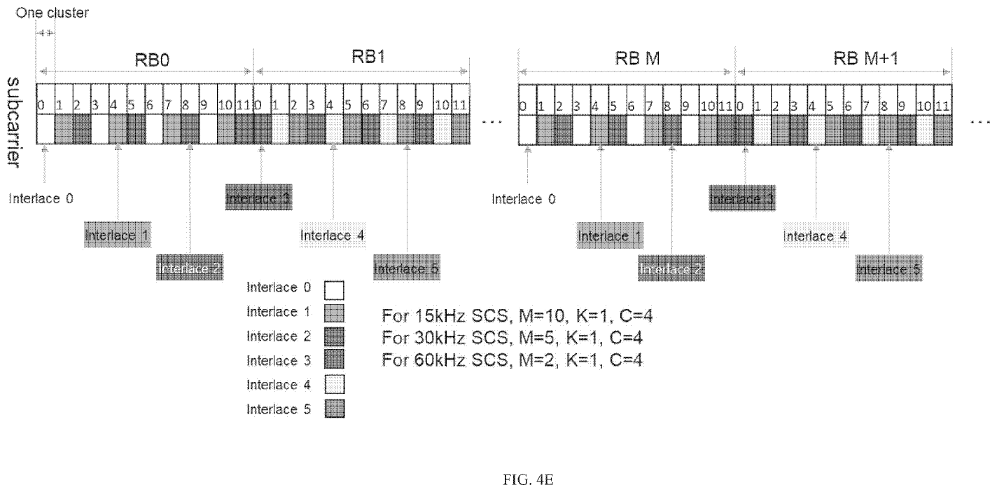

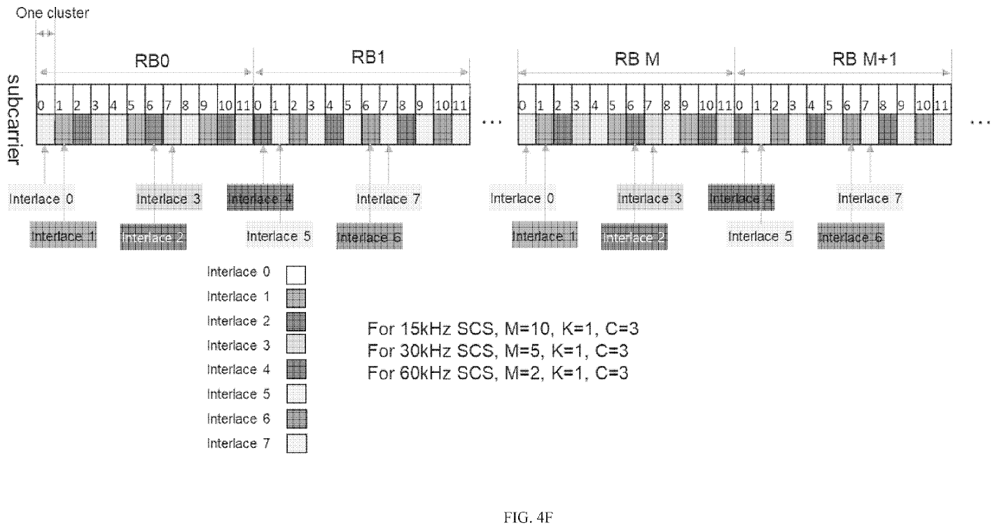

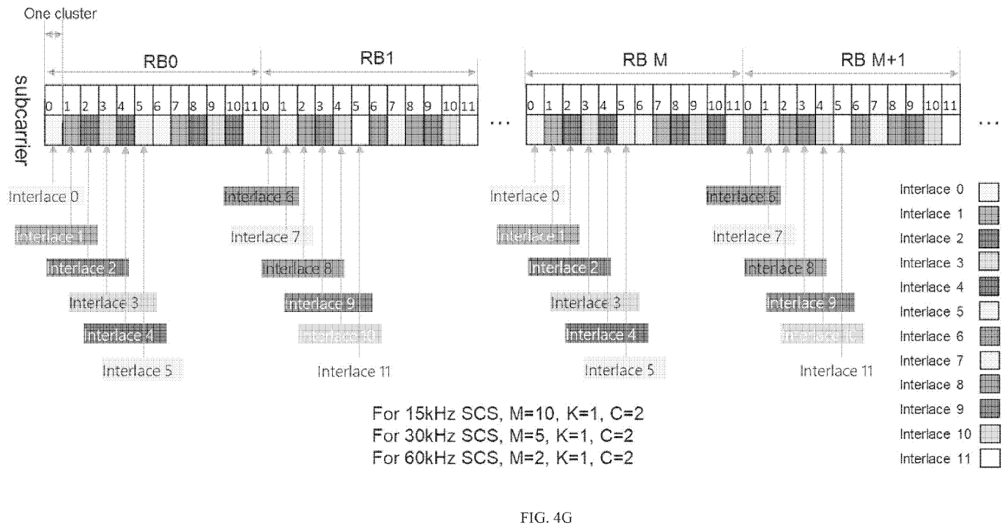

For example, as shown in FIG. 4A, when X=6, K=3, and C=2, there are 2 cluster-based interlaces per RB-based interlace. For each of the 2 cluster-based interlaces, there are 2 clusters per RB and each cluster comprises 3 contiguous subcarriers,
Cluster-based interlace 0 with reference to RB-based interlace p includes subcarriers 0, 1, 2, 6, 7 and 8 of RBs p, p+10, p+20, . . . , and corresponds to cluster-based interlace p×2 in FIG. 4A, where the index of p×2 is globally numbered among total M×12/X cluster-based interlaces; and
Cluster-based interlace 1 with reference to RB-based interlace p includes subcarriers 3, 4, 5, 9, 10 and 11 of RBs p, p+10, p+20, . . . , and corresponds to cluster-based interlace p×2+1 in FIG. 4A, where the index of p×2+1 is globally numbered among total M×12/X cluster-based interlaces.

For example, as shown in FIG. 4B, when X=6, K=2, and C=3, there are 2 cluster-based interlaces per RB-based interlace. For each of the 2 cluster-based interlaces, there are 3 clusters per RB and each cluster comprises 2 contiguous subcarriers,
Cluster-based interlace 0 with reference to RB-based interlace p includes subcarriers 0, 1, 4, 5, 8 and 9 of RBs p, p+10, p+20, . . . , and corresponds to cluster-based interlace p×2 in FIG. 4B, where the index of p×2 is globally numbered among total M×12/X cluster-based interlaces; and
Cluster-based interlace 1 with reference to RB-based interlace p includes subcarriers 2, 3, 6, 7, 10 and 11 of RBs p, p+10, p+20, . . . , and corresponds to cluster-based interlace p×2+1 in FIG. 4B, where the index of p×2+1 is globally numbered among total M×12/X cluster-based interlaces.

For example, as shown in FIG. 4C, when X=6, K=1, and C=6, there are 2 cluster-based interlaces per RB-based interlace. For each of the 2 cluster-based interlaces, there are 6 clusters per RB and each cluster comprises 1 subcarrier,
Cluster-based interlace 0 with reference to RB-based interlace p includes subcarriers 0, 2, 4, 6, 8 and 10 of RBs p, p+10, p+20, . . . , and corresponds to cluster-based interlace p×2 in FIG. 4C, where the index of p×2 is globally numbered among total M×12/X cluster-based interlaces; and
Cluster-based interlace 1 with reference to RB-based interlace p includes subcarriers 1, 3, 5, 7, 9 and 11 of RBs p, p+10, p+20, . . . , and corresponds to cluster-based interlace p×2+1 in FIG. 4C, where the index of p×2+1 is globally numbered among total M×12/X cluster-based interlaces.

For example, as shown in FIG. 4D, when X=4, K=2, and C=2, there are 3 cluster-based interlaces per RB-based interlace. For each of the 3 cluster-based interlaces, there are 2 clusters per RB and each cluster comprises 2 contiguous subcarriers,
Cluster-based interlace 0 with reference to RB-based interlace p includes subcarriers 0, 1, 6 and 7 of RBs p, p+10, p+20, . . . , and corresponds to cluster-based interlace p×3 in FIG. 4D, where the index of p×3 is globally numbered among total M×12/X cluster-based interlaces;
Cluster-based interlace 1 with reference to RB-based interlace p includes subcarriers 2, 3, 8 and 9 of RBs p, p+10, p+20, . . . , and corresponds to cluster-based interlace p×3+1 in FIG. 4D, where the index of p×3+1 is globally numbered among total M×12/X cluster-based interlaces; and
Cluster-based interlace 2 with reference to RB-based interlace p includes subcarriers 4, 5, 10 and 11 of RBs p, p+10, p+20, . . . , and corresponds to cluster-based interlace p×3+2 in FIG. 4D, where the index of p×3+2 is globally numbered among total M×12/X cluster-based interlaces.

For example, as shown in FIG. 4E, when X=4, K=1, and C=4, there are 3 cluster-based interlaces per RB-based interlace. For each of the 3 cluster-based interlaces, there are 4 clusters per RB and each cluster comprises 1 subcarrier,
Cluster-based interlace 0 with reference to RB-based interlace p includes subcarriers 0, 3, 6 and 9 of RBs p, p+10, p+20, . . . , and corresponds to cluster-based interlace p×3 in FIG. 4E, where the index of p×3 is globally numbered among total M×12/X cluster-based interlaces;
Cluster-based interlace 1 with reference to RB-based interlace p includes subcarriers 1, 4, 7 and 10 of RBs p, p+10, p+20, . . . , and corresponds to cluster-based interlace p×3+1 in FIG. 4E, where the index of p×3+1 is globally numbered among total M×12/X cluster-based interlaces; and
Cluster-based interlace 2 with reference to RB-based interlace p includes subcarriers 2, 5, 8 and 11 of RBs p, p+10, p+20, . . . , and corresponds to cluster-based interlace p×3+2 in FIG. 4E, where the index of p×3+2 is globally numbered among total M×12/X cluster-based interlaces.

For example, as shown in FIG. 4F, when X=3, K=1, and C=3, there are 4 cluster-based interlaces per RB-based interlace. For each of the 4 cluster-based interlaces, there are 4 clusters per RB and each cluster comprises 1 subcarrier,
Cluster-based interlace 0 with reference to RB-based interlace p includes subcarriers 0, 4 and 8 of RBs p, p+10, p+20, . . . , and corresponds to cluster-based interlace p×4 in FIG. 4F, where the index of p×4 is globally numbered among total M×12/X cluster-based interlaces;
Cluster-based interlace 1 with reference to RB-based interlace p includes subcarriers 1, 5 and 9 of RBs p, p+10, p+20, . . . , and corresponds to cluster-based interlace p×4+1 in FIG. 4F, where the index of p×4+1 is globally numbered among total M×12/X cluster-based interlaces;
Cluster-based interlace 2 with reference to RB-based interlace p includes subcarriers 2, 6 and 10 of RBs p, p+10, p+20, . . . , and corresponds to cluster-based interlace p×4+2 in FIG. 4F, where the index of p×4+2 is globally numbered among total M×12/X cluster-based interlaces; and
Cluster-based interlace 3 with reference to RB-based interlace p includes subcarriers 3, 7 and 11 of RBs p, p+10, p+20, . . . , and corresponds to cluster-based interlace p×4+3 in FIG. 4F, where the index of p×4+3 is globally numbered among total M×12/X cluster-based interlaces.

For example, as shown in FIG. 4G, when X=2, K=1, and C=2, there are 6 cluster-based interlaces per RB-based interlace. For each of the 6 cluster-based interlaces, there are 2 clusters per RB and each cluster comprises 1 subcarrier,
Cluster-based interlace 0 with reference to RB-based interlace p includes subcarriers 0 and 6 of RBs p, p+10, p+20, . . . , and corresponds to cluster-based interlace p×6 in FIG. 4G, where the index of p×6 is globally numbered among total M×12/X cluster-based interlaces; and
Cluster-based interlace 1 with reference to RB-based interlace p includes subcarriers 1 and 7 of RBs p, p+10, p+20, . . . , and corresponds to cluster-based interlace p×6+1 in FIG. 4G, where the index of p×6+1 is globally numbered among total M×12/X cluster-based interlaces;
Cluster-based interlace 2 with reference to RB-based interlace p includes subcarriers 2 and 8 of RBs p, p+10, p+20, . . . , and corresponds to cluster-based interlace p×6+2 in FIG. 4G, where the index of p×6+2 is globally numbered among total M×12/X cluster-based interlaces;
Cluster-based interlace 3 with reference to RB-based interlace p includes subcarriers 3 and 9 of RBs p, p+10, p+20, . . . , and corresponds to cluster-based interlace p×6+3 in FIG. 4G, where the index of p×6+3 is globally numbered among total M×12/X cluster-based interlaces;
Cluster-based interlace 4 with reference to RB-based interlace p includes subcarriers 4 and 10 of RBs p, p+10, p+20, . . . , and corresponds to cluster-based interlace p×6+4 in FIG. 4G, where the index of p×6+4 is globally numbered among total M×12/X cluster-based interlaces; and
Cluster-based interlace 5 with reference to RB-based interlace p includes subcarriers 5 and 11 of RBs p, p+10, p+20, . . . , and corresponds to cluster-based interlace p×6+5 in FIG. 4G, where the index of p×6+5 is globally numbered among total M×12/X cluster-based interlaces.

For example, when X=K=C=1, there are 12 cluster-based interlaces per RB-based interlace,
Cluster-based interlace 0 with reference to RB-based interlace p includes subcarrier 0 of RBs p, p+10, p+20, . . . , and corresponds to the globally indexed cluster-based interlace p×12 among total M×12/X cluster-based interlaces;
Cluster-based interlace 1 with reference to RB-based interlace p includes subcarrier 1 of RBs p, p+10, p+20, . . . , and corresponds to the globally indexed cluster-based interlace p×12+1 among total M×12/X cluster-based interlaces;
Cluster-based interlace 2 with reference to RB-based interlace p includes subcarrier 2 of RBs p, p+10, p+20, . . . , and corresponds to the globally indexed cluster-based interlace p×12+2 among total M×12/X cluster-based interlaces;
Cluster-based interlace 3 with reference to RB-based interlace p includes subcarrier 3 of RBs p, p+10, p+20, . . . , and corresponds to the globally indexed cluster-based interlace p×12+3 among total M×12/X cluster-based interlaces;
Cluster-based interlace 4 with reference to RB-based interlace p includes subcarrier 4 of RBs p, p+10, p+20, . . . , and corresponds to the globally indexed cluster-based interlace p×12+4 among total M×12/X cluster-based interlaces;
Cluster-based interlace 5 with reference to RB-based interlace p includes subcarrier 5 of RBs p, p+10, p+20, . . . , and corresponds to the globally indexed cluster-based interlace p×12+5 among total M×12/X cluster-based interlaces;
Cluster-based interlace 6 with reference to RB-based interlace p includes subcarrier 6 of RBs p, p+10, p+20, . . . , and corresponds to the globally indexed cluster-based interlace p×12+6 among total M×12/X cluster-based interlaces;
Cluster-based interlace 7 with reference to RB-based interlace p includes subcarrier 7 of RBs p, p+10, p+20, . . . , and corresponds to the globally indexed cluster-based interlace p×12+7 among total M×12/X cluster-based interlaces;
Cluster-based interlace 8 with reference to RB-based interlace p includes subcarrier 8 of RBs p, p+10, p+20, . . . , and corresponds to the globally indexed cluster-based interlace p×12+8 among total M×12/X cluster-based interlaces;
Cluster-based interlace 9 with reference to RB-based interlace p includes subcarrier 9 of RBs p, p+10, p+20, . . . , and corresponds to the globally indexed cluster-based interlace p×12+9 among total M×12/X cluster-based interlaces;
Cluster-based interlace 10 with reference to RB-based interlace p includes subcarrier 10 of RBs p, p+10, p+20, . . . , and corresponds to the globally indexed cluster-based interlace p×12+10 among total M×12/X cluster-based interlaces; and
Cluster-based interlace 11 with reference to RB-based interlace p includes subcarrier 11 of RBs p, p+10, p+20, . . . , and corresponds to the globally indexed cluster-based interlace p×12+11 among total M×12/X cluster-based interlaces.

For 30 KHz SCS, M=5, and taking RB-based interlace p as the reference, it is assumed that RB-based interlace p comprises RBs p, p+5, p+10, p+15, . . . , where p is the interlace index of the RB-based interlace and p∈{0, 1, 2, 3, 4} for 30 KHz SCS. For the cluster-based interlace structure, assuming X is the total number of subcarriers per RB, and X∈{1, 2, 3, 4, 6}, then RB-based interlace p comprises 12/X cluster-based interlaces. It is further assumed that pᵢ is the index of a cluster-based interlace with reference to RB-based interlace p, i∈

$$\{ 0 , 1 , … , \frac{12}{X} - 1 \} .$$

For the non-interleaved subcarrier-to-cluster mapping, cluster-based interlace pᵢ with reference to RB-based interlace p may include subcarrier i×X, i×X+1, . . . , i×X+X−1 of RBs p, p+5, p+10, p+15, . . . . The M×12/X cluster-based interlaces may be indexed together (or globally) from 0 to M×12/X−1. Cluster-based interlace pᵢ with reference to RB-based interlace p may correspond to one of the M×12/X cluster-based interlaces with a (global) index of p×12/X+pᵢ.

For example, as shown in FIG. 3A, when X=K=6, there are 2 cluster-based interlaces per RB-based interlace,
Cluster-based interlace 0 with reference to RB-based interlace p includes subcarriers 0, 1, 2, 3, 4 and 5 of RBs p, p+5, p+10, p+15, . . . , and corresponds to cluster-based interlace p×2 in FIG. 3A, where the index of p×2 is globally numbered among total M×12/X cluster-based interlaces; and
Cluster-based interlace 1 with reference to RB-based interlace p includes subcarriers 6, 7, 8, 9, 10 and 11 of RBs p, p+5, p+10, p+15, . . . , and corresponds to cluster-based interlace p×2+1 in FIG. 3A, where the index of p×2+1 is globally numbered among total M×12/X cluster-based interlaces.

For example, as shown in FIG. 3B, when X=K=4, there are 3 cluster-based interlaces per RB-based interlace,
Cluster-based interlace 0 with reference to RB-based interlace p includes subcarriers 0, 1, 2 and 3 of RBs p, p+5, p+10, p+15, . . . , and corresponds to cluster-based interlace p×3 in FIG. 3B, where the index of p×3 is globally numbered among total M×12/X cluster-based interlaces;
Cluster-based interlace 1 with reference to RB-based interlace p includes subcarriers 4, 5, 6 and 7 of RBs p, p+5, p+10, p+15, . . . , and corresponds to cluster-based interlace p×3+1 in FIG. 3B, where the index of p×3+1 is globally numbered among total M×12/X cluster-based interlaces; and
Cluster-based interlace 2 with reference to RB-based interlace p includes subcarriers 8, 9, 10 and 11 of RBs p, p+5, p+10, p+15, . . . , and corresponds to cluster-based interlace p×3+2 in FIG. 3B, where the index of p×3+2 is globally numbered among total M×12/X cluster-based interlaces.

For example, as shown in FIG. 3C, when X=K=3, there are 4 cluster-based interlaces per RB-based interlace,
Cluster-based interlace 0 with reference to RB-based interlace p includes subcarriers 0, 1 and 2 of RBs p, p+5, p+10, p+15, . . . , and corresponds to cluster-based interlace p×4 in FIG. 3C, where the index of p×4 is globally numbered among total M×12/X cluster-based interlaces;
Cluster-based interlace 1 with reference to RB-based interlace p includes subcarriers 3, 4 and 5 of RBs p, p+5, p+10, p+15, . . . , and corresponds to cluster-based interlace p×4+1 in FIG. 3C, where the index of p×4+1 is globally numbered among total M×12/X cluster-based interlaces;
Cluster-based interlace 2 with reference to RB-based interlace p includes subcarriers 6, 7 and 8 of RBs p, p+5, p+10, p+15, . . . , and corresponds to cluster-based interlace p×4+2 in FIG. 3C, where the index of p×4+2 is globally numbered among total M×12/X cluster-based interlaces; and
Cluster-based interlace 3 with reference to RB-based interlace p includes subcarriers 9, 10 and 11 of RBs p, p+5, p+10, p+15, . . . , and corresponds to cluster-based interlace p×4+3 in FIG. 3C, where the index of p×4+3 is globally numbered among total M×12/X cluster-based interlaces.

For example, as shown in FIG. 3D, when X=K=2, there are 6 cluster-based interlaces per RB-based interlace,
Cluster-based interlace 0 with reference to RB-based interlace p includes subcarriers 0 and 1 of RBs p, p+5, p+10, p+15, . . . , and corresponds to cluster-based interlace p×6 in FIG. 3D, where the index of p×6 is globally numbered among total M×12/X cluster-based interlaces;
Cluster-based interlace 1 with reference to RB-based interlace p includes subcarriers 2 and 3 of RBs p, p+5, p+10, p+15, . . . , and corresponds to cluster-based interlace p×6+1 in FIG. 3D, where the index of p×6+1 is globally numbered among total M×12/X cluster-based interlaces;
Cluster-based interlace 2 with reference to RB-based interlace p includes subcarriers 4 and 5 of RBs p, p+5, p+10, p+15, . . . , and corresponds to cluster-based interlace p×6+2 in FIG. 3D, where the index of p×6+2 is globally numbered among total M×12/X cluster-based interlaces;
Cluster-based interlace 3 with reference to RB-based interlace p includes subcarriers 6 and 7 of RBs p, p+5, p+10, p+15, . . . , and corresponds to cluster-based interlace p×6+3 in FIG. 3D, where the index of p×6+3 is globally numbered among total M×12/X cluster-based interlaces;
Cluster-based interlace 4 with reference to RB-based interlace p includes subcarriers 8 and 9 of RBs p, p+5, p+10, p+15, . . . , and corresponds to cluster-based interlace p×6+4 in FIG. 3D, where the index of p×6+4 is globally numbered among total M×12/X cluster-based interlaces; and
Cluster-based interlace 5 with reference to RB-based interlace p includes subcarriers 10 and 11 of RBs p, p+5, p+10, p+15, . . . , and corresponds to cluster-based interlace p×6+5 in FIG. 3D, where the index of p×6+5 is globally numbered among total M×12/X cluster-based interlaces.

For example, when X=K=1, there are 12 cluster-based interlaces per RB-based interlace,
Cluster-based interlace 0 with reference to RB-based interlace p includes subcarrier 0 of RBs p, p+5, p+10, p+15, . . . , and corresponds to the globally indexed cluster-based interlace p×12 among total M×12/X cluster-based interlaces;
Cluster-based interlace 1 with reference to RB-based interlace p includes subcarrier 1 of RBs p, p+5, p+10, p+15, . . . , and corresponds to the globally indexed cluster-based interlace p×12+1 among total M×12/X cluster-based interlaces;
Cluster-based interlace 2 with reference to RB-based interlace p includes subcarrier 2 of RBs p, p+5, p+10, p+15, . . . , and corresponds to the globally indexed cluster-based interlace p×12+2 among total M×12/X cluster-based interlaces;
Cluster-based interlace 3 with reference to RB-based interlace p includes subcarrier 3 of RBs p, p+5, p+10, p+15, . . . , and corresponds to the globally indexed cluster-based interlace p×12+3 among total M×12/X cluster-based interlaces;
Cluster-based interlace 4 with reference to RB-based interlace p includes subcarrier 4 of RBs p, p+5, p+10, p+15, . . . , and corresponds to the globally indexed cluster-based interlace p×12+4 among total M×12/X cluster-based interlaces;
Cluster-based interlace 5 with reference to RB-based interlace p includes subcarrier 5 of RBs p, p+5, p+10, p+15, . . . , and corresponds to the globally indexed cluster-based interlace p×12+5 among total M×12/X cluster-based interlaces;
Cluster-based interlace 6 with reference to RB-based interlace p includes subcarrier 6 of RBs p, p+5, p+10, p+15, . . . , and corresponds to the globally indexed cluster-based interlace p×12+6 among total M×12/X cluster-based interlaces;
Cluster-based interlace 7 with reference to RB-based interlace p includes subcarrier 7 of RBs p, p+5, p+10, p+15, . . . , and corresponds to the globally indexed cluster-based interlace p×12+7 among total M×12/X cluster-based interlaces;
Cluster-based interlace 8 with reference to RB-based interlace p includes subcarrier 8 of RBs p, p+5, p+10, p+15, . . . , and corresponds to the globally indexed cluster-based interlace p×12+8 among total M×12/X cluster-based interlaces;
Cluster-based interlace 9 with reference to RB-based interlace p includes subcarrier 9 of RBs p, p+5, p+10, p+15, . . . , and corresponds to the globally indexed cluster-based interlace p×12+9 among total M×12/X cluster-based interlaces;
Cluster-based interlace 10 with reference to RB-based interlace p includes subcarrier 10 of RBs p, p+5, p+10, p+15, . . . , and corresponds to the globally indexed cluster-based interlace p×12+10 among total M×12/X cluster-based interlaces; and
Cluster-based interlace 11 with reference to RB-based interlace p includes subcarrier 11 of RBs p, p+5, p+10, p+15, . . . , and corresponds to the globally indexed cluster-based interlace p×12+11 among total M×12/X cluster-based interlaces.

For the interleaved subcarrier-to-cluster mapping, cluster-based interlace pᵢ with reference to RB-based interlace p may include C clusters, wherein the first cluster may include subcarrier {i, i+1, . . . , i+K−1} of RB p, RB p+5, RB p+10, RB p+15, . . . ; the second cluster may include subcarrier

$$\{ i + \frac{12}{C} , i + \frac{12}{C} + 1 , … , i + \frac{12}{C} + K - 1 \}$$

of RB p, RB p+5, RB p+10, RB p+15, . . . ; . . . ; and the C^{th} cluster may include subcarrier

$$\{ i + \frac{12}{C} \times ( C - 1 ) , i + \frac{12}{C} \times ( C - 1 ) + 1 , … , i + \frac{12}{C} \times ( C - 1 ) + K - 1 \}$$

of RB p, RB p+5, RB p+10, RB p+15, . . . . The M×12/X cluster-based interlaces may be indexed together (or globally) from 0 to M×12/X−1. Cluster-based interlace pᵢ with reference to RB-based interlace p may correspond to one of the M×12/X cluster-based interlaces with a (global) index of p×12/X+pᵢ.

For example, as shown in FIG. 4A, when X=6, K=3, and C=2, there are 2 cluster-based interlaces per RB-based interlace. For each of the 2 cluster-based interlaces, there are 2 clusters per RB and each cluster comprises 3 contiguous subcarriers,
Cluster-based interlace 0 with reference to RB-based interlace p includes subcarriers 0, 1, 2, 6, 7 and 8 of RBs p, p+5, p+10, p+15, . . . , and corresponds to cluster-based interlace p×2 in FIG. 4A, where the index of p×2 is globally numbered among total M×12/X cluster-based interlaces; and
Cluster-based interlace 1 with reference to RB-based interlace p includes subcarriers 3, 4, 5, 9, 10 and 11 of RBs p, p+5, p+10, p+15, . . . , and corresponds to cluster-based interlace p×2+1 in FIG. 4A, where the index of p×2+1 is globally numbered among total M×12/X cluster-based interlaces.

For example, as shown in FIG. 4B, when X=6, K=2, and C=3, there are 2 cluster-based interlaces per RB-based interlace. For each of the 2 cluster-based interlaces, there are 3 clusters per RB and each cluster comprises 2 contiguous subcarriers,
Cluster-based interlace 0 with reference to RB-based interlace p includes subcarriers 0, 1, 4, 5, 8 and 9 of RBs p, p+5, p+10, p+15, . . . , and corresponds to cluster-based interlace p×2 in FIG. 4B, where the index of p×2 is globally numbered among total M×12/X cluster-based interlaces; and
Cluster-based interlace 1 with reference to RB-based interlace p includes subcarriers 2, 3, 6, 7, 10 and 11 of RBs p, p+5, p+10, p+15, . . . , and corresponds to cluster-based interlace p×2+1 in FIG. 4B, where the index of p×2+1 is globally numbered among total M×12/X cluster-based interlaces.

For example, as shown in FIG. 4C, when X=6, K=1, and C=6, there are 2 cluster-based interlaces per RB-based interlace. For each of the 2 cluster-based interlaces, there are 6 clusters per RB and each cluster comprises 1 subcarrier,
Cluster-based interlace 0 with reference to RB-based interlace p includes subcarriers 0, 2, 4, 6, 8 and 10 of RBs p, p+5, p+10, p+15, . . . , and corresponds to cluster-based interlace p×2 in FIG. 4C, where the index of p×2 is globally numbered among total M×12/X cluster-based interlaces; and
Cluster-based interlace 1 with reference to RB-based interlace p includes subcarriers 1, 3, 5, 7, 9 and 11 of RBs p, p+5, p+10, p+15, . . . , and corresponds to cluster-based interlace p×2+1 in FIG. 4C, where the index of p×2+1 is globally numbered among total M×12/X cluster-based interlaces.

For example, as shown in FIG. 4D, when X=4, K=2, and C=2, there are 3 cluster-based interlaces per RB-based interlace. For each of the 3 cluster-based interlaces, there are 2 clusters per RB and each cluster comprises 2 contiguous subcarriers,
Cluster-based interlace 0 with reference to RB-based interlace p includes subcarriers 0, 1, 6 and 7 of RBs p, p+5, p+10, p+15, . . . , and corresponds to cluster-based interlace p×3 in FIG. 4D, where the index of p×3 is globally numbered among total M×12/X cluster-based interlaces;
Cluster-based interlace 1 with reference to RB-based interlace p includes subcarriers 2, 3, 8 and 9 of RBs p, p+5, p+10, p+15, . . . , and corresponds to cluster-based interlace p×3+1 in FIG. 4D, where the index of p×3+1 is globally numbered among total M×12/X cluster-based interlaces; and
Cluster-based interlace 2 with reference to RB-based interlace p includes subcarriers 4, 5, 10 and 11 of RBs p, p+5, p+10, p+15, . . . , and corresponds cluster-based to interlace p×3+2 in FIG. 4D, where the index of p×3+2 is globally numbered among total M×12/X cluster-based interlaces.

For example, as shown in FIG. 4E, when X=4, K=1, and C=4, there are 3 cluster-based interlaces per RB-based interlace. For each of the 3 cluster-based interlaces, there are 4 clusters per RB and each cluster comprises 1 subcarrier,
Cluster-based interlace 0 with reference to RB-based interlace p includes subcarriers 0, 3, 6 and 9 of RBs p, p+5, p+10, p+15, . . . , and corresponds to cluster-based interlace p×3 in FIG. 4E, where the index of p×3 is globally numbered among total M×12/X cluster-based interlaces;
Cluster-based interlace 1 with reference to RB-based interlace p includes subcarriers 1, 4, 7 and 10 of RBs p, p+5, p+10, p+15, . . . , and corresponds to cluster-based interlace p×3+1 in FIG. 4E, where the index of p×3+1 is globally numbered among total M×12/X cluster-based interlaces; and
Cluster-based interlace 2 with reference to RB-based interlace p includes subcarriers 2, 5, 8 and 11 of RBs p, p+5, p+10, p+15, . . . , and corresponds to cluster-based interlace p×3+2 in FIG. 4E, where the index of p×3+2 is globally numbered among total M×12/X cluster-based interlaces.

For example, as shown in FIG. 4F, when X=3, K=1, and C=3, there are 4 cluster-based interlaces per RB-based interlace. For each of the 4 cluster-based interlaces, there are 4 clusters per RB and each cluster comprises 1 subcarrier,
Cluster-based interlace 0 with reference to RB-based interlace p includes subcarriers 0, 4 and 8 of RBs p, p+5, p+10, p+15, . . . , and corresponds to cluster-based interlace p×4 in FIG. 4F, where the index of p×4 is globally numbered among total M×12/X cluster-based interlaces;
Cluster-based interlace 1 with reference to RB-based interlace p includes subcarriers 1, 5 and 9 of RBs p, p+5, p+10, p+15, . . . , and corresponds to cluster-based interlace p×4+1 in FIG. 4F, where the index of p×4+1 is globally numbered among total M×12/X cluster-based interlaces;
Cluster-based interlace 2 with reference to RB-based interlace p includes subcarriers 2, 6 and 10 of RBs p, p+5, p+10, p+15, . . . , and corresponds to cluster-based interlace p×4+2 in FIG. 4F, where the index of p×4+2 is globally numbered among total M×12/X cluster-based interlaces; and
Cluster-based interlace 3 with reference to RB-based interlace p includes subcarriers 3, 7 and 11 of RBs p, p+5, p+10, p+15, . . . , and corresponds to cluster-based interlace p×4+3 in FIG. 4F, where the index of p×4+3 is globally numbered among total M×12/X cluster-based interlaces.

For example, as shown in FIG. 4G, when X=2, K=1, and C=2, there are 6 cluster-based interlaces per RB-based interlace. For each of the 6 cluster-based interlaces, there are 2 clusters per RB and each cluster comprises 1 subcarrier,
Cluster-based interlace 0 with reference to RB-based interlace p includes subcarriers 0 and 6 of RBs p, p+5, p+10, p+15, . . . , and corresponds to cluster-based interlace p×6 in FIG. 4G, where the index of p×6 is globally numbered among total M×12/X cluster-based interlaces; and
Cluster-based interlace 1 with reference to RB-based interlace p includes subcarriers 1 and 7 of RBs p, p+5, p+10, p+15, . . . , and corresponds to cluster-based interlace p×6+1 in FIG. 4G, where the index of p×6+1 is globally numbered among total M×12/X cluster-based interlaces;
Cluster-based interlace 2 with reference to RB-based interlace p includes subcarriers 2 and 8 of RBs p, p+5, p+10, p+15, . . . , and corresponds to cluster-based interlace p×6+2 in FIG. 4G, where the index of p×6+2 is globally numbered among total M×12/X cluster-based interlaces;
Cluster-based interlace 3 with reference to RB-based interlace p includes subcarriers 3 and 9 of RBs p, p+5, p+10, p+15, . . . , and corresponds to cluster-based interlace p×6+3 in FIG. 4G, where the index of p×6+3 is globally numbered among total M×12/X cluster-based interlaces;
Cluster-based interlace 4 with reference to RB-based interlace p includes subcarriers 4 and 10 of RBs p, p+5, p+10, p+15, . . . , and corresponds to cluster-based interlace p×6+4 in FIG. 4G, where the index of p×6+4 is globally numbered among total M×12/X cluster-based interlaces; and
Cluster-based interlace 5 with reference to RB-based interlace p includes subcarriers 5 and 11 of RBs p, p+5, p+10, p+15, . . . , and corresponds to cluster-based interlace p×6+5 in FIG. 4G, where the index of p×6+5 is globally numbered among total M×12/X cluster-based interlaces.

For example, when X=K=C=1, there are 12 cluster-based interlaces per RB-based interlace,
Cluster-based interlace 0 with reference to RB-based interlace p includes subcarrier 0 of RBs p, p+5, p+10, p+15, . . . , and corresponds to the globally indexed cluster-based interlace p×12 among total M×12/X cluster-based interlaces;
Cluster-based interlace 1 with reference to RB-based interlace p includes subcarrier 1 of RBs p, p+5, p+10, p+15, . . . , and corresponds to the globally indexed cluster-based interlace p×12+1 among total M×12/X cluster-based interlaces;
Cluster-based interlace 2 with reference to RB-based interlace p includes subcarrier 2 of RBs p, p+5, p+10, p+15, . . . , and corresponds to the globally indexed cluster-based interlace p×12+2 among total M×12/X cluster-based interlaces;
Cluster-based interlace 3 with reference to RB-based interlace p includes subcarrier 3 of RBs p, p+5, p+10, p+15, . . . , and corresponds to the globally indexed cluster-based interlace p×12+3 among total M×12/X cluster-based interlaces;
Cluster-based interlace 4 with reference to RB-based interlace p includes subcarrier 4 of RBs p, p+5, p+10, p+15, . . . , and corresponds to the globally indexed cluster-based interlace p×12+4 among total M×12/X cluster-based interlaces;
Cluster-based interlace 5 with reference to RB-based interlace p includes subcarrier 5 of RBs p, p+5, p+10, p+15, . . . , and corresponds to the globally indexed cluster-based interlace p×12+5 among total M×12/X cluster-based interlaces;
Cluster-based interlace 6 with reference to RB-based interlace p includes subcarrier 6 of RBs p, p+5, p+10, p+15, . . . , and corresponds to the globally indexed cluster-based interlace p×12+6 among total M×12/X cluster-based interlaces;
Cluster-based interlace 7 with reference to RB-based interlace p includes subcarrier 7 of RBs p, p+5, p+10, p+15, . . . , and corresponds to the globally indexed cluster-based interlace p×12+7 among total M×12/X cluster-based interlaces;
Cluster-based interlace 8 with reference to RB-based interlace p includes subcarrier 8 of RBs p, p+5, p+10, p+15, . . . , and corresponds to the globally indexed cluster-based interlace p×12+8 among total M×12/X cluster-based interlaces;
Cluster-based interlace 9 with reference to RB-based interlace p includes subcarrier 9 of RBs p, p+5, p+10, p+15, . . . , and corresponds to the globally indexed cluster-based interlace p×12+9 among total M×12/X cluster-based interlaces;
Cluster-based interlace 10 with reference to RB-based interlace p includes subcarrier 10 of RBs p, p+5, p+10, p+15, . . . , and corresponds to the globally indexed cluster-based interlace p×12+10 among total M×12/X cluster-based interlaces; and
Cluster-based interlace 11 with reference to RB-based interlace p includes subcarrier 11 of RBs p, p+5, p+10, p+15, . . . , and corresponds to the globally indexed cluster-based interlace p×12+11 among total M×12/X cluster-based interlaces.

For 60 kHz SCS, to meet OCB requirements, the supported number of RB-based interlace may be 2 (e.g., M=2). Taking RB-based interlace p as the reference, it is assumed that RB-based interlace p includes RBs p, p+2, p+4, p+6, . . . , where p is the interlace index of the RB-based interlace and p∈{0, 1} for 60 kHz SCS. For the cluster-based interlace structure, assuming X is the total number of subcarriers per RB, and X∈{1, 2, 3, 4, 6}, then RB-based interlace p comprises 12/X cluster-based interlaces. It is further assumed that pᵢ is the index of a cluster-based interlace with reference to RB-based interlace p, i∈

$$\{ 0 , 1 , … , \frac{12}{X} - 1 \} .$$

For the non-interleaved subcarrier-to-cluster mapping, cluster-based interlace pᵢ with reference to RB-based interlace p may include subcarrier i×X, i×X+1, . . . , i×X+X−1 of RBs p, p+2, p+4, p+6, . . . . The M×12/X cluster-based interlaces may be indexed together (or globally) from 0 to M×12/X−1. Cluster-based interlace pᵢ with reference to RB-based interlace p may correspond to one of the M×12/X cluster-based interlaces with a (global) index of p×12/X+p.

For example, as shown in FIG. 3A, when X=K=6, there are 2 cluster-based interlaces per RB-based interlace,
Cluster-based interlace 0 with reference to RB-based interlace p includes subcarriers 0, 1, 2, 3, 4 and 5 of RBs p, p+2, p+4, p+6, . . . , and corresponds to cluster-based interlace p×2 in FIG. 3A, where the index of p×2 is globally numbered among total M×12/X cluster-based interlaces; and
Cluster-based interlace 1 with reference to RB-based interlace p includes subcarriers 6, 7, 8, 9, 10 and 11 of RBs p, p+2, p+4, p+6, . . . , and corresponds to cluster-based interlace p×2+1 in FIG. 3A, where the index of p×2+1 is globally numbered among total M×12/X cluster-based interlaces.

For example, as shown in FIG. 3B, when X=K=4, there are 3 cluster-based interlaces per RB-based interlace,
Cluster-based interlace 0 with reference to RB-based interlace p includes subcarriers 0, 1, 2 and 3 of RBs p, p+2, p+4, p+6, . . . , and corresponds to cluster-based interlace p×3 in FIG. 3B, where the index of p×3 is globally numbered among total M×12/X cluster-based interlaces;
Cluster-based interlace 1 with reference to RB-based interlace p includes subcarriers 4, 5, 6 and 7 of RBs p, p+2, p+4, p+6, . . . , and corresponds to cluster-based interlace p×3+1 in FIG. 3B, where the index of p×3+1 is globally numbered among total M×12/X cluster-based interlaces; and
Cluster-based interlace 2 with reference to RB-based interlace p includes subcarriers 8, 9, 10 and 11 of RBs p, p+2, p+4, p+6, . . . , and corresponds to cluster-based interlace p×3+2 in FIG. 3B, where the index of p×3+2 is globally numbered among total M×12/X cluster-based interlaces.

For example, as shown in FIG. 3C, when X=K=3, there are 4 cluster-based interlaces per RB-based interlace,
Cluster-based interlace 0 with reference to RB-based interlace p includes subcarriers 0, 1 and 2 of RBs p, p+2, p+4, p+6, . . . , and corresponds to cluster-based interlace p×4 in FIG. 3C, where the index of p×4 is globally numbered among total M×12/X cluster-based interlaces;
Cluster-based interlace 1 with reference to RB-based interlace p includes subcarriers 3, 4 and 5 of RBs p, p+2, p+4, p+6, . . . , and corresponds to cluster-based interlace p×4+1 in FIG. 3C, where the index of p×4+1 is globally numbered among total M×12/X cluster-based interlaces;
Cluster-based interlace 2 with reference to RB-based interlace p includes subcarriers 6, 7 and 8 of RBs p, p+2, p+4, p+6, . . . , and corresponds to cluster-based interlace p×4+2 in FIG. 3C, where the index of p×4+2 is globally numbered among total M×12/X cluster-based interlaces; and
Cluster-based interlace 3 with reference to RB-based interlace p includes subcarriers 9, 10 and 11 of RBs p, p+2, p+4, p+6, . . . , and corresponds to cluster-based interlace p×4+3 in FIG. 3C, where the index of p×4+3 is globally numbered among total M×12/X cluster-based interlaces.

For example, as shown in FIG. 3D, when X=K=2, there are 6 cluster-based interlaces per RB-based interlace,
Cluster-based interlace 0 with reference to RB-based interlace p includes subcarriers 0 and 1 of RBs p, p+2, p+4, p+6, . . . , and corresponds to cluster-based interlace p×6 in FIG. 3D, where the index of p×6 is globally numbered among total M×12/X cluster-based interlaces;
Cluster-based interlace 1 with reference to RB-based interlace p includes subcarriers 2 and 3 of RBs p, p+2, p+4, p+6, . . . , and corresponds to cluster-based interlace p×6+1 in FIG. 3D, where the index of p×6+1 is globally numbered among total M×12/X cluster-based interlaces;
Cluster-based interlace 2 with reference to RB-based interlace p includes subcarriers 4 and 5 of RBs p, p+2, p+4, p+6, . . . , and corresponds to cluster-based interlace p×6+2 in FIG. 3D, where the index of p×6+2 is globally numbered among total M×12/X cluster-based interlaces;
Cluster-based interlace 3 with reference to RB-based interlace p includes subcarriers 6 and 7 of RBs p, p+2, p+4, p+6, . . . , and corresponds to cluster-based interlace p×6+3 in FIG. 3D, where the index of p×6+3 is globally numbered among total M×12/X cluster-based interlaces;
Cluster-based interlace 4 with reference to RB-based interlace p includes subcarriers 8 and 9 of RBs p, p+2, p+4, p+6, . . . , and corresponds to cluster-based interlace p×6+4 in FIG. 3D, where the index of p×6+4 is globally numbered among total M×12/X cluster-based interlaces; and
Cluster-based interlace 5 with reference to RB-based interlace p includes subcarriers 10 and 11 of RBs p, p+2, p+4, p+6, . . . , and corresponds to cluster-based interlace p×6+5 in FIG. 3D, where the index of p×6+5 is globally numbered among total M×12/X cluster-based interlaces.

For example, when X=K=1, there are 12 cluster-based interlaces per RB-based interlace,
Cluster-based interlace 0 with reference to RB-based interlace p includes subcarrier 0 of RBs p, p+2, p+4, p+6, . . . , and corresponds to the globally indexed cluster-based interlace p×12 among total M×12/X cluster-based interlaces;
Cluster-based interlace 1 with reference to RB-based interlace p includes subcarrier 1 of RBs p, p+2, p+4, p+6, . . . , and corresponds to the globally indexed cluster-based interlace p×12+1 among total M×12/X cluster-based interlaces;
Cluster-based interlace 2 with reference to RB-based interlace p includes subcarrier 2 of RBs p, p+2, p+4, p+6, . . . , and corresponds to the globally indexed cluster-based interlace p×12+2 among total M×12/X cluster-based interlaces;
Cluster-based interlace 3 with reference to RB-based interlace p includes subcarrier 3 of RBs p, p+2, p+4, p+6, . . . , and corresponds to the globally indexed cluster-based interlace p×12+3 among total M×12/X cluster-based interlaces;
Cluster-based interlace 4 with reference to RB-based interlace p includes subcarrier 4 of RBs p, p+2, p+4, p+6, . . . , and corresponds to the globally indexed cluster-based interlace p×12+4 among total M×12/X cluster-based interlaces;
Cluster-based interlace 5 with reference to RB-based interlace p includes subcarrier 5 of RBs p, p+2, p+4, p+6, . . . , and corresponds to the globally indexed cluster-based interlace p×12+5 among total M×12/X cluster-based interlaces;
Cluster-based interlace 6 with reference to RB-based interlace p includes subcarrier 6 of RBs p, p+2, p+4, p+6, . . . , and corresponds to the globally indexed cluster-based interlace p×12+6 among total M×12/X cluster-based interlaces;
Cluster-based interlace 7 with reference to RB-based interlace p includes subcarrier 7 of RBs p, p+2, p+4, p+6, . . . , and corresponds to the globally indexed cluster-based interlace p×12+7 among total M×12/X cluster-based interlaces;
Cluster-based interlace 8 with reference to RB-based interlace p includes subcarrier 8 of RBs p, p+2, p+4, p+6, . . . , and corresponds to the globally indexed cluster-based interlace p×12+8 among total M×12/X cluster-based interlaces;
Cluster-based interlace 9 with reference to RB-based interlace p includes subcarrier 9 of RBs p, p+2, p+4, p+6, . . . , and corresponds to the globally indexed cluster-based interlace p×12+9 among total M×12/X cluster-based interlaces;
Cluster-based interlace 10 with reference to RB-based interlace p includes subcarrier 10 of RBs p, p+2, p+4, p+6, . . . , and corresponds to the globally indexed cluster-based interlace p×12+10 among total M×12/X cluster-based interlaces; and
Cluster-based interlace 11 with reference to RB-based interlace p includes subcarrier 11 of RBs p, p+2, p+4, p+6, . . . , and corresponds to the globally indexed cluster-based interlace p×12+11 among total M×12/X cluster-based interlaces.

For the interleaved subcarrier-to-cluster mapping, cluster-based interlace pᵢ with reference to RB-based interlace p may include C clusters, wherein the first cluster may include subcarrier {i, i+1, . . . , i+K−1} of RBs p, p+2, p+4, p+6, . . . ; the second cluster may include subcarrier

$$\{ i + \frac{12}{C} , i + \frac{12}{C} + 1 , … , i + \frac{12}{C} + K - 1 \}$$

of RBs p, p+2, p+4, p+6, . . . ; . . . ; and the C^{th} cluster may include subcarrier

$$\{ i + \frac{12}{C} \times ( C - 1 ) , i + \frac{12}{C} \times ( C - 1 ) + 1 , … , i + \frac{12}{C} \times ( C - 1 ) + K - 1 \}$$

of RBs p, p+2, p+4, p+6, . . . . The M×12/X cluster-based interlaces may be indexed together (or globally) from 0 to M×12/X−1. Cluster-based interlace pᵢ with reference to RB-based interlace p may correspond to one of the M×12/X cluster-based interlaces with a (global) index of p×12/X+pᵢ.

For example, as shown in FIG. 4A, when X=6, K=3, and C=2, there are 2 cluster-based interlaces per RB-based interlace. For each of the 2 cluster-based interlaces, there are 2 clusters per RB and each cluster comprises 3 contiguous subcarriers,
Cluster-based interlace 0 with reference to RB-based interlace p includes subcarriers 0, 1, 2, 6, 7 and 8 of RBs p, p+2, p+4, p+6, . . . , and corresponds to cluster-based interlace p×2 in FIG. 4A, where the index of p×2 is globally numbered among total M×12/X cluster-based interlaces; and
Cluster-based interlace 1 with reference to RB-based interlace p includes subcarriers 3, 4, 5, 9, 10 and 11 of RBs p, p+2, p+4, p+6, . . . , and corresponds to cluster-based interlace p×2+1 in FIG. 4A, where the index of p×2+1 is globally numbered among total M×12/X cluster-based interlaces.

For example, as shown in FIG. 4B, when X=6, K=2, and C=3, there are 2 cluster-based interlaces per RB-based interlace. For each of the 2 cluster-based interlaces, there are 3 clusters per RB and each cluster comprises 2 contiguous subcarriers,
Cluster-based interlace 0 with reference to RB-based interlace p includes subcarriers 0, 1, 4, 5, 8 and 9 of RBs p, p+2, p+4, p+6, . . . , and corresponds to cluster-based interlace p×2 in FIG. 4B, where the index of p×2 is globally numbered among total M×12/X cluster-based interlaces; and
Cluster-based interlace 1 with reference to RB-based interlace p includes subcarriers 2, 3, 6, 7, 10 and 11 of RBs p, p+2, p+4, p+6, . . . , and corresponds to cluster-based interlace p×2+1 in FIG. 4B, where the index of p×2+1 is globally numbered among total M×12/X cluster-based interlaces.

For example, as shown in FIG. 4C, when X=6, K=1, and C=6, there are 2 cluster-based interlaces per RB-based interlace. For each of the 2 cluster-based interlaces, there are 6 clusters per RB and each cluster comprises 1 subcarrier,
Cluster-based interlace 0 with reference to RB-based interlace p includes subcarriers 0, 2, 4, 6, 8 and 10 of RBs p, p+2, p+4, p+6, . . . , and corresponds to cluster-based interlace p×2 in FIG. 4C, where the index of p×2 is globally numbered among total M×12/X cluster-based interlaces; and
Cluster-based interlace 1 with reference to RB-based interlace p includes subcarriers 1, 3, 5, 7, 9 and 11 of RBs p, p+2, p+4, p+6, . . . , and corresponds to cluster-based interlace p×2+1 in FIG. 4C, where the index of p×2+1 is globally numbered among total M×12/X cluster-based interlaces.

For example, as shown in FIG. 4D, when X=4, K=2, and C=2, there are 3 cluster-based interlaces per RB-based interlace. For each of the 3 cluster-based interlaces, there are 2 clusters per RB and each cluster comprises 2 contiguous subcarriers,
Cluster-based interlace 0 with reference to RB-based interlace p includes subcarriers 0, 1, 6 and 7 of RBs p, p+2, p+4, p+6, . . . , and corresponds to cluster-based interlace p×3 in FIG. 4D, where the index of p×3 is globally numbered among total M×12/X cluster-based interlaces;
Cluster-based interlace 1 with reference to RB-based interlace p includes subcarriers 2, 3, 8 and 9 of RBs p, p+2, p+4, p+6, . . . , and corresponds to cluster-based interlace p×3+1 in FIG. 4D, where the index of p×3+1 is globally numbered among total M×12/X cluster-based interlaces; and
Cluster-based interlace 2 with reference to RB-based interlace p includes subcarriers 4, 5, 10 and 11 of RBs p, p+2, p+4, p+6, . . . , and corresponds to cluster-based interlace p×3+2 in FIG. 4D, where the index of p×3+2 is globally numbered among total M×12/X cluster-based interlaces.

For example, as shown in FIG. 4E, when X=4, K=1, and C=4, there are 3 cluster-based interlaces per RB-based interlace. For each of the 3 cluster-based interlaces, there are 4 clusters per RB and each cluster comprises 1 subcarrier,
Cluster-based interlace 0 with reference to RB-based interlace p includes subcarriers 0, 3, 6 and 9 of RBs p, p+2, p+4, p+6, . . . , and corresponds to cluster-based interlace p×3 in FIG. 4E, where the index of p×3 is globally numbered among total M×12/X cluster-based interlaces;
Cluster-based interlace 1 with reference to RB-based interlace p includes subcarriers 1, 4, 7 and 10 of RBs p, p+2, p+4, p+6, . . . , and corresponds to cluster-based interlace p×3+1 in FIG. 4E, where the index of p×3+1 is globally numbered among total M×12/X cluster-based interlaces; and
Cluster-based interlace 2 with reference to RB-based interlace p includes subcarriers 2, 5, 8 and 11 of RBs p, p+2, p+4, p+6, . . . , and corresponds to cluster-based interlace p×3+2 in FIG. 4E, where the index of p×3+2 is globally numbered among total M×12/X cluster-based interlaces.

For example, as shown in FIG. 4F, when X=3, K=1, and C=3, there are 4 cluster-based interlaces per RB-based interlace. For each of the 4 cluster-based interlaces, there are 4 clusters per RB and each cluster comprises 1 subcarrier,
Cluster-based interlace 0 with reference to RB-based interlace p includes subcarriers 0, 4 and 8 of RBs p, p+2, p+4, p+6, . . . , and corresponds to cluster-based interlace p×4 in FIG. 4F, where the index of p×4 is globally numbered among total M×12/X cluster-based interlaces;
Cluster-based interlace 1 with reference to RB-based interlace p includes subcarriers 1, 5 and 9 of RBs p, p+2, p+4, p+6, . . . , and corresponds to cluster-based interlace p×4+1 in FIG. 4F, where the index of p×4+1 is globally numbered among total M×12/X cluster-based interlaces;
Cluster-based interlace 2 with reference to RB-based interlace p includes subcarriers 2, 6 and 10 of RBs p, p+2, p+4, p+6, . . . , and corresponds to cluster-based interlace p×4+2 in FIG. 4F, where the index of p×4+2 is globally numbered among total M×12/X cluster-based interlaces; and
Cluster-based interlace 3 with reference to RB-based interlace p includes subcarriers 3, 7 and 11 of RBs p, p+2, p+4, p+6, . . . , and corresponds to cluster-based interlace p×4+3 in FIG. 4F, where the index of p×4+3 is globally numbered among total M×12/X cluster-based interlaces.

For example, as shown in FIG. 4G, when X=2, K=1, and C=2, there are 6 cluster-based interlaces per RB-based interlace. For each of the 6 cluster-based interlaces, there are 2 clusters per RB and each cluster comprises 1 subcarrier,
Cluster-based interlace 0 with reference to RB-based interlace p includes subcarriers 0 and 6 of RBs p, p+2, p+4, p+6, . . . , and corresponds to cluster-based interlace p×6 in FIG. 4G, where the index of p×6 is globally numbered among total M×12/X cluster-based interlaces; and
Cluster-based interlace 1 with reference to RB-based interlace p includes subcarriers 1 and 7 of RBs p, p+2, p+4, p+6, . . . , and corresponds to cluster-based interlace p×6+1 in FIG. 4G, where the index of p×6+1 is globally numbered among total M×12/X cluster-based interlaces;
Cluster-based interlace 2 with reference to RB-based interlace p includes subcarriers 2 and 8 of RBs p, p+2, p+4, p+6, . . . , and corresponds to cluster-based interlace p×6+2 in FIG. 4G, where the index of p×6+2 is globally numbered among total M×12/X cluster-based interlaces;
Cluster-based interlace 3 with reference to RB-based interlace p includes subcarriers 3 and 9 of RBs p, p+2, p+4, p+6, . . . , and corresponds to cluster-based interlace p×6+3 in FIG. 4G, where the index of p×6+3 is globally numbered among total M×12/X cluster-based interlaces;
Cluster-based interlace 4 with reference to RB-based interlace p includes subcarriers 4 and 10 of RBs p, p+2, p+4, p+6, . . . , and corresponds to cluster-based interlace p×6+4 in FIG. 4G, where the index of p×6+4 is globally numbered among total M×12/X cluster-based interlaces; and
Cluster-based interlace 5 with reference to RB-based interlace p includes subcarriers 5 and 11 of RBs p, p+2, p+4, p+6, . . . , and corresponds to cluster-based interlace p×6+5 in FIG. 4G, where the index of p×6+5 is globally numbered among total M×12/X cluster-based interlaces.

For example, when X=K=C=1, there are 12 cluster-based interlaces per RB-based interlace,
Cluster-based interlace 0 with reference to RB-based interlace p includes subcarrier 0 of RBs p, p+2, p+4, p+6, . . . , and corresponds to the globally indexed cluster-based interlace p×12 among total M×12/X cluster-based interlaces;
Cluster-based interlace 1 with reference to RB-based interlace p includes subcarrier 1 of RBs p, p+2, p+4, p+6, . . . , and corresponds to the globally indexed cluster-based interlace p×12+1 among total M×12/X cluster-based interlaces;
Cluster-based interlace 2 with reference to RB-based interlace p includes subcarrier 2 of RBs p, p+2, p+4, p+6, . . . , and corresponds to the globally indexed cluster-based interlace p×12+2 among total M×12/X cluster-based interlaces;
Cluster-based interlace 3 with reference to RB-based interlace p includes subcarrier 3 of RBs p, p+2, p+4, p+6, . . . , and corresponds to the globally indexed cluster-based interlace p×12+3 among total M×12/X cluster-based interlaces;
Cluster-based interlace 4 with reference to RB-based interlace p includes subcarrier 4 of RBs p, p+2, p+4, p+6, . . . , and corresponds to the globally indexed cluster-based interlace p×12+4 among total M×12/X cluster-based interlaces;
Cluster-based interlace 5 with reference to RB-based interlace p includes subcarrier 5 of RBs p, p+2, p+4, p+6, . . . , and corresponds to the globally indexed cluster-based interlace p×12+5 among total M×12/X cluster-based interlaces;
Cluster-based interlace 6 with reference to RB-based interlace p includes subcarrier 6 of RBs p, p+2, p+4, p+6, . . . , and corresponds to the globally indexed cluster-based interlace p×12+6 among total M×12/X cluster-based interlaces;
Cluster-based interlace 7 with reference to RB-based interlace p includes subcarrier 7 of RBs p, p+2, p+4, p+6, . . . , and corresponds to the globally indexed cluster-based interlace p×12+7 among total M×12/X cluster-based interlaces;
Cluster-based interlace 8 with reference to RB-based interlace p includes subcarrier 8 of RBs p, p+2, p+4, p+6, . . . , and corresponds to the globally indexed cluster-based interlace p×12+8 among total M×12/X cluster-based interlaces;
Cluster-based interlace 9 with reference to RB-based interlace p includes subcarrier 9 of RBs p, p+2, p+4, p+6, . . . , and corresponds to the globally indexed cluster-based interlace p×12+9 among total M×12/X cluster-based interlaces;
Cluster-based interlace 10 with reference to RB-based interlace p includes subcarrier 10 of RBs p, p+2, p+4, p+6, . . . , and corresponds to the globally indexed cluster-based interlace p×12+10 among total M×12/X cluster-based interlaces; and
Cluster-based interlace 11 with reference to RB-based interlace p includes subcarrier 11 of RBs p, p+2, p+4, p+6, . . . , and corresponds to the globally indexed cluster-based interlace p×12+11 among total M×12/X cluster-based interlaces.

For 120 kHz SCS, since each RB occupies 1.44 MHz bandwidth, the RB-based interlace including RBs equally spaced in the frequency domain cannot meet the PSD requirements. However, the RB-based interlace can still meet OCB requirements. It is assumed that there are P RB-based interlaces specified for 120 kHz SCS (e.g., P=2, 3, 4, 5, 6, 8, 10 etc.), that is, every two consecutive RB-based interlaces are spaced with P RBs (e.g., M=P). It is further assumed that RB-based interlace p includes RBs p, p+P, p+2P, p+3P, . . . , where p is the interlace index of the RB-based interlace and p∈{0, 1,2, . . . , P−1} for 120 KHz SCS. For the cluster-based interlace structure, assuming X is the total number of subcarriers per RB, and X∈{1, 2, 3, 4, 6}, then RB-based interlace p comprises 12/X cluster-based interlaces. It is further assumed that pᵢ is the index of a cluster-based interlace with reference to RB-based interlace p, i∈

$$\{ 0 , 1 , … , \frac{12}{X} - 1 \} .$$

For the non-interleaved subcarrier-to-cluster mapping, cluster-based interlace pᵢ with reference to RB-based interlace p may include subcarrier i×X, i×X+1, . . . , i×X+X−1 of RBs p, p+P, p+2P, p+3P, . . . . The M×12/X or P×12/X (M=P) cluster-based interlaces may be indexed together (or globally) from 0 to M×12/X−1 or P×12/X−1 (M=P). Cluster-based interlace pᵢ with reference to RB-based interlace p may correspond to one of the M×12/X or P×12/X (M=P) cluster-based interlaces with a (global) index of p×12/X+pᵢ.

For example, when X=K−6, there are 2 cluster-based interlaces per RB-based interlace,
Cluster-based interlace 0 with reference to RB-based interlace p includes subcarriers 0, 1, 2, 3, 4 and 5 of RBs p, p+P, p+2P, p+3P, . . . , and corresponds to cluster-based interlace p×2, where the index of p×2 is globally numbered among total P×12/K cluster-based interlaces; and
Cluster-based interlace 1 with reference to RB-based interlace p includes subcarriers 6, 7, 8, 9, 10 and 11 of RBs p, p+P, p+2P, p+3P, . . . , and corresponds to cluster-based interlace p×2+1, where the index of p×2+1 is globally numbered among total P×12/K cluster-based interlaces.

For example, when X=K=4, there are 3 cluster-based interlaces per RB-based interlace,
Cluster-based interlace 0 with reference to RB-based interlace p includes subcarriers 0, 1, 2 and 3 of RBs p, p+P, p+2P, p+3P, . . . , and corresponds to cluster-based interlace p×3, where the index of p×3 is globally numbered among total P×12/K cluster-based interlaces;
Cluster-based interlace 1 with reference to RB-based interlace p includes subcarriers 4, 5, 6 and 7 of RBs p, p+P, p+2P, p+3P, . . . , and corresponds to cluster-based interlace p×3+1, where the index of p×3+1 is globally numbered among total P×12/K cluster-based interlaces; and
Cluster-based interlace 2 with reference to RB-based interlace p includes subcarriers 8, 9, 10 and 11 of RBs p, p+P, p+2P, p+3P, . . . , and corresponds to cluster-based interlace p×3+2, where the index of p×3+2 is globally numbered among total P×12/K cluster-based interlaces.

For example, when X=K=3, there are 4 cluster-based interlaces per RB-based interlace,
Cluster-based interlace 0 with reference to RB-based interlace p includes subcarriers 0, 1 and 2 of RBs p, p+P, p+2P, p+3P, . . . , and corresponds to cluster-based interlace p×4, where the index of p×4 is globally numbered among total P×12/K cluster-based interlaces;
Cluster-based interlace 1 with reference to RB-based interlace p includes subcarriers 3, 4 and 5 of RBs p, p+P, p+2P, p+3P, . . . , and corresponds to cluster-based interlace p×4+1, where the index of p×4+1 is globally numbered among total P×12/K cluster-based interlaces;
Cluster-based interlace 2 with reference to RB-based interlace p includes subcarriers 6, 7 and 8 of RBs p, p+P, p+2P, p+3P, . . . , and corresponds to cluster-based interlace p×4+2, where the index of p×4+2 is globally numbered among total P×12/K cluster-based interlaces; and
Cluster-based interlace 3 with reference to RB-based interlace p includes subcarriers 9, 10 and 11 of RBs p, p+P, p+2P, p+3P, . . . , and corresponds to cluster-based interlace p×4+3, where the index of p×4+3 is globally numbered among total P×12/K cluster-based interlaces.

For example, when X=K=2, there are 6 cluster-based interlaces per RB-based interlace,
Cluster-based interlace 0 with reference to RB-based interlace p includes subcarriers 0 and 1 of RBs p, p+P, p+2P, p+3P, . . . , and corresponds to cluster-based interlace p×6, where the index of p×6 is globally numbered among total P×12/K cluster-based interlaces;
Cluster-based interlace 1 with reference to RB-based interlace p includes subcarriers 2 and 3 of RBs p, p+P, p+2P, p+3P, . . . , and corresponds to cluster-based interlace p×6+1, where the index of p×6+1 is globally numbered among total P×12/K cluster-based interlaces;
Cluster-based interlace 2 with reference to RB-based interlace p includes subcarriers 4 and 5 of RBs p, p+P, p+2P, p+3P, . . . , and corresponds to cluster-based interlace p×6+2, where the index of p×6+2 is globally numbered among total P×12/K cluster-based interlaces;
Cluster-based interlace 3 with reference to RB-based interlace p includes subcarriers 6 and 7 of RBs p, p+P, p+2P, p+3P, . . . , and corresponds to cluster-based interlace p×6+3, where the index of p×6+3 is globally numbered among total P×12/K cluster-based interlaces;
Cluster-based interlace 4 with reference to RB-based interlace p includes subcarriers 8 and 9 of RBs p, p+P, p+2P, p+3P, . . . , and corresponds to cluster-based interlace p×6+4, where the index of p×6+4 is globally numbered among total P×12/K cluster-based interlaces; and
Cluster-based interlace 5 with reference to RB-based interlace p includes subcarriers 10 and 11 of RBs p, p+P, p+2P, p+3P, . . . , and corresponds to cluster-based interlace p×6+5, where the index of p×6+5 is globally numbered among total P×12/K cluster-based interlaces.

For example, when X=K=1, there are 12 cluster-based interlaces per RB-based interlace,
Cluster-based interlace 0 with reference to RB-based interlace p includes subcarrier 0 of RBs p, p+P, p+2P, p+3P, . . . , and corresponds to the globally indexed cluster-based interlace p×12 among total P×12/K cluster-based interlaces;
Cluster-based interlace 1 with reference to RB-based interlace p includes subcarrier 1 of RBs p, p+P, p+2P, p+3P, . . . , and corresponds to the globally indexed cluster-based interlace p×12+1 among total P×12/K cluster-based interlaces;
Cluster-based interlace 2 with reference to RB-based interlace p includes subcarrier 2 of RBs p, p+P, p+2P, p+3P, . . . , and corresponds to the globally indexed cluster-based interlace p×12+2 among total P×12/K cluster-based interlaces;
Cluster-based interlace 3 with reference to RB-based interlace p includes subcarrier 3 of RBs p, p+P, p+2P, p+3P, . . . , and corresponds to the globally indexed cluster-based interlace p×12+3 among total P×12/K cluster-based interlaces;
Cluster-based interlace 4 with reference to RB-based interlace p includes subcarrier 4 of RBs p, p+P, p+2P, p+3P, . . . , and corresponds to the globally indexed cluster-based interlace p×12+4 among total P×12/K cluster-based interlaces;
Cluster-based interlace 5 with reference to RB-based interlace p includes subcarrier 5 of RBs p, p+P, p+2P, p+3P, . . . , and corresponds to the globally indexed cluster-based interlace p×12+5 among total P×12/K cluster-based interlaces;
Cluster-based interlace 6 with reference to RB-based interlace p includes subcarrier 6 of RBs p, p+P, p+2P, p+3P, . . . , and corresponds to the globally indexed cluster-based interlace p×12+6 among total P×12/K cluster-based interlaces;
Cluster-based interlace 7 with reference to RB-based interlace p includes subcarrier 7 of RBs p, p+P, p+2P, p+3P, . . . , and corresponds to the globally indexed cluster-based interlace p×12+7 among total P×12/K cluster-based interlaces;
Cluster-based interlace 8 with reference to RB-based interlace p includes subcarrier 8 of RBs p, p+P, p+2P, p+3P, . . . , and corresponds to the globally indexed cluster-based interlace p×12+8 among total P×12/K cluster-based interlaces;
Cluster-based interlace 9 with reference to RB-based interlace p includes subcarrier 9 of RBs p, p+P, p+2P, p+3P, . . . , and corresponds to the globally indexed cluster-based interlace p×12+9 among total P×12/K cluster-based interlaces;
Cluster-based interlace 10 with reference to RB-based interlace p includes subcarrier 10 of RBs p, p+P, p+2P, p+3P, . . . , and corresponds to the globally indexed cluster-based interlace p×12+10 among total P×12/K cluster-based interlaces; and
Cluster-based interlace 11 with reference to RB-based interlace p includes subcarrier 11 of RBs p, p+P, p+2P, p+3P, . . . , and corresponds to the globally indexed cluster-based interlace p×12+11 among total P×12/K cluster-based interlaces.

For the interleaved subcarrier-to-cluster mapping, cluster-based interlace pᵢ with reference to RB-based interlace p may include C clusters, wherein the first cluster may include subcarrier {i, i+1, . . . , i+K−1} of RBs p, p+P, p+2P, p+3P, . . . ; the second cluster may include subcarrier

$$\{ i + \frac{12}{C} , i + \frac{12}{C} + 1 , … , i + \frac{12}{C} + K - 1 \}$$

of RBs p, p+P, p+2P, p+3P, . . . ; . . . ; and the C^{th} cluster may include subcarrier

$$\{ i + \frac{12}{C} \times ( C - 1 ) , i + \frac{12}{C} \times ( C - 1 ) + 1 , … , i + \frac{12}{C} \times ( C - 1 ) + K - 1 \}$$

of RBs p, p+P, p+2P, p+3P, . . . . The M×12/X or P×12/X (M=P) cluster-based interlaces may be indexed together (or globally) from 0 to M×12/X−1 or P×12/X−1 (M=P). Cluster-based interlace pᵢ with reference to RB-based interlace p may correspond to one of the M×12/X or P×12/X (M=P) cluster-based interlaces with a (global) index of p×12/X+pᵢ.

For example, when X=6, K=3, and C=2, there are 2 cluster-based interlaces per RB-based interlace. For each of the 2 cluster-based interlaces, there are 2 clusters per RB and each cluster comprises 3 contiguous subcarriers,
Cluster-based interlace 0 with reference to RB-based interlace p includes subcarriers 0, 1, 2, 6, 7 and 8 of RBs p, p+P, p+2P, p+3P, . . . , and corresponds to cluster-based interlace p×2, where the index of p×2 is globally numbered among total P×12/X cluster-based interlaces; and
Cluster-based interlace 1 with reference to RB-based interlace p includes subcarriers 3, 4, 5, 9, 10 and 11 of RBs p, p+P, p+2P, p+3P, . . . , and corresponds to cluster-based interlace p×2+1, where the index of p×2+1 is globally numbered among total P×12/X cluster-based interlaces.

For example, when X=6, K=2, and C=3, there are 2 cluster-based interlaces per RB-based interlace. For each of the 2 cluster-based interlaces, there are 3 clusters per RB and each cluster comprises 2 contiguous subcarriers,
Cluster-based interlace 0 with reference to RB-based interlace p includes subcarriers 0, 1, 4, 5, 8 and 9 of RBs p, p+P, p+2P, p+3P, . . . , and corresponds to cluster-based interlace p×2, where the index of p×2 is globally numbered among total P×12/X cluster-based interlaces; and
Cluster-based interlace 1 with reference to RB-based interlace p includes subcarriers 2, 3, 6, 7, 10 and 11 of RBs p, p+P, p+2P, p+3P, . . . , and corresponds to cluster-based interlace p×2+1, where the index of p×2+1 is globally numbered among total P×12/X cluster-based interlaces.

For example, when X=6, K=1, and C=6, there are 2 cluster-based interlaces per RB-based interlace. For each of the 2 cluster-based interlaces, there are 6 clusters per RB and each cluster comprises 1 subcarrier,
Cluster-based interlace 0 with reference to RB-based interlace p includes subcarriers 0, 2, 4, 6, 8 and 10 of RBs p, p+P, p+2P, p+3P, . . . , and corresponds to cluster-based interlace p×2, where the index of p×2 is globally numbered among total P×12/X cluster-based interlaces; and
Cluster-based interlace 1 with reference to RB-based interlace p includes subcarriers 1, 3, 5, 7, 9 and 11 of RBs p, p+P, p+2P, p+3P, . . . , and corresponds to cluster-based interlace p×2+1, where the index of p×2+1 is globally numbered among total P×12/X cluster-based interlaces.

For example, when X=4, K=2, and C=2, there are 3 cluster-based interlaces per RB-based interlace. For each of the 3 cluster-based interlaces, there are 2 clusters per RB and each cluster comprises 2 contiguous subcarriers,
Cluster-based interlace 0 with reference to RB-based interlace p includes subcarriers 0, 1, 6 and 7 of RBs p, p+P, p+2P, p+3P, . . . , and corresponds to cluster-based interlace p×3, where the index of p×3 is globally numbered among total P×12/X cluster-based interlaces;
Cluster-based interlace 1 with reference to RB-based interlace p includes subcarriers 2, 3, 8 and 9 of RBs p, p+P, p+2P, p+3P, . . . , and corresponds to cluster-based interlace p×3+1, where the index of p×3+1 is globally numbered among total P×12/X cluster-based interlaces; and
Cluster-based interlace 2 with reference to RB-based interlace p includes subcarriers 4, 5, 10 and 11 of RBs p, p+P, p+2P, p+3P, . . . , and corresponds to cluster-based interlace p×3+2, where the index of p×3+2 is globally numbered among total P×12/X cluster-based interlaces.

For example, when X=4, K=1, and C=4, there are 3 cluster-based interlaces per RB-based interlace. For each of the 3 cluster-based interlaces, there are 4 clusters per RB and each cluster comprises 1 subcarrier,
Cluster-based interlace 0 with reference to RB-based interlace p includes subcarriers 0, 3, 6 and 9 of RBs p, p+P, p+2P, p+3P, . . . , and corresponds to cluster-based interlace p×3, where the index of p×3 is globally numbered among total P×12/X cluster-based interlaces;
Cluster-based interlace 1 with reference to RB-based interlace p includes subcarriers 1, 4, 7 and 10 of RBs p, p+P, p+2P, p+3P, . . . , and corresponds to cluster-based interlace p×3+1, where the index of p×3+1 is globally numbered among total P×12/X cluster-based interlaces; and
Cluster-based interlace 2 with reference to RB-based interlace p includes subcarriers 2, 5, 8 and 11 of RBs p, p+P, p+2P, p+3P, . . . , and corresponds to cluster-based interlace p×3+2, where the index of p×3+2 is globally numbered among total P×12/X cluster-based interlaces.

For example, when X=3, K=1, and C=3, there are 4 cluster-based interlaces per RB-based interlace. For each of the 4 cluster-based interlaces, there are 4 clusters per RB and each cluster comprises 1 subcarrier,
Cluster-based interlace 0 with reference to RB-based interlace p includes subcarriers 0, 4 and 8 of RBs p, p+P, p+2P, p+3P, . . . , and corresponds to cluster-based interlace p×4, where the index of p×4 is globally numbered among total P×12/X cluster-based interlaces;
Cluster-based interlace 1 with reference to RB-based interlace p includes subcarriers 1, 5 and 9 of RBs p, p+P, p+2P, p+3P, . . . , and corresponds to cluster-based interlace p×4+1, where the index of p×4+1 is globally numbered among total P×12/X cluster-based interlaces;
Cluster-based interlace 2 with reference to RB-based interlace p includes subcarriers 2, 6 and 10 of RBs p, p+P, p+2P, p+3P, . . . , and corresponds to cluster-based interlace p×4+2, where the index of p×4+2 is globally numbered among total P×12/X cluster-based interlaces; and
Cluster-based interlace 3 with reference to RB-based interlace p includes subcarriers 3, 7 and 11 of RBs p, p+P, p+2P, p+3P, . . . , and corresponds to cluster-based interlace p×4+3, where the index of p×4+3 is globally numbered among total P×12/X cluster-based interlaces.

For example, when X=2, K=1, and C=2, there are 6 cluster-based interlaces per RB-based interlace. For each of the 6 cluster-based interlaces, there are 2 clusters per RB and each cluster comprises 1 subcarrier,
Cluster-based interlace 0 with reference to RB-based interlace p includes subcarriers 0 and 6 of RBs p, p+P, p+2P, p+3P, . . . , and corresponds to cluster-based interlace p×6, where the index of p×6 is globally numbered among total M×12/X cluster-based interlaces; and
Cluster-based interlace 1 with reference to RB-based interlace p includes subcarriers 1 and 7 of RBs p, p+P, p+2P, p+3P, . . . , and corresponds to cluster-based interlace p×6+1, where the index of p×6+1 is globally numbered among total P×12/X cluster-based interlaces;
Cluster-based interlace 2 with reference to RB-based interlace p includes subcarriers 2 and 8 of RBs p, p+P, p+2P, p+3P, . . . , and corresponds to cluster-based interlace p×6+2, where the index of p×6+2 is globally numbered among total P×12/X cluster-based interlaces;
Cluster-based interlace 3 with reference to RB-based interlace p includes subcarriers 3 and 9 of RBs p, p+P, p+2P, p+3P, . . . , and corresponds to cluster-based interlace p×6+3, where the index of p×6+3 is globally numbered among total P×12/X cluster-based interlaces;
Cluster-based interlace 4 with reference to RB-based interlace p includes subcarriers 4 and 10 of RBs p, p+P, p+2P, p+3P, . . . , and corresponds to cluster-based interlace p×6+4, where the index of p×6+4 is globally numbered among total P×12/X cluster-based interlaces; and
Cluster-based interlace 5 with reference to RB-based interlace p includes subcarriers 5 and 11 of RBs p, p+P, p+2P, p+3P, . . . , and corresponds to cluster-based interlace p×6+5, where the index of p×6+5 is globally numbered among total P×12/X cluster-based interlaces.

For example, when X=K=C=1, there are 12 cluster-based interlaces per RB-based interlace,
Cluster-based interlace 0 with reference to RB-based interlace p includes subcarrier 0 of RBs p, p+P, p+2P, p+3P, . . . , and corresponds to the globally indexed cluster-based interlace p×12 among total P×12/X cluster-based interlaces;
Cluster-based interlace 1 with reference to RB-based interlace p includes subcarrier 1 of RBs p, p+P, p+2P, p+3P, . . . , and corresponds to the globally indexed cluster-based interlace p×12+1 among total P×12/X cluster-based interlaces;
Cluster-based interlace 2 with reference to RB-based interlace p includes subcarrier 2 of RBs p, p+P, p+2P, p+3P, . . . , and corresponds to the globally indexed cluster-based interlace p×12+2 among total P×12/X cluster-based interlaces;
Cluster-based interlace 3 with reference to RB-based interlace p includes subcarrier 3 of RBs p, p+P, p+2P, p+3P, . . . , and corresponds to the globally indexed cluster-based interlace p×12+3 among total P×12/X cluster-based interlaces;
Cluster-based interlace 4 with reference to RB-based interlace p includes subcarrier 4 of RBs p, p+P, p+2P, p+3P, . . . , and corresponds to the globally indexed cluster-based interlace p×12+4 among total P×12/X cluster-based interlaces;
Cluster-based interlace 5 with reference to RB-based interlace p includes subcarrier 5 of RBs p, p+P, p+2P, p+3P, . . . , and corresponds to the globally indexed cluster-based interlace p×12+5 among total P×12/X cluster-based interlaces;
Cluster-based interlace 6 with reference to RB-based interlace p includes subcarrier 6 of RBs p, p+P, p+2P, p+3P, . . . , and corresponds to the globally indexed cluster-based interlace p×12+6 among total P×12/X cluster-based interlaces;
Cluster-based interlace 7 with reference to RB-based interlace p includes subcarrier 7 of RBs p, p+P, p+2P, p+3P, . . . , and corresponds to the globally indexed cluster-based interlace p×12+7 among total P×12/X cluster-based interlaces;
Cluster-based interlace 8 with reference to RB-based interlace p includes subcarrier 8 of RBs p, p+P, p+2P, p+3P, . . . , and corresponds to the globally indexed cluster-based interlace p×12+8 among total P×12/X cluster-based interlaces;
Cluster-based interlace 9 with reference to RB-based interlace p includes subcarrier 9 of RBs p, p+P, p+2P, p+3P, . . . , and corresponds to the globally indexed cluster-based interlace p×12+9 among total P×12/X cluster-based interlaces;
Cluster-based interlace 10 with reference to RB-based interlace p includes subcarrier 10 of RBs p, p+P, p+2P, p+3P, . . . , and corresponds to the globally indexed cluster-based interlace p×12+10 among total P×12/X cluster-based interlaces; and
Cluster-based interlace 11 with reference to RB-based interlace p includes subcarrier 11 of RBs p, p+P, p+2P, p+3P, . . . , and corresponds to the globally indexed cluster-based interlace p×12+11 among total P×12/X cluster-based interlaces.

As can be seen from the above, with the cluster-based interlace, the PSFCH capacity can be proportionally increased dependent on the cluster size and the number of clusters per RB. It is worth noting that the cluster-based interlace can also be applied to other sidelink channels, such as PSCCH, PSSCH and PSBCH.

In some embodiments, a PSFCH transmission may be constrained within one RB set, which is also named an LBT bandwidth or channel bandwidth and may be approximate 20 MHz.

Within a PSFCH resource pool, the cluster-based interlaces have the same structure. Each cluster-based interlace includes equal number of subcarriers within one RB. The cluster-based interlaces are configured with the same subcarrier spacing, the same cluster size and the same number of clusters per RB.

To indicate the cluster-based interlace, a PSFCH resource pool configuration may indicate at least one of the following: (a′) an index of an RB set for the PSFCH; (b′) subcarrier spacing of the carrier; (c′) a cluster size (i.e., the number of contiguous subcarriers per cluster) (e.g., the value of K); (d′) the number of clusters per RB (e.g., the value of C); (e′) the total number of subcarriers per RB for a cluster-based interlace (e.g., the value of X); or (f′) a subcarrier-to-cluster mapping type (e.g., interleaved or non-interleaved). The PSFCH resource pool configuration may be configured for a UE via RRC signaling or predefined in, for example, a standard(s).

In some embodiments, parameter (a′) may be implicitly determined, and thus not included in the PSFCH resource pool configuration. In some embodiments, parameter (b′) may be implicitly determined (for example, the same as the one for PSSCH corresponding to the PSFCH), and thus not included in the PSFCH resource pool configuration. In some embodiments, parameter (f′) may not be included in the PSFCH resource pool configuration when, for example, a default type is predefined in, for example, a standard(s), or the current mapping type can be implicitly determined. For example, in the case that parameter (c′) is configured or the value of parameter (c′) is greater than 1, it suggests that the interleaved subcarrier-to-cluster mapping is employed.

In some embodiments, the PSFCH resource pool configuration may include none, only one, or more than one of parameters (c′)-(e′). For example, parameter (e′) can be determined based on parameter (c′) or parameter (d′) (e.g., X=K×C). For example, any one of parameters (c′)-(e′) may be predefined in, for example, a standard(s).

The above parameters are only for illustrative purposes. Various other parameters or parameter combinations may be included in the resource pool configuration as long as it can define the structure of the cluster-based interlace.

Various methods may be employed to determine the corresponding RB set for a PSFCH transmission on the carrier. Various methods may be employed to determine the cluster-based interlace in the RB set for the PSFCH transmission. In some embodiments, a UE may first determine an RB set for a PSFCH transmission and then determine which cluster-based interlace in the RB set is used for the PSFCH transmission. In some embodiments, a UE may determine a number of cluster-based interlaces on a number of RB sets for a PSFCH transmission, and then determine which cluster-based interlace among the number of cluster-based interlaces is used for the PSFCH transmission.

For example, in a first embodiment, the RB set used for a PSFCH transmission may be a predefined (e.g., the lowest or highest in the frequency domain) RB set of one or more RB sets for transmitting the PSSCH corresponding to the PSFCH. In a second embodiment, the RB set used for a PSFCH transmission may be explicitly indicated in the PSFCH resource pool as described above.

For example, in a third embodiment, a PSFCH transmission can have multiple transmission opportunities on multiple RB sets in the frequency domain. In some examples, the multiple RB sets can be the one or more RB sets for transmitting the PSSCH corresponding to the PSFCH. In some examples, the multiple RB sets can be all RB sets on the carrier. Although there are multiple transmission opportunities, the PSFCH may be transmitted in at most one of the multiple RB sets subject to the outcomes of LBT tests on the multiple RB sets. In the case that the LBT tests for more than one RB set of the multiple RB sets are successful, the PSFCH may be transmitted in a predefined RB set (e.g., the lowest or highest in the frequency domain) of the more than one RB set with a successful LBT test. In the case that the LBT tests for all of the multiple RB sets fail, the PSFCH transmission would be dropped.

The specific cluster-based interlace used for the PSFCH transmission in the RB set (which can be determined according to one of the above methods or other similar methods) may be dependent on the total number of available PSFCH resources (denoted as R). In some embodiments, for a PSSCH received on z RB-based interlaces in slot #n and scheduled by an associated SCI, a UE may determine an index of a PSFCH resource (e.g., the index of the cluster-based interlace) for a PSFCH transmission corresponding to the PSSCH based on: R; a physical layer source ID (e.g., P_{ID}) indicated in the SCI scheduling the PSSCH; and an ID of the UE in a UE group (e.g., M_{ID}) in the case that groupcast ACK or NACK based HARQ-ACK feedback is enabled (e.g., as indicated by the SCI), or otherwise, M_{ID} is zero. In some examples, M_{ID} may be indicated by a higher layer(s) (e.g., RRC layer). For example, the index of the PSFCH resource (e.g., the index of the cluster-based interlace) for the PSFCH transmission may be determined according to (P_{ID}+M_{ID}) mod R.

Various methods may be employed to determine the value of R.

In some embodiments, the value of R may refer to the total number of PSFCH resources (e.g., cluster-based interlaces) available within the PSFCH resource pool. The R PSFCH resources are on all the available cluster-based interlaces with one PSFCH transmission on one cluster-based interlace.

For example, without consideration of code-division multiplexing (CDM) or time-division multiplexing (TDM) based multiple UEs multiplexing on the same cluster-based interlace for PSFCH transmission, different UEs in a UE group may have different cluster-based interlaces for transmitting multiple PSFCHs at the same time on the same carrier. Therefore, the total number of PSFCH resources available for PSFCH transmission may be dependent on the total number of cluster-based interlaces, or the number of RB-based interlaces and the cluster size. For example, R=M×12/X=M×12/(K×C), where M is the number of RB-based interlaces dependent on subcarrier spacing of the carrier, X is the total number of subcarriers per RB, C is the number of clusters per RB, and K is the cluster size as described above. For 15 kHz SCS, R may be equal to 20, 30, 40, 60 or 120 for X equal to 6, 4, 3, 2 or 1, respectively. For 30 kHz SCS, R may be equal to 10, 15, 20, 30, or 60 for X equal to 6, 4, 3, 2 or 1, respectively.

With CDM-based multiplexing, the total number of PSFCH resources available for PSFCH transmission may be further dependent on the number of cyclic shift pairs supported for the PSFCH resource pool (e.g., N_{cs}). For example, R=N_{cs}×M×12/X=N_{cs}×M×12/(K×C). With TDM-based multiplexing, the total number of PSFCH resources available for PSFCH transmission may be further dependent on the number of PSFCH transmission occasions within a PSFCH slot (e.g., B). For example, R=B×M×12/X=B×M×12/(K×C). With CDM and TDM-based multiplexing, the total number of PSFCH resources available for PSFCH transmission may be further dependent on N_{cs} and B. For example, R=N_{cs}×B×M×₁₂/X=N_{cs}×B×M×12/(K×C).

In some embodiments, the value of R may refer to the total number of PSFCH resources (e.g., cluster-based interlaces) available for multiplexing HARQ-ACK information in a PSFCH transmission corresponding to slot #n and the z RB-based interlaces for the PSSCH transmission.

For example, without consideration of CDM or TDM-based multiple UEs multiplexing on the same cluster-based interlace for PSFCH transmission, different UEs in a UE group may have different cluster-based interlaces for transmitting multiple PSFCHs at the same time on the same carrier. Therefore, the total number of PSFCH resources available for PSFCH transmission may be dependent on the total number of cluster-based interlaces corresponding to the PSSCH transmission. For example, R=z×12/X=z×12/(K×C), where z is the number of RB-based interlaces allocated for the PSSCH transmission, X is the total number of subcarriers per RB, C is the number of clusters per RB, and K is the cluster size as described above.

With CDM-based multiplexing, the total number of PSFCH resources available for PSFCH transmission may be further dependent on the number of cyclic shift pairs supported for the PSFCH resource pool (e.g., N_{cs}). For example, R=N_{cs}×2×12/X=N_{cs}×7×12/(K×C). With TDM-based multiplexing, the total number of PSFCH resources available for PSFCH transmission may be further dependent on the number of PSFCH transmission occasions within a PSFCH slot (e.g., B). For example, R=B×z×12/X=B×z×12/(K×C). With CDM and TDM-based multiplexing, the total number of PSFCH resources available for PSFCH transmission may be further dependent on N_{cs} and B. For example,

$$R = {N}_{c s} \times B \times z \times 12 / X = {N}_{c s} \times B \times z \times 12 / ( K \times C ) .$$

For example, in a fourth embodiment, the RB set used for a PSFCH transmission may be one of the RB sets for transmitting the PSSCH corresponding to the PSFCH, or one of the RB sets within the PSFCH resource pool. The specific RB set may be implicitly determined based on the PSFCH resource index (e.g., index of the cluster-based interlace) among available PSFCH resources within the PSFCH resource pool.

For example, in the fourth embodiment, similar to the above embodiments, the specific cluster-based interlace used for the PSFCH transmission may be dependent on the total number of available PSFCH resources (e.g., R). For example, a UE may determine an index of a PSFCH resource (e.g., the index of the cluster-based interlace) for a PSFCH transmission corresponding to a PSSCH based on: R, P_{ID}, and M_{ID}, for example, according to (P_{ID}+M_{ID}) mod R.

In the fourth embodiment, the total number of available PSFCH resources (e.g., R) may refer to the number of RB sets for transmitting the PSSCH corresponding to the PSFCH, or the number of the RB set(s) within the PSFCH resource pool.

For example, in the fourth embodiment, without consideration of CDM or TDM-based multiple UEs multiplexing on the same cluster-based interlace for PSFCH transmission, the total number of PSFCH resources available for PSFCH transmission (e.g., R) may be dependent on the number of RB sets for transmitting the PSSCH corresponding to the PSFCH, or the number of the RB set(s) within the PSFCH resource pool (denoted as D). For example, R=D×M×12/X=D×M×12/(K×C), where M is the number of RB-based interlaces dependent on subcarrier spacing of the carrier, X is the total number of subcarriers per RB, C is the number of clusters per RB, and K is the cluster size as described above.

With CDM-based multiplexing, the total number of PSFCH resources available for PSFCH transmission may be further dependent on the number of cyclic shift pairs supported for the PSFCH resource pool (e.g., N_{cs}). For example, R=N_{cs}×D×M×12/X=N_{cs}×D×M×12/(K×C). With TDM-based multiplexing, the total number of PSFCH resources available for PSFCH transmission may be further dependent on the number of PSFCH transmission occasions within a PSFCH slot (e.g., B). For example, R=B×D×M×12/X=B×D×M×12/(K×C). With CDM and TDM-based multiplexing, the total number of PSFCH resources available for PSFCH transmission may be further dependent on N_{cs} and B. For example,

$$R = {N}_{c s} \times B \times D \times M \times 12 / X = {N}_{c s} \times B \times D \times M \times 12 / ( K \times C ) .$$

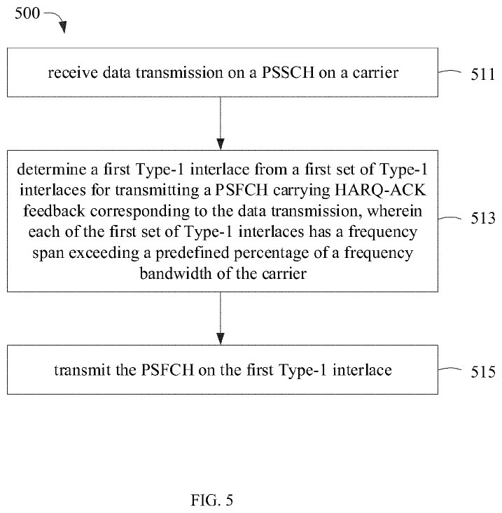

FIG. 5 illustrates a flow chart of exemplary procedure 500 for wireless communications in accordance with some embodiments of the present disclosure. Details described in all of the foregoing embodiments of the present disclosure are applicable for the embodiments shown in FIG. 5. In some examples, the procedure may be performed by a UE, for example, UE 110 in FIG. 1.

Referring to FIG. 5, in operation 511, a first UE may receive data transmission on a PSSCH on a carrier.

In operation 513, the first UE may determine a first Type-1 interlace from a first set of Type-1 interlaces (e.g., cluster-based interlaces) for transmitting a PSFCH carrying HARQ-ACK feedback corresponding to the data transmission, wherein each of the first set of Type-1 interlaces has a frequency span exceeding a predefined percentage of a frequency bandwidth of the carrier. In some embodiments, each of the first set of Type-1 interlaces may include a set of subcarrier clusters that are equally spaced in the frequency bandwidth of the carrier in the case that non-interleaved subcarrier-to-cluster mapping is employed. In some embodiments, the each of the first set of Type-1 interlaces may include a set of subcarrier clusters that are equally spaced within each RB associated with the corresponding Type-1 interlace in the case that interleaved subcarrier-to-cluster mapping is employed.

In operation 515, the first UE may transmit the PSFCH on the first Type-1 interlace.

In some embodiments of the present disclosure, each of the set of subcarrier clusters comprises equal number (e.g., K) of contiguous subcarriers per RB. In some embodiments of the present disclosure, in the case that the non-interleaved subcarrier-to-cluster mapping is employed, the first Type-1 interlace includes a single subcarrier cluster in each RB associated with the first Type-1 interlace. In some embodiments of the present disclosure, in the case that the interleaved subcarrier-to-cluster mapping is employed, the first Type-1 interlace includes one or more subcarrier clusters (e.g., X) in each RB associated with the first Type-1 interlace.

In some embodiments of the present disclosure, the first Type-1 interlace may be defined with reference to a Type-2 interlace of a second set of Type-2 interlaces (e.g., RB-based interlaces). Each of the second set of Type-2 interlaces has a frequency span exceeding the predefined percentage of the frequency bandwidth of the carrier and comprises RBs that are equally spaced in the frequency bandwidth of the carrier. In some embodiments, the Type-2 interlace comprises one or more Type-1 interlaces orthogonal in a frequency domain.

In some embodiments, the number of Type-1 interlaces of the first set of Type-1 interlaces may be dependent on the number of Type-2 interlaces of the second set of Type-2 interlaces and a size of the subcarrier cluster in the case that non-interleaved subcarrier-to-cluster mapping is employed. For example, the number of Type-1 interlaces of the first set of Type-1 interlaces may be determined according to M×12/K, wherein M is the number of Type-2 interlaces dependent on subcarrier spacing of the carrier, and K is the cluster size.

In some embodiments, the number of Type-1 interlaces of the first set of Type-1 interlaces may be dependent on the number of Type-2 interlaces of the second set of Type-2 interlaces and the total number of subcarriers per RB for each Type-1 interlace in the case that interleaved subcarrier-to-cluster mapping is employed. For example, the number of Type-1 interlaces of the first set of Type-1 interlaces may be determined according to M×12/X, wherein M is the number of Type-2 interlaces dependent on subcarrier spacing of the carrier, and X is the total number of subcarriers per RB for a Type-1 interlace.

In some embodiments, the first Type-1 interlace may be determined from the first set of Type-1 interlaces based on a total number of available PSFCH resources (e.g., R as described above). The total number of available PSFCH resources may be determined based on one of the following in the case that non-interleaved subcarrier-to-cluster mapping is employed: the number of Type-2 interlaces of the second set of Type-2 interlaces and a size of the subcarrier cluster (e.g., R=M×12/K); the number of Type-2 interlaces for transmitting the PSSCH and a size of the subcarrier cluster (e.g., R=z×12/K); the number of RB sets for transmitting the PSSCH, the number of Type-2 interlaces of the second set of Type-2 interlaces, and a size of the subcarrier cluster (e.g., R=D×M×12/K); or the number of RB sets within a resource pool for the PSFCH, the number of Type-2 interlaces of the second set of Type-2 interlaces, and a size of the subcarrier cluster (e.g., R=D×M×12/K).

In some embodiments, the first Type-1 interlace may be determined from the first set of Type-1 interlaces based on a total number of available PSFCH resources (e.g., R as described above). The total number of available PSFCH resources may be determined based on one of the following in the case that interleaved subcarrier-to-cluster mapping is employed: the number of Type-2 interlaces of the second set of Type-2 interlaces, and the total number of subcarriers per RB for each Type-1 interlace (e.g., R=M×12/X); the number of Type-2 interlaces for transmitting the PSSCH and the total number of subcarriers per RB for each Type-1 interlace (e.g., R=z×12/X); the number of RB sets for transmitting the PSSCH, the number of Type-2 interlaces of the second set of Type-2 interlaces, and the total number of subcarriers per RB for each Type-1 interlace (e.g., R=D×M×12/X); or the number of RB sets within a resource pool for the PSFCH, the number of Type-2 interlaces of the second set of Type-2 interlaces, and the total number of subcarriers per RB for each Type-1 interlace (e.g., R=D×M×12/X).

In some embodiments, the number of Type-2 interlaces (e.g., M) of the second set of Type-2 interlaces is dependent on subcarrier spacing of the carrier.

In some embodiments, wherein the total number of available PSFCH resources may be determined further based on at least one of: the number of cyclic shift pairs supported for the resource pool for the PSFCH (e.g., N_{cs}); or the number of PSFCH transmission occasions within a PSFCH slot (e.g., B).

In some embodiments, the first UE is from a UE group. The first Type-1 interlace may be determined from the first set of Type-1 interlaces further based on: a physical layer source ID (e.g., P_{ID}) indicated in the SCI scheduling the PSSCH; and an ID of the first UE in the UE group (e.g., M_{ID}) in the case that groupcast ACK or NACK based HARQ-ACK feedback is enabled.

In some embodiments of the present disclosure, the first UE may receive a configuration of a resource pool for the PSFCH. The configuration may indicate at least one of the following: an index of an RB set for the PSFCH; subcarrier spacing of the carrier; a cluster size or the number of contiguous subcarriers per cluster (e.g., K); the number of subcarriers per cluster per RB; the number of clusters per Type-2 interlace; a subcarrier-to-cluster mapping type (e.g., interleaved or non-interleaved); the number of clusters per RB (e.g., C); or the total number of subcarriers per RB for each Type-1 interlace (e.g., X).

In some embodiments of the present disclosure, the first set of Type-1 interlaces is within a resource pool for the PSFCH.

In some embodiments of the present disclosure, the PSFCH is transmitted confined within an RB set on the carrier. The RB set may be: a predefined (e.g., lowest or highest) RB set of the RB set(s) for transmitting the PSSCH; indicated in a configuration of a resource pool for the PSFCH; one of the RB set(s) for transmitting the PSSCH; one of the RB set(s) within a resource pool for the PSFCH; an RB set of one or more RB sets for transmitting the PSSCH subject to the result of an LBT test on each of the one or more RB sets; or an RB set of all RB sets on the carrier subject to the result of an LBT test on each of the RB sets on the carrier.

It should be appreciated by persons skilled in the art that the sequence of the operations in exemplary procedure 500 may be changed and some of the operations in exemplary procedure 500 may be eliminated or modified, without departing from the spirit and scope of the disclosure.

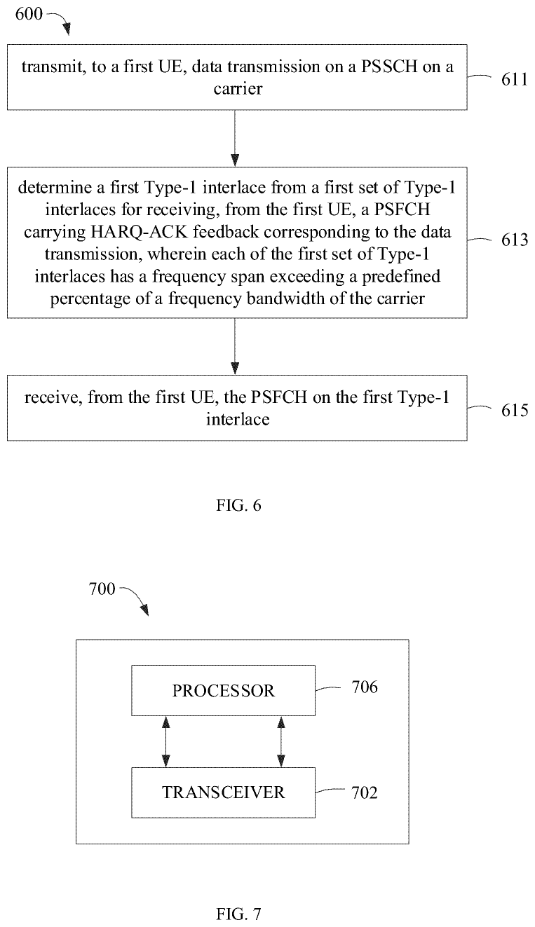

FIG. 6 illustrates a flow chart of exemplary procedure 600 for wireless communications in accordance with some embodiments of the present disclosure. Details described in all of the foregoing embodiments of the present disclosure are applicable for the embodiments shown in FIG. 6. In some examples, the procedure may be performed by a UE, for example, UE 110 in FIG. 1.

Referring to FIG. 6, in operation 611, a second UE may transmit, to a first UE, data transmission on a PSSCH on a carrier.

In operation 613, the second UE may determine a first Type-1 interlace from a first set of Type-1 interlaces (e.g., cluster-based interlaces) for receiving, from the first UE, a PSFCH carrying HARQ-ACK feedback corresponding to the data transmission, wherein each of the first set of Type-1 interlaces has a frequency span exceeding a predefined percentage of a frequency bandwidth of the carrier. In some embodiments, the each of the first set of Type-1 interlaces may include a set of subcarrier clusters that are equally spaced in the frequency bandwidth of the carrier in the case that non-interleaved subcarrier-to-cluster mapping is employed. In some embodiments, the each of the first set of Type-1 interlaces may include equally spaced within each RB associated with the corresponding Type-1 interlace in the case that interleaved subcarrier-to-cluster mapping is employed.

In operation 615, the second UE may receive, from the first UE, the PSFCH on the first Type-1 interlace.

In some embodiments of the present disclosure, each of the set of subcarrier clusters comprises equal number (e.g., K) of contiguous subcarriers per RB. In some embodiments of the present disclosure, in the case that the non-interleaved subcarrier-to-cluster mapping is employed, the first Type-1 interlace includes a single subcarrier cluster in each RB associated with the first Type-1 interlace. In some embodiments of the present disclosure, in the case that the interleaved subcarrier-to-cluster mapping is employed, the first Type-1 interlace includes one or more subcarrier clusters (e.g., X) in each RB associated with the first Type-1 interlace.

In some embodiments of the present disclosure, the first Type-1 interlace may be defined with reference to a Type-2 interlace of a second set of Type-2 interlaces (e.g., RB-based interlaces). Each of the second set of Type-2 interlaces has a frequency span exceeding the predefined percentage of the frequency bandwidth of the carrier and comprises RBs that are equally spaced in the frequency bandwidth of the carrier. In some embodiments, the Type-2 interlace comprises one or more Type-1 interlaces orthogonal in a frequency domain.

In some embodiments, the number of Type-1 interlaces of the first set of Type-1 interlaces may be dependent on the number of Type-2 interlaces of the second set of Type-2 interlaces and a size of the subcarrier cluster in the case that non-interleaved subcarrier-to-cluster mapping is employed. For example, the number of Type-1 interlaces of the first set of Type-1 interlaces may be determined according to M×12/K, wherein M is the number of Type-2 interlaces dependent on subcarrier spacing of the carrier, and K is the cluster size.

In some embodiments, the number of Type-1 interlaces of the first set of Type-1 interlaces may be dependent on the number of Type-2 interlaces of the second set of Type-2 interlaces and the total number of subcarriers per RB for each Type-1 interlace in the case that interleaved subcarrier-to-cluster mapping is employed. For example, the number of Type-1 interlaces of the first set of Type-1 interlaces may be determined according to M×12/X, wherein M is the number of Type-2 interlaces dependent on subcarrier spacing of the carrier, and X is the total number of subcarriers per RB for a Type-1 interlace.

In some embodiments, the first Type-1 interlace may be determined from the first set of Type-1 interlaces based on a total number of available PSFCH resources (e.g., R as described above). The total number of available PSFCH resources may be determined based on one of the following in the case that non-interleaved subcarrier-to-cluster mapping is employed: the number of Type-2 interlaces of the second set of Type-2 interlaces and a size of the subcarrier cluster (e.g., R=M×12/K); the number of Type-2 interlaces for transmitting the PSSCH and a size of the subcarrier cluster (e.g., R=z×12/K); the number of RB sets for transmitting the PSSCH, the number of Type-2 interlaces of the second set of Type-2 interlaces, and a size of the subcarrier cluster (e.g., R=D×M×12/K); or the number of RB sets within a resource pool for the PSFCH, the number of Type-2 interlaces of the second set of Type-2 interlaces, and a size of the subcarrier cluster (e.g., R=D×M×12/K).

In some embodiments, the first Type-1 interlace may be determined from the first set of Type-1 interlaces based on a total number of available PSFCH resources (e.g., R as described above). The total number of available PSFCH resources may be determined based on one of the following in the case that interleaved subcarrier-to-cluster mapping is employed: the number of Type-2 interlaces of the second set of Type-2 interlaces, and the total number of subcarriers per RB for each Type-1 interlace (e.g., R=M×12/X); the number of Type-2 interlaces for transmitting the PSSCH and the total number of subcarriers per RB for each Type-1 interlace (e.g., R=z×12/X); the number of RB sets for transmitting the PSSCH, the number of Type-2 interlaces of the second set of Type-2 interlaces, and the total number of subcarriers per RB for each Type-1 interlace (e.g., R=D×M×12/X); or the number of RB sets within a resource pool for the PSFCH, the number of Type-2 interlaces of the second set of Type-2 interlaces, and the total number of subcarriers per RB for each Type-1 interlace (e.g., R=D×M×12/X).

In some embodiments, the number of Type-2 interlaces (e.g., M) of the second set of Type-2 interlaces is dependent on subcarrier spacing of the carrier.

In some embodiments, wherein the total number of available PSFCH resources may be determined further based on at least one of: the number of cyclic shift pairs supported for the resource pool for the PSFCH (e.g., N_{cs}); or the number of PSFCH transmission occasions within a PSFCH slot (e.g., B).

In some embodiments, the second UE and the first UE are from a UE group. The first Type-1 interlace may be determined from the first set of Type-1 interlaces further based on: a physical layer source ID (e.g., P_{ID}) indicated in the SCI scheduling the PSSCH; and an ID of the first UE in the UE group (e.g., M_{ID}) in the case that groupcast ACK or NACK based HARQ-ACK feedback is enabled.

In some embodiments, the PSFCH is configured with a resource pool. The resource pool may be configured by at least one of the following: an index of an RB set for the PSFCH; subcarrier spacing of the carrier; a cluster size or the number of contiguous subcarriers per cluster (e.g., K); the number of subcarriers per cluster per RB; the number of clusters per Type-2 interlace; a subcarrier-to-cluster mapping type (e.g., interleaved or non-interleaved); the number of clusters per RB (e.g., C); or the total number of subcarriers per RB for each Type-1 interlace (e.g., X).

In some embodiments of the present disclosure, the first set of Type-1 interlaces is within a resource pool for the PSFCH.

In some embodiments of the present disclosure, the PSFCH is transmitted confined within an RB set on the carrier. The RB set may be: a predefined (e.g., lowest or highest) RB set of the RB set(s) for transmitting the PSSCH; indicated in a configuration of a resource pool for the PSFCH; one of the RB set(s) for transmitting the PSSCH; one of the RB set(s) within a resource pool for the PSFCH; an RB set of one or more RB sets for transmitting the PSSCH subject to the result of an LBT test on each of the one or more RB sets; or an RB set of all RB sets on the carrier subject to the result of an LBT test on each of the RB sets on the carrier.

It should be appreciated by persons skilled in the art that the sequence of the operations in exemplary procedure 600 may be changed and some of the operations in exemplary procedure 600 may be eliminated or modified, without departing from the spirit and scope of the disclosure.

FIG. 7 illustrates a block diagram of an exemplary apparatus 700 according to some embodiments of the present disclosure. As shown in FIG. 7, the apparatus 700 may include at least one processor 706 and at least one transceiver 702 coupled to the processor 706. The apparatus 700 may be a UE.

Although in this figure, elements such as the at least one transceiver 702 and processor 706 are described in the singular, the plural is contemplated unless a limitation to the singular is explicitly stated. In some embodiments of the present application, the transceiver 702 may be divided into two devices, such as a receiving circuitry and a transmitting circuitry. In some embodiments of the present application, the apparatus 700 may further include an input device, a memory, and/or other components.

In some embodiments of the present application, the apparatus 700 may be a UE. The transceiver 702 and the processor 706 may interact with each other so as to perform the operations with respect to the UE described in FIGS. 1-6.

In some embodiments of the present application, the apparatus 700 may further include at least one non-transitory computer-readable medium. For example, in some embodiments of the present disclosure, the non-transitory computer-readable medium may have stored thereon computer-executable instructions to cause the processor 706 to implement the method with respect to the UE as described above. For example, the computer-executable instructions, when executed, cause the processor 706 interacting with transceiver 702 to perform the operations with respect to the UE described in FIGS. 1-6.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A first user equipment (UE), comprising:
at least one memory; and
at least one processor coupled with the at least one memory and configured to cause the first UE to:
receive data transmission on a physical sidelink shared channel (PSSCH) on a carrier;
determine a first Type-1 interlace from a first set of Type-1 interlaces for transmitting a physical sidelink feedback channel (PSFCH) carrying hybrid automatic repeat request acknowledgement (HARQ-ACK) feedback corresponding to the data transmission, wherein each of the first set of Type-1 interlaces has a frequency span exceeding a predefined percentage of a frequency bandwidth of the carrier and comprises a set of subcarrier clusters that are equally spaced in the frequency bandwidth of the carrier in the case that non-interleaved subcarrier-to-cluster mapping is employed or equally spaced within each resource block (RB) associated with the corresponding Type-1 interlace in the case that interleaved subcarrier-to-cluster mapping is employed; and
transmit the PSFCH on the first Type-1 interlace.

2. The first UE of claim 1, wherein each of the set of subcarrier clusters comprises equal number of contiguous subcarriers per RB.

3. The first UE of claim 1, wherein in the case that the non-interleaved subcarrier-to-cluster mapping is employed, the first Type-1 interlace includes a single subcarrier cluster in each RB associated with the first Type-1 interlace; or
wherein in the case that the interleaved subcarrier-to-cluster mapping is employed, the first Type-1 interlace includes one or more subcarrier clusters in each RB associated with the first Type-1 interlace.

4. The first UE of claim 1, wherein the first Type-1 interlace is defined with reference to a Type-2 interlace of a second set of Type-2 interlaces, wherein each of the second set of Type-2 interlaces has a frequency span exceeding the predefined percentage of the frequency bandwidth of the carrier and comprises RBs that are equally spaced in the frequency bandwidth of the carrier.

5. The first UE of claim 4, wherein the Type-2 interlace comprises one or more Type-1 interlaces orthogonal in a frequency domain.

6. The first UE of claim 4, wherein a number of Type-1 interlaces of the first set of Type-1 interlaces is dependent on a number of Type-2 interlaces of the second set of Type-2 interlaces and a size of the subcarrier cluster in the case that non-interleaved subcarrier-to-cluster mapping is employed; or
wherein the number of Type-1 interlaces of the first set of Type-1 interlaces is dependent on the number of Type-2 interlaces of the second set of Type-2 interlaces and a total number of subcarriers per RB for each Type-1 interlace in the case that interleaved subcarrier-to-cluster mapping is employed.

7. The first UE of claim 4, wherein the first Type-1 interlace is determined from the first set of Type-1 interlaces based on a total number of available PSFCH resources, which is determined based on one of the following in the case that non-interleaved subcarrier-to-cluster mapping is employed:
the number of Type-2 interlaces of the second set of Type-2 interlaces and a size of the subcarrier cluster;
the number of Type-2 interlaces for transmitting the PSSCH and a size of the subcarrier cluster;
the number of RB sets for transmitting the PSSCH, the number of Type-2 interlaces of the second set of Type-2 interlaces, and a size of the subcarrier cluster; or
the number of RB sets within a resource pool for the PSFCH, the number of Type-2 interlaces of the second set of Type-2 interlaces, and a size of the subcarrier cluster.

8. The first UE of claim 4, wherein the first Type-1 interlace is determined from the first set of Type-1 interlaces based on a total number of available PSFCH resources, which is determined based on one of the following in the case that interleaved subcarrier-to-cluster mapping is employed:
the number of Type-2 interlaces of the second set of Type-2 interlaces, and the total number of subcarriers per RB for each Type-1 interlace;
the number of Type-2 interlaces for transmitting the PSSCH and the total number of subcarriers per RB for each Type-1 interlace;
the number of RB sets for transmitting the PSSCH, the number of Type-2 interlaces of the second set of Type-2 interlaces, and the total number of subcarriers per RB for each Type-1 interlace; or
the number of RB sets within a resource pool for the PSFCH, the number of Type-2 interlaces of the second set of Type-2 interlaces, and the total number of subcarriers per RB for each Type-1 interlace.

9. The first UE of claim 8, wherein the number of Type-2 interlaces of the second set of Type-2 interlaces is dependent on subcarrier spacing of the carrier.

10. The first UE of claim 8, wherein the total number of available PSFCH resources is determined further based on at least one of:
the number of cyclic shift pairs supported for the resource pool for the PSFCH; or
the number of PSFCH transmission occasions within a PSFCH slot.

11. The first UE of claim 8, wherein the first UE is from a UE group, and the first Type-1 interlace is determined from the first set of Type-1 interlaces further based on:
a physical layer source ID indicated in sidelink control information (SCI) scheduling the PSSCH; and
an ID of the first UE in the UE group in the case that groupcast ACK or negative ACK (NACK) based HARQ-ACK feedback is enabled.

12. The first UE of claim 1, wherein the at least one processor is configured to cause the UE to receive a configuration of a resource pool for the PSFCH, and the configuration indicates at least one of the following:
an index of an RB set for the PSFCH;
subcarrier spacing of the carrier;
a cluster size or a number of contiguous subcarriers per cluster;
a number of subcarriers per cluster per RB;
a number of clusters per Type-2 interlace;
a subcarrier-to-cluster mapping type;
a number of clusters per RB; or
a total number of subcarriers per RB for each Type-1 interlace.

13. The first UE of claim 1, wherein the PSFCH is transmitted confined within an RB set on the carrier and the RB set is:
a predefined RB set of RB set(s) for transmitting the PSSCH;
indicated in a configuration of a resource pool for the PSFCH;
one of RB set(s) for transmitting the PSSCH;
one of RB set(s) within a resource pool for the PSFCH;
an RB set of one or more RB sets for transmitting the PSSCH subject to a result of a listen-before-talk (LBT) test on each of the one or more RB sets; or
an RB set of all RB sets on the carrier subject to the result of an LBT test on each of the RB sets on the carrier.

14. A second user equipment (UE), comprising:
at least one memory; and
at least one processor coupled with the at least one memory and configured to cause the second UE to:
transmit, to a first UE, data transmission on a physical sidelink shared channel (PSSCH) on a carrier;
determine a first Type-1 interlace from a first set of Type-1 interlaces for receiving, from the first UE, a physical sidelink feedback channel (PSFCH) carrying hybrid automatic repeat request acknowledgement (HARQ-ACK) feedback corresponding to the data transmission, wherein each of the first set of Type-1 interlaces has a frequency span exceeding a predefined percentage of a frequency bandwidth of the carrier and comprises a set of subcarrier clusters that are equally spaced in the frequency bandwidth of the carrier in the case that non-interleaved subcarrier-to-cluster mapping is employed or equally spaced within each resource block (RB) associated with the corresponding Type-1 interlace in the case that interleaved subcarrier-to-cluster mapping is employed; and
receive, from the first UE, the PSFCH on the first Type-1 interlace.

15. A method performed by a first user equipment (UE), the method comprising:
receiving data transmission on a physical sidelink shared channel (PSSCH) on a carrier;
determining a first Type-1 interlace from a first set of Type-1 interlaces for transmitting a physical sidelink feedback channel (PSFCH) carrying hybrid automatic repeat request acknowledgement (HARQ-ACK) feedback corresponding to the data transmission, wherein each of the first set of Type-1 interlaces has a frequency span exceeding a predefined percentage of a frequency bandwidth of the carrier and comprises a set of subcarrier clusters that are equally spaced in the frequency bandwidth of the carrier in the case that non-interleaved subcarrier-to-cluster mapping is employed or equally spaced within each resource block (RB) associated with the corresponding Type-1 interlace in the case that interleaved subcarrier-to-cluster mapping is employed; and
transmitting the PSFCH on the first Type-1 interlace.

16. A processor for wireless communication, comprising:
at least one controller coupled with at least one memory and configured to cause the processor to:
receive data transmission on a physical sidelink shared channel (PSSCH) on a carrier;
determine a first Type-1 interlace from a first set of Type-1 interlaces for transmitting a physical sidelink feedback channel (PSFCH) carrying hybrid automatic repeat request acknowledgement (HARQ-ACK) feedback corresponding to the data transmission, wherein each of the first set of Type-1 interlaces has a frequency span exceeding a predefined percentage of a frequency bandwidth of the carrier and comprises a set of subcarrier clusters that are equally spaced in the frequency bandwidth of the carrier in the case that non-interleaved subcarrier-to-cluster mapping is employed or equally spaced within each resource block (RB) associated with the corresponding Type-1 interlace in the case that interleaved subcarrier-to-cluster mapping is employed; and
transmit the PSFCH on the first Type-1 interlace.

17. The processor of claim 16, wherein each of the set of subcarrier clusters comprises equal number of contiguous subcarriers per RB.

18. The processor of claim 16, wherein in the case that the non-interleaved subcarrier-to-cluster mapping is employed, the first Type-1 interlace includes a single subcarrier cluster in each RB associated with the first Type-1 interlace; or
wherein in the case that the interleaved subcarrier-to-cluster mapping is employed, the first Type-1 interlace includes one or more subcarrier clusters in each RB associated with the first Type-1 interlace.

19. The processor of claim 16, wherein the first Type-1 interlace is defined with reference to a Type-2 interlace of a second set of Type-2 interlaces, wherein each of the second set of Type-2 interlaces has a frequency span exceeding the predefined percentage of the frequency bandwidth of the carrier and comprises RBs that are equally spaced in the frequency bandwidth of the carrier.

20. The processor of claim 19, wherein the Type-2 interlace comprises one or more Type-1 interlaces orthogonal in a frequency domain.
